(19) United States
(12) Patent Application Publication
(10) Pub. No.: US 2025/0150289 A1
(43) Pub. Date: May 8, 2025

(54) METHOD AND SYSTEM FOR ACHIEVING A CONSENSUS AND ITS USE THEREOF

(71) Applicant: BB INVENTIONS INC., Varennes (CA)

(72) Inventor: Nathan Trudeau, Varennes, QC (CA)

(21) Appl. No.: 18/691,146

(22) PCT Filed: Aug. 26, 2022
(86) PCT No.: PCT/IB2022/058013

§ 371 Date: Mar. 12, 2024

Related U.S. Application Data
(60) Provisional application No. 63/333,742, filed on Apr. 22, 2022.
(60) Provisional application No. 63/243,157, filed on Sep. 12, 2021.

(51) Int. Cl. H04L 9/00

(52) U.S. Cl. CPC H04L 9/50

(57) ABSTRACT

A computer-implemented method for processing a structured data unit related to a distributed ledger enabled system. The computer-implemented method is performed by at least one first computing node related to the distributed ledger enabled system. The computer-implemented method comprises determining a reliability associated with at least one of the at least one first computing node, at least one given computing node and at least one second computing node and providing at least one indication of at least one portion of the structured data unit to at least one portion of the at least one second computing node. Additional computer-implemented methods are also described.

### CROSS-REFERENCE TO RELATED APPLICATIONS

This application claims priority to U.S. Provisional Patent Application No. 63/243,157 filed on Sep. 12, 2021, entitled “METHOD AND SYSTEM FOR ACHIEVING A CONSENSUS AND ITS USE THEREOF”; and U.S. Provisional Patent Application No. 63/333,742 filed on Apr. 22, 2022, entitled “METHOD AND SYSTEM FOR ACHIEVING A CONSENSUS AND ITS USE THEREOF”, all of which are incorporated by reference herein in their entirety.

### TECHNICAL FIELD

At least one embodiment of the invention relates to methods and systems for achieving a consensus. More precisely, at least one embodiment of the invention relates to computer-implemented methods in distributed ledger enabled systems.

### BACKGROUND OF THE ART

Distributed ledger enabled systems, such as blockchains, tangles and hashgraphs, are systems comprising databases that are consensually shared across a plurality of entities and are actively maintained to track provided transactions. One can think of blockchains as being the most prominent and used form of distributed ledger enabled system, which in most cases has the particularity of being decentralized. The skilled addressee will appreciate that a decentralized distributed ledger enabled system enables at least one type of at least one relevant activity and information to be shared between the plurality of entities. Thus, to ensure data legitimacy, the entities related to the distributed ledger enabled system usually achieve a consensus when actions are initiated therein.

One method for achieving the consensus well-known in the art is a concept called proof of work (PoW), which is used in distributed ledger enabled systems such as Bitcoin™ and the like. The skilled addressee will appreciate that PoW generally relies on a first node proving that a certain amount of computational effort was made to validate a plurality of transactions comprised in a PoW distributed ledger enabled system, such as a blockchain. At least one second node is then tasked to validate if the effort produced by the first node is sufficient, a result of said validation thereby enabling an eligibility for the first node to receive a reward. To ensure the security of a system using PoW, complex cryptographic algorithms are often used and the amount of computational effort needed for attaining a consensus between nodes participating in the distributed ledger enabled system is often significant. From a security standpoint, PoW generally relies on entities, such as the first node, validating transactions in the distributed ledger enabled system to invest a large amount of at least one computational resource in order to perform said validation, often leading to significant electricity costs. As a byproduct of the amount of at least one computational resource needed to perform said validation, a limiting participating barrier for less powerful entities often takes form. It will be understood by the skilled addressee that a system using PoW may not be appealing due to various reasons, such as an increasing requirement of powerful computer hardware in order for nodes participating in the consensus to maintain a reasonable reward eligibility upon validation of transactions, as an increase in computational power to validate transactions is often seen in correlation with an increase of at least one type of at least one activity in the distributed ledger enabled system, thereby often leading to both significant energy consumption and increasing monetary costs. Moreover, from a security standpoint, PoW generally relies on entities making transactions in the distributed ledger enabled system to invest resources, such as monetary resources, when making said transactions, which can lead to significant costs, oftentimes creating a limiting barrier in the type, nature and scope of transactions said entities can make.

Another well-known method for achieving the consensus is a concept called proof of stake (PoS), which is used in distributed ledger enabled systems such as Cardano™ and the like. Unlike PoW, PoS instead generally relies on selecting a validator to provide a block, thereby enabling an eligibility of a reward for doing so. The skilled addressee will appreciate that the validator is typically selected proportionally to an amount of at least one invested computational resource, such as monetary resources. From a security standpoint, similarly to PoW, PoS generally relies on entities making transactions in the distributed ledger enabled system to invest resources when making said transactions, which can lead to significant costs, oftentimes creating a limiting barrier in the type, nature and scope of transactions said entities can make. An advantage of PoS when compared to PoW is that it requires less energy to operate. PoS, however, tends to rely on entities investing a significant amount of at least one type of resource(s), often limiting benefits for less wealthy entities. Another well-known method for achieving the consensus is a concept called proof of space (PoSpace), which is similar to PoW but tends to rely more on storage than heavy computational efforts, and which is used in distributed ledger enabled systems such as Chia™ and the like. In a system using PoSpace, a verifier(s) is typically asking a prover to open several random locations in its data storing system to obtain a reward. From a security standpoint, similarly to PoW and PoS, PoSpace generally relies on entities making transactions in the distributed ledger enabled system to invest resources when making said transactions, which can lead to significant costs, oftentimes creating a limiting barrier in the type, nature and scope of transactions said entities can make. Although, similarly to PoW requiring significant computational efforts, PoSpace requires the prover to have a significant amount of space and read speed in their data storing system, such as a hard drive or a solid-state drive, thus often leading to a significant resources investment in relevant computer hardware.

There is therefore a need for of a method and a system that will overcome the above-identified drawbacks.

### SUMMARY

Common problems in the technical field related to the current technology are that consensus algorithms often require a significant amount of at least one type of resource(s) to operate and that power in a related distributed ledger enabled system is often correlated to how wealthy a given entity is, often limiting decentralization by widening the gap between more wealthy entities and less wealthy entities. In at least one embodiment, the present technology provides at least one of (i) an environmentally friendly, (ii) a fast, (iii) a decentralized, (iv) a feeless and (v) a secured practical solution to at least one of these technical problems by combining multiple strategies, systems and methods, including evaluating the reliability of computing nodes and using random or pseudo-random numbers.

According to a broad aspect, there is provided a computer-implemented method for processing a structured data unit related to a distributed ledger enabled system, the computer-implemented method being performed by at least one first computing node related to the distributed ledger enabled system, the computer-implemented method comprising: determining a reliability associated with at least one of the at least one first computing node, at least one given computing node and at least one second computing node; and providing at least one indication of at least one portion of the structured data unit to at least one subset of the at least one second computing node.

Optionally, in any of the previous aspects, the structured data unit is one of at least one portion of a block related to a blockchain and a structure of at least one indication of at least one portion of at least one transaction associated with at least one of the at least one second computing node and at least one other computing node, said at least one other computing node being considered to be reliable.

Optionally, in any of the previous aspects, the method is associated with the at least one given computing node.

Optionally, in any of the previous aspects, at least one subset of the at least one given computing node is at least one subset of at least one of the at least one first computing node and the at least one second computing node.

Optionally, in any of the previous aspects, said processing comprises associating at least one first indication of at least one obtained first trackable number associated with at least one of the at least one first computing node, the at least one given computing node and the at least one second computing node with the structured data unit.

Optionally, in any of the previous aspects, the method further includes associating at least one indication of at least one transaction with the structured data unit, and wherein at least one portion of said at least one indication of the at least one transaction is organized according to at least one associated second trackable number.

Optionally, in any of the previous aspects, associating data with at least one given portion of the structured data unit comprises one of: adding said data to said at least one given portion; and storing said data on at least one storage medium, obtaining at least one given indication of said data on the at least one storage medium and adding said at least one given indication to said at least one given portion.

Optionally, in any of the previous aspects, determining the reliability comprises comparing at least one reliability metric value associated with at least one of the at least one first computing node, the at least one given computing node and the at least one second computing node with at least one reliability metric value threshold, and further wherein the at least one reliability metric value threshold is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the at least one reliability metric value threshold comprises at least one first minimum reliability metric value threshold and at least one first maximum reliability metric value threshold.

Optionally, in any of the previous aspects, said determining of reliability comprises obtaining at least one authorization associated with at least one of the at least one first computing node and the at least one given computing node, and further wherein the at least one authorization is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the structured data unit is obtained from at least one subset of at least one of: the at least one first computing node; the at least one given computing node; and the at least one second computing node.

Optionally, in any of the previous aspects, at least one subset of the at least one first computing node, the at least one given computing node and the at least one second computing node enables at least one portion of said processing.

Optionally, in any of the previous aspects, at least one subset of the at least one first computing node enables at least one portion of a generating process of the structured data unit.

Optionally, in any of the previous aspects, the method further includes confirming the structured data unit in the distributed ledger enabled system, wherein said confirming involves at least one subset of at least one of: the at least one first computing node; the at least one given computing node; and the at least one second computing node.

Optionally, in any of the previous aspects, the method further includes performing a validating associated with the structured data unit.

Optionally, in any of the previous aspects, at least one of said validating and said providing comprises combining at least one part of at least one cryptographic key associated with at least one of the at least one first computing node, the at least one given computing node and the at least one second computing node with at least one portion of at least one of the structured data unit and information involved in at least one interaction between at least one subset of at least one of the at least one first computing node, the at least one given computing node and at least one second computing node.

Optionally, in any of the previous aspects, said validating comprises associating at least one portion of at least one result of at least one comparison associated with at least one subset of the at least one first computing node and at least one third computing node with the structured data unit.

Optionally, in any of the previous aspects, said processing comprises performing a selecting associated with at least one subset of at least one of the at least one first computing node, the at least one given computing node, the at least one second computing node and the at least one third computing node using at least one given trackable number, and further wherein said selecting involves at least one other subset of at least one of the at least one first computing node, the at least one given computing node, the at least one second computing node and the at least one third computing node.

Optionally, in any of the previous aspects, said selecting comprises determining at least one portion of at least one reliability metric value distribution and performing said selecting using said at least one portion of the at least one reliability metric value distribution.

Optionally, in any of the previous aspects, said selecting comprises at least one of: determining at least one portion of at least one reliability metric value distribution; providing, to at least one of at least one first intermediary smart contract, system manager, server, computing node and processing device, information required to perform at least one processing step of said selection; and obtaining, from at least one of at least one first providing smart contract, system manager, server, computing node and processing device, information associated with the selection.

Optionally, in any of the previous aspects, said validating comprises determining at least one of a reliability and a uniqueness associated with the structured data unit.

Optionally, in any of the previous aspects, said validating comprises at least one of tracking and invalidating at least one relevant trackable number associated with the structured data unit, and further wherein a performing of at least one of said tracking and invalidating involves at least one subset of at least one of the at least one first computing node, the at least one given computing node, and at least one of at least one smart contract, system manager, server, computing node, processing device and machine readable instruction related to the distributed ledger enabled system.

Optionally, in any of the previous aspects, said validating comprises redetermining a previously determined reliability associated with at least one of the at least one first computing node, the at least one given computing node, the at least one second computing node and the at least one other computing node according to at least one of at least one condition, event, action, function, criterion, smart contract, system manager, server, computing node, parameter, processing device, rule, machine readable instruction, and vote of at least one entity related to the distributed ledger enabled system.

Optionally, in any of the previous aspects, a performing of said validating involves at least one first subset of at least one of: the at least one first computing node; the at least one second computing node; the at least one given computing node; the at least one third computing node; and at least one of at least one smart contract, system manager, server, computing node, processing device and machine readable instruction related to the distributed ledger enabled system.

Optionally, in any of the previous aspects, said validating comprises enabling at least one of a penalizing and a compensating associated with the at least one first subset, and further wherein at least one of a shape, form, scope and nature of at least one of said penalizing and said compensating is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, at least one second portion of at least one of the at least one obtained first trackable number, the at least one associated second trackable number, the at least one given trackable number and the at least one relevant trackable number is one of pseudo-random and random, and further wherein an obtaining process associated with said at least one second portion involves at least one subset of at least one of the at least one first computing node, the at least one given computing node, the at least one second computing node and the structured data unit.

Optionally, in any of the previous aspects, a reliability associated with at least one computing node related to said processing comprises at least one of at least one rule, role, ability to perform at least one previously determined action in the distributed ledger enabled system, reliability metric value, demonstration of trustworthiness and determining of trustworthiness determined by at least one first rightful computing node.

Optionally, in any of the previous aspects, said penalizing comprises at least one of: preventing at least one action to be performed on at least one first asset accessible by at least one subset of at least one of the at least one first subset; losing at least one second asset accessible by at least one subset of at least one of the at least one first subset; and altering at least one reliability metric value associated with at least one of the at least one first subset; and at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, at least a portion of the method is enabled according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, said role comprises at least one of at least one right, responsibility and authority, said at least one of at least one right, responsibility and authority comprising at least one of: delegating a storing of at least one portion of data related to at least one subset of at least one of the at least one first computing node, the at least one second computing node, the at least one given computing node, and the at least one third computing node according to at least one of at least one condition, event, action, function, criterion, smart contract, system manager, server, computing node, parameter, processing device, rule, machine readable instruction and vote of at least one entity related to the distributed ledger enabled system; storing at least one additional portion of delegated data related to at least one subset of at least one of the at least one first computing node, the at least one second computing node, the at least one given computing node, and the at least one third computing node according to at least one of at least one condition, event, action, function, criterion, smart contract, system manager, server, computing node, parameter, processing device, rule, machine readable instruction and vote of at least one entity related to the distributed ledger enabled system; altering at least one transaction threshold of at least one structured data unit related to the distributed ledger enabled system for at least one subset of at least one of the at least one first computing node, the at least one second computing node, the at least one given computing node, and the at least one third computing node according to at least one of at least one condition, event, action, function, criterion, smart contract, system manager, server, computing node, parameter, processing device, rule, machine readable instruction and vote of at least one entity related to the distributed ledger enabled system; and performing at least one task, said at least one task comprising at least one of monitoring, modifying, adding, terminating and determining a behavior of at least one machine readable instruction related to the distributed ledger enabled system for at least one subset of at least one of the at least one first computing node, the at least one second computing node, the at least one given computing node, and the at least one third computing node according to at least one of at least one condition, event, action, function, criterion, smart contract, system manager, server, computing node, parameter, processing device, rule, machine readable instruction and vote of at least one entity related to the distributed ledger enabled system.

According to a broad aspect, there is provided a system comprising at least one processor, and at least one storage medium storing instructions, which when executed by the at least one processor, causes the system to carry out the computer-implemented method of any one of the previous aspects.

According to a broad aspect, there is provided a machine-readable medium carrying machine readable instructions, which when executed by a processor of a machine, causes the machine to perform the computer-implemented method of any one of the previous aspects.

According to a broad aspect, there is provided a computer-implemented method for validating a structured data unit related to a distributed ledger enabled system, the computer-implemented method being performed by at least one first computing node related to the distributed ledger enabled system, the computer-implemented method comprising: determining a reliability associated with at least one of the at least one first computing node, at least one given computing node and at least one second computing node; obtaining at least one indication of at least one first transaction associated with the structured data unit; determining a similarity between at least one indication of at least one second transaction associated with the at least one first computing node and the at least one indication of the at least one first transaction; and providing at least one of at least one given indication of a first result of said determining of similarity and at least one portion of the structured data unit to at least one subset of the at least one second computing node.

Optionally, in any of the previous aspects, the structured data unit is one of at least one portion of a block related to a blockchain and a structure of at least one indication of at least one portion of at least one transaction associated with at least one of the at least one second computing node and at least one other computing node, said at least one other computing node being considered to be reliable.

Optionally, in any of the previous aspects, a performing of at least one processing step of said validating is associated with the at least one given computing node, and further wherein at least one of said providing and at least one other processing step comprises said at least one processing step.

Optionally, in any of the previous aspects, at least one subset of the at least one given computing node is at least one subset of at least one of the at least one first computing node and the at least one second computing node.

Optionally, in any of the previous aspects, the method further includes: providing at least one portion of at least one of the at least one given indication, the at least one indication of the at least one first transaction and the at least one indication of the at least one second transaction to at least one relevant subset of at least one given computing node; and obtaining at least one indication of a second result, the at least one indication of the second result being obtained by first determining a similarity between at least one of the at least one given indication, the at least one indication of the at least one first transaction, the at least one indication of the at least one second transaction and at least one indication of at least one third transaction associated with the at least one relevant subset.

Optionally, in any of the previous aspects, the method further includes associating at least one first indication of at least one obtained first trackable number associated with at least one of the at least one first computing node, the at least one given computing node and the at least one second computing node with at least one of the at least one given indication, the at least one indication of the second result and the structured data unit.

Optionally, in any of the previous aspects, associating data with at least one given portion of at least one of the at least one given indication, the at least one indication of the second result and the structured data unit comprises one of: adding said data to said at least one given portion; and storing said data on at least one storage medium, obtaining at least one given indication of said data on the at least one storage medium and adding said at least one given indication to said at least one given portion.

Optionally, in any of the previous aspects, the method further includes determining a validity associated with at least one of the at least one given indication, the at least one indication of the second result, the at least one indication of at least one first transaction, the at least one indication of at least one third transaction and at least one other given portion of the structured data unit.

Optionally, in any of the previous aspects, determining the reliability comprises comparing at least one reliability metric value associated with at least one of the at least one first computing node, the at least one given computing node and the at least one second computing node with at least one reliability metric value threshold, and further wherein the at least one reliability metric value threshold is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the at least one reliability metric value threshold comprises at least one first minimum reliability metric value threshold and at least one first maximum reliability metric value threshold.

Optionally, in any of the previous aspects, said determining of reliability comprises obtaining at least one authorization associated with at least one of the at least one first computing node and the at least one given computing node, and further wherein the at least one authorization is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the structured data unit is obtained from at least one subset of at least one of the at least one first computing node, the at least one given computing node and the at least one second computing node.

Optionally, in any of the previous aspects, at least one subset of the at least one first computing node, the at least one given computing node and the at least one second computing node enables at least one portion of said validating.

Optionally, in any of the previous aspects, at least one subset of the at least one first computing node enables at least one portion of a generating process of the structured data unit.

Optionally, in any of the previous aspects, at least one of: determining a similarity between at least one indication of at least one second transaction associated with the at least one first computing node and the at least one indication of the at least one first transaction; and determining a similarity between at least one of the at least one given indication, the at least one indication of the at least one first transaction, the at least one indication of the at least one second transaction and at least one indication of at least one third transaction associated with the at least one relevant subset involves at least one portion of at least one of: the at least one indication of the at least one second transaction; the at least one indication of the at least one first transaction; and the at least one indication of the at least one third transaction to be organized according to at least one associated second trackable number.

Optionally, in any of the previous aspects, at least one of said validating and said providing comprises combining at least one part of at least one cryptographic key associated with at least one of the at least one first computing node, the at least one given computing node and the at least one second computing node with at least one portion of at least one of the structured data unit, the at least one given indication, the at least one indication of the second result and information involved in at least one interaction between at least one subset of at least one of the at least one first computing node, the at least one given computing node and at least one second computing node.

Optionally, in any of the previous aspects, the method further includes associating at least one portion of at least one of the at least one given indication, the at least one indication of the at least one third transaction, at least one indication of the at least one second transaction, the at least one indication of the at least one first transaction and the structured data unit with at least one of the at least one given indication, the at least one indication of the at least one third transaction, at least one indication of the at least one second transaction, the at least one indication of the at least one first transaction and the structured data unit.

Optionally, in any of the previous aspects, the method further includes performing a selecting associated with at least one subset of at least one of the at least one first computing node, the at least one given computing node and the at least one second computing node using at least one given trackable number, and further wherein said selecting involves at least one other subset of at least one of the at least one first computing node, the at least one given computing node and the at least one second computing node.

Optionally, in any of the previous aspects, said selecting comprises determining at least one portion of at least one reliability metric value distribution and performing said selecting using said at least one portion of the at least one reliability metric value distribution.

Optionally, in any of the previous aspects, said selecting comprises at least one of: determining at least one portion of at least one reliability metric value distribution; providing, to at least one of at least one first intermediary smart contract, system manager, server, computing node and processing device information required to perform at least one processing step of said selection; and obtaining, from at least one of at least one first providing smart contract, system manager, server, computing node and processing device information associated with the selection.

Optionally, in any of the previous aspects, the method further includes determining at least one of a reliability and a uniqueness associated with at least one of the at least one given indication, the at least one indication of the at least one third transaction, at least one indication of the at least one second transaction, the at least one indication of the at least one first transaction and the structured data unit.

Optionally, in any of the previous aspects, the method further includes at least one of tracking and invalidating at least one relevant trackable number associated with at least one of the at least one given indication, the at least one indication of the at least one third transaction, at least one indication of the at least one second transaction, the at least one indication of the at least one first transaction and the structured data unit, and further wherein a performing of at least one of said tracking and invalidating involves at least one subset of at least one of the at least one first computing node, the at least one given computing node, at least one smart contract, system manager, server, computing node, processing device and machine readable instruction related to the distributed ledger enabled system.

Optionally, in any of the previous aspects, the method further includes redetermining a previously determined reliability associated with at least one of the at least one first computing node, the at least one given computing node, the at least one second computing node and the at least one other computing node according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the method further includes enabling at least one of a penalizing and a compensating associated with at least one of the at least one first computing node, the at least one given computing node, the at least one second computing node and at least one concerned computing node, and wherein at least one of a shape, form, scope and nature of at least one of said penalizing and said compensating is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, at least one first portion of at least one of the at least one obtained first trackable number, the at least one associated second trackable number, the at least one given trackable number and the at least one relevant trackable number is one of pseudo-random and random, and wherein an obtaining process associated with said at least one first portion involves at least one subset of at least one of the at least one first computing node, the at least one given computing node, the at least one second computing node and the structured data unit.

Optionally, in any of the previous aspects, a reliability associated with at least one computing node related to said validating comprises at least one of at least one rule, role, ability to perform at least one previously determined action in the distributed ledger enabled system, reliability metric value, demonstration of trustworthiness and determining of trustworthiness determined by at least one first rightful computing node.

Optionally, in any of the previous aspects, said penalizing comprises at least one of: preventing at least one action to be performed on at least one first asset accessible by at least one subset of at least one of the at least one first computing node, the at least one given computing node, the at least one second computing node and the at least one concerned computing node; losing at least one second asset accessible by at least one subset of at least one of the at least one first computing node, the at least one given computing node, the at least one second computing node and the at least one concerned computing node; and altering at least one reliability metric value associated with at least one of the at least one first computing node, the at least one given computing node, the at least one second computing node and the at least one concerned computing node, and at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, at least a portion of the method is enabled according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the method further includes, according to at least one criterion, performing at least one blockchain-related action of removing, adding, or updating, on at least one portion of the data associated with the structured data unit.

Optionally, in any of the previous aspects, the at least one criterion comprises a transaction type of at least one transaction associated with the structured data unit.

Optionally, in any of the previous aspects, the at least one blockchain-related action comprises at least one of: removing potentially malicious data; removing at least one transaction; adding at least one transaction; updating at least one transaction; adding a signature; updating a signature; adding a co-signature; and updating a co-signature.

Optionally, in any of the previous aspects, said role comprises at least one of at least one right, responsibility and authority, said at least one of at least one right, responsibility and authority comprising at least one of: delegating a storing of at least one portion of data related to at least one subset of at least one of the at least one first computing node, the at least one second computing node, the at least one given computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; storing at least one additional portion of delegated data related to at least one subset of at least one of the at least one first computing node, the at least one second computing node, the at least one given computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; altering at least one transaction threshold associated with at least one structured data unit related to the distributed ledger enabled system for at least one subset of at least one of the at least one first computing node, the at least one second computing node, the at least one given computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; and performing at least one task, said at least one task comprising at least one of monitoring, modifying, adding, terminating and determining a behavior associated with at least one machine readable instruction related to the distributed ledger enabled system for at least one subset of at least one of the at least one first computing node, the at least one second computing node, the at least one given computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system.

According to a broad aspect, there is provided a system comprising at least one processor, and at least one storage medium storing instructions, which when executed by the at least one processor, causes the system to carry out the computer-implemented method of any one of the previous aspects.

According to a broad aspect, there is provided a machine-readable medium carrying machine readable instructions, which when executed by a processor of a machine, causes the machine to perform the computer-implemented method of any one of the previous aspects.

Optionally, in any of the previous aspects, there is provided a computer-implemented method for generating at least one indication of a trackable number, the computer-implemented method being performed by at least one first computing node part of a distributed ledger enabled system, the computer-implemented method comprising: combining at least one first identifier associated with the at least one first computing node with at least one first trackable number associated with at least one determined portion of at least one structured data unit part of the distributed ledger enabled system; and obtaining the at least one indication of the trackable number according to a first result of said combining.

Optionally, in any of the previous aspects, the structured data unit is a block related to a blockchain.

Optionally, in any of the previous aspects, said combining comprises at least one of at least one concatenation process, number reduction process, hashing process, and normalization process.

Optionally, in any of the previous aspects, said combining comprises at least one of at least one length normalization process, exclusive or (XOR) operation, compression process, and number reduction process.

Optionally, in any of the previous aspects, the trackable number is compared to at least one trackable number threshold, and further wherein the at least one trackable number threshold is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, at least one first portion of at least one of said combining and said obtaining is processed by at least one second computing node and according to at least one of the first result and a second result of said at least one first portion, providing at least one of the first result and the second result to at least one subset of the at least one first computing node, and further wherein the at least one second computing node is considered to be reliable.

Optionally, in any of the previous aspects, said at least one determined portion of the structured data unit is determined according to at least one of at least one given computing node, at least one condition, event, action, function, criterion, smart contract, system manager, server, computing node, parameter, processing device, rule, machine readable instruction and vote of at least one entity related to the distributed ledger enabled system.

Optionally, in any of the previous aspects, at least one subset of the at least one given computing node is at least one subset of at least one of the at least one first computing node and the at least one second computing node.

Optionally, in any of the previous aspects, at least one of a shape, form, scope and nature of said combining is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, said generating comprises a first determining process determining at least one of: a reliability associated with the at least one first computing node, the at least one given computing node and the at least one second computing node, a validity associated with at least one first position associated with the at least one structured data unit and a validity associated with the at least one indication of the trackable number.

Optionally, in any of the previous aspects, said combining comprises a first obtaining process of the at least one first identifier.

Optionally, in any of the previous aspects, said first determining process comprises enabling a penalizing associated with at least one of the at least one first computing node, the at least one given computing node and the at least one second computing node, and further wherein at least one of a shape, form, scope and nature of said penalizing is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the method further includes combining at least one part of at least one cryptographic key associated with at least one of the at least one first computing node, the at least one given computing node and the at least one second computing node with at least one portion of at least one of the first result, the second result and the at least one indication of the trackable number and information involved in at least one interaction between at least one subset of at least one of the at least one first computing node, the at least one given computing node and at least one second computing node.

Optionally, in any of the previous aspects, the method further includes performing a selecting associated with at least one subset of at least one of the at least one first computing node, the at least one given computing node and the at least one second computing node using at least one given trackable number, and further wherein said selecting involves at least one other subset of at least one of the at least one first computing node, the at least one given computing node and the at least one second computing node.

Optionally, in any of the previous aspects, said selecting comprises determining at least one portion of at least one reliability metric value distribution and performing said selecting using said at least one portion of the at least one reliability metric value distribution.

Optionally, in any of the previous aspects, said selecting comprises at least one of: determining at least one portion of at least one reliability metric value distribution; providing, to at least one of at least one first intermediary smart contract, system manager, server, computing node and processing device, information required to perform at least one processing step of said selection; and obtaining, from at least one of at least one first providing smart contract, system manager, server, computing node and processing device, information associated with the selection.

Optionally, in any of the previous aspects, the at least one given trackable number is one of pseudo-random and random, and wherein an obtaining process associated with said at least one given trackable number involves at least one subset of at least one of: the at least one first computing node; the at least one given computing node; the at least one second computing node; and the at least one structured data unit.

Optionally, in any of the previous aspects, the at least one given trackable number is obtained using the computer-implemented method of any one of claims 67 to 77.

Optionally, in any of the previous aspects, said penalizing comprises at least one of: preventing at least one action to be performed on at least one first asset accessible by at least one subset of at least one of the at least one first computing node, the at least one given computing node and the at least one second computing node; losing at least one second asset accessible by at least one subset of at least one of the at least one first computing node, the at least one given computing node and the at least one second computing node; and altering at least one reliability metric value associated with at least one of the at least one first computing node, the at least one given computing node and the at least one second computing node, and at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, at least a portion of the method is enabled according to at least one of: at least one condition, event, action, function, criterion, smart contract, system manager, server, computing node, parameter, processing device, rule, machine readable instruction and vote of at least one entity related to the distributed ledger enabled system.

According to a broad aspect, there is provided a system comprising at least one processor, and at least one storage medium storing instructions, which when executed by the at least one processor, causes the system to carry out the computer-implemented method of any one of the previous aspects.

According to a broad aspect, there is provided a machine-readable medium carrying machine readable instructions, which when executed by a processor of a machine, causes the machine to perform the computer-implemented method of any one of the previous aspects.

According to a broad aspect, there is provided a computer-implemented method for generating a transaction to be added to a distributed ledger enabled system's structured data unit, the computer-implemented method being performed by at least one first computing node, the computer-implemented method comprising: determining a reliability associated with at least one second computing node; obtaining at least one indication of at least one trackable number from the at least one second computing node; associating the at least one indication of the at least one trackable number with the transaction; and providing at least one indication of the transaction to at least one third computing node.

Optionally, in any of the previous aspects, the method further includes determining a reliability associated with at least one of the at least one first computing node, the at least one third computing node and at least one given computing node.

Optionally, in any of the previous aspects, the method is associated with the at least one given computing node.

Optionally, in any of the previous aspects, at least one subset of the at least one given computing node is at least one subset of at least one of the at least one first computing node, the at least one second computing node and the at least one third computing node.

Optionally, in any of the previous aspects, at least a portion of the method is enabled according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, said enabling is associated with at least one of at least one of a shape, form, scope and nature of at least one portion of the transaction, transaction-related data, obtained pre-transaction information, said first determining process and said determining of reliability.

Optionally, in any of the previous aspects, the method further includes associating at least one first indication of at least one obtained first trackable number associated with at least one of the at least one first computing node, the at least one given computing node and the at least one third computing node with the transaction.

Optionally, in any of the previous aspects, associating data with the transaction comprises one of adding said data to said transaction and storing said data on at least one storage medium, obtaining at least one given indication of said data on the at least one storage medium, and adding said at least one given indication to said transaction.

Optionally, in any of the previous aspects, at least one first portion of at least one of the at least one trackable number and the at least one obtained first trackable number is one of pseudo-random and random, and wherein an obtaining process associated with said at least one first portion involves at least one subset of at least one of the at least one first computing node, the at least one given computing node, the at least one second computing node and the at least one third computing node.

Optionally, in any of the previous aspects, the method further includes at least one of tracking and invalidating at least one of the at least one trackable number and the at least one obtained first trackable number, and wherein a performing of at least one of said tracking and invalidating involves at least one subset of at least one of the at least one first computing node, the at least one second computing node, the at least one third computing node, the at least one given computing node, at least one smart contract, system manager, server, computing node, processing device and machine readable instruction related to the distributed ledger enabled system.

Optionally, in any of the previous aspects, the method further includes redetermining a previously determined reliability associated with at least one of the at least one first computing node, the at least one given computing node, the at least one second computing node and the at least one third computing node according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the method further includes enabling a penalizing associated with at least one of the at least one first computing node, the at least one given computing node, the at least one second computing node, the at least one third computing node and at least one concerned computing node, and further wherein at least one of a shape, form, scope and nature of said penalizing is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the method further includes determining at least one of a reliability and a uniqueness associated with at least one of the at least one obtained first trackable number, the at least one trackable number, said transaction-related data, said obtained pre-transaction information and the transaction.

Optionally, in any of the previous aspects, a reliability associated with at least one computing node related to said generating comprises at least one of at least one rule, role, ability to perform at least one previously determined action in the distributed ledger enabled system, reliability metric value, demonstration of trustworthiness and determining of trustworthiness determined by at least one first rightful computing node.

Optionally, in any of the previous aspects, said penalizing comprises at least one of: preventing at least one action to be performed on at least one first asset accessible by at least one subset of at least one of the at least one first computing node, the at least one given computing node, the at least one second computing node, the at least one third computing node and the at least one concerned computing node; losing at least one second asset accessible by at least one subset of at least one of the at least one first computing node, the at least one given computing node, the at least one second computing node, the at least one third computing node and the at least one concerned computing node; and altering at least one reliability metric value associated with at least one of the at least one first computing node, the at least one given computing node, the at least one second computing node, the at least one third computing node and the at least one concerned computing node, and at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, said role comprises at least one of at least one right, responsibility and authority, said at least one of at least one right, responsibility and authority comprising at least one of: delegating a storing of at least one portion of data related to at least one subset of at least one of the at least one first computing node, the at least one second computing node, the at least one given computing node, the at least one third computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; storing at least one additional portion of delegated data related to at least one subset of at least one of the at least one first computing node, the at least one second computing node, the at least one given computing node, the at least one third computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; altering at least one transaction threshold associated with at least one structured data unit related to the distributed ledger enabled system for at least one subset of at least one of the at least one first computing node, the at least one second computing node, the at least one given computing node, the at least one third computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; and performing at least one task, said at least one task comprising at least one of monitoring, modifying, adding, terminating and determining a behavior associated with at least one machine readable instruction related to the distributed ledger enabled system for at least one subset of at least one of the at least one first computing node, the at least one second computing node, the at least one given computing node, the at least one third computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system.

According to a broad aspect, there is provided a system comprising at least one processor, and at least one storage medium storing instructions, which when executed by the at least one processor, causes the system to carry out the computer-implemented method of any one of the previous aspects.

According to a broad aspect, there is provided a machine-readable medium carrying machine readable instructions, which when executed by a processor of a machine, causes the machine to perform the computer-implemented method of any one of the previous aspects.

According to a broad aspect, there is provided a computer-implemented method for validating at least one size of at least one structured data unit, the computer-implemented method being performed by at least one first computing node part of a distributed ledger enabled system, the computer-implemented method comprising: comparing at least one size of at least one structured data unit with at least one threshold; and establishing said validation according to at least one indication of a first result of said comparing, wherein the at least one size is obtained according to at least one combination of at least one trackable number associated with the at least one structured data unit.

Optionally, in any of the previous aspects, the at least one threshold is determined according to at least one of a reliability associated with at least one of: the at least one first computing node; at least one second computing node at least one of associated with the at least one structured data unit and involved in at least one of a processing and a generating of the at least one structured data unit; and a nature associated with the at least one structured data unit, at least one condition, event, action, function, criterion, smart contract, system manager, server, computing node, parameter, processing device, rule, machine readable instruction and vote of at least one entity related to the distributed ledger enabled system.

Optionally, in any of the previous aspects, the at least one structured data unit is at least one of at least one block related to a blockchain and at least one structure of at least one indication of at least one portion of at least one transaction associated with at least one of the at least one second computing node and at least one other computing node, said at least one other computing node being considered to be reliable.

Optionally, in any of the previous aspects, the at least one threshold is determined according to at least one of: at least one rate of at least one type of at least one activity related to the distributed ledger enabled system; and a centralization related to the distributed ledger enabled system.

Optionally, in any of the previous aspects, the method further includes determining a reliability associated with at least one of the at least one first computing node, the at least one other computing node and the at least one second computing node.

Optionally, in any of the previous aspects, at least one first portion of the at least one trackable number is one of pseudo-random and random, and wherein an obtaining process associated with said at least one first portion involves at least one subset of at least one of the at least one first computing node, the at least one second computing node and the at least one structured data unit.

Optionally, in any of the previous aspects, the method further includes determining at least one of a reliability and a uniqueness associated with the at least one structured data unit.

Optionally, in any of the previous aspects, said validating comprises at least one of tracking and invalidating at least one relevant trackable number associated with the at least one structured data unit, and further wherein a performing of at least one of said tracking and invalidating involves at least one subset of the at least one first computing node, at least one smart contract, system manager, server, computing node, processing device and machine readable instruction related to the distributed ledger enabled system.

Optionally, in any of the previous aspects, the method further includes redetermining a previously determined reliability associated with at least one of the at least one first computing node, the at least one second computing node and the at least one other computing node according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, the method further includes enabling a penalizing associated with at least one of the at least one first computing node, the at least one second computing node and at least one concerned computing node, and further wherein at least one of a shape, form, scope and nature of said penalizing is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, said penalizing comprises at least one of: preventing at least one action to be performed on at least one first asset accessible by at least one of the at least one first computing node, the at least one second computing node and the at least one concerned computing node; losing at least one second asset accessible by at least one of the at least one first computing node, the at least one second computing node and the at least one concerned computing node; and altering at least one reliability metric value associated with at least one of the at least one first computing node, the at least one second computing node and the at least one concerned computing node; and at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, a reliability associated with at least one computing node related to said validating comprises at least one of: at least one rule, role, ability to perform at least one previously determined action in the distributed ledger enabled system, reliability metric value, demonstration of trustworthiness and determining of trustworthiness determined by at least one first rightful computing node.

Optionally, in any of the previous aspects, at least a portion of the method is enabled according to at least one of at least one condition, event, action, function, criterion, smart contract, system manager, server, computing node, parameter, processing device, rule, machine readable instruction and vote of at least one entity related to the distributed ledger enabled system.

Optionally, in any of the previous aspects, said role comprises at least one of at least one right, responsibility and authority, said at least one of at least one right, responsibility and authority comprising at least one of: delegating a storing of at least one portion of data related to at least one subset of at least one of the at least one first computing node, the at least one second computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; storing at least one additional portion of delegated data related to at least one subset of at least one of the at least one first computing node, the at least one second computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; altering at least one transaction threshold associated with at least one structured data unit related to the distributed ledger enabled system for at least one subset of at least one of the at least one first computing node, the at least one second computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; and performing at least one task, said at least one task comprising at least one of monitoring, modifying, adding, terminating and determining a behavior associated with at least one machine readable instruction related to the distributed ledger enabled system for at least one subset of at least one of the at least one first computing node, the at least one second computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system.

According to a broad aspect, there is provided a system comprising at least one processor, and at least one storage medium storing instructions, which when executed by the at least one processor, causes the system to carry out the computer-implemented method of any one of the previous aspects.

According to a broad aspect, there is provided a machine-readable medium carrying machine readable instructions, which when executed by a processor of a machine, causes the machine to perform the computer-implemented method of any one of the previous aspects.

The skilled addressee will appreciate that at least one embodiment of the methods and the systems disclosed are of great advantages for various purposes.

A first advantage of at least one embodiment of the methods and the systems disclosed herein is that the present technology enables to effectively process a transaction without needing to significantly rely on investing resources, such as monetary resources, like PoS, PoW and PoSpace. Instead, the present technology uses a principle of probabilistic equality in which nodes have an equal opportunity to generate the next block given that the nodes respect at least one determined rule.

A second advantage of at least one embodiment of the methods and the systems herein is that the present technology enables a detection of potentially unwanted events and/or the countering of potentially unwanted events by, according to at least one defined rule, determining a potentially suspicious pattern associated with at least one node and enabling a punishing of the at least one node. For instance, a Sybil attack, which consists of attempting an attack on a blockchain by creating a large quantity of at least one node to take over a decisional related power of a blockchain, could potentially be countered by using a defined rule establishing that a given computing node is required to have a determined reliability metric value to act as an enforcer, a generator and/or any other relevant role. In at least one embodiment, even if the given computing node attempts a Sybil attack without enabling the detection of the potentially unwanted blockchain-related event and/or the countering of the potentially suspicious pattern enabled by said at least one rule, using a system comprising a plurality of rules, the suspicious pattern could still be determinable and penalizable, according to a nature, form and scope of said system. The skilled addressee will appreciate that the potentially suspicious pattern may be provided in various forms. In at least one embodiment, a blockchain using the present technology could detect a potentially suspicious pattern selected from a group comprising a malicious rotating and/or an alternating of nodes acting as or being selected as an enforcer, a generator and/or any other relevant role, ignoring and/or prioritizing transactions from or for at least one specific computing node when generating or validating a block as a generator or an enforcer, selecting an enforcer and/or a partner that was enabled in a same timeframe as a generator, and/or a requester and/or any other relevant role, processing a transaction of a computing node enabled in a same timeframe as a generator or an enforcer when generating a block or validating a block, processing a transaction of a computing node enabled in a same timeframe as a majority of other computing nodes when generating and/or validating a block and/or the like. In at least one embodiment, an enforcer and/or a partner is established according to at least one of a generation of a block, a blockchain-related event in the blockchain and a blockchain-related action in the blockchain. Therefore, a reliability metric value associated with a node performing any of the aforementioned potentially suspicious patterns could be impacted negatively when detected, and the node may be penalized and/or may become blacklisted.

A third advantage of at least one embodiment of the methods and systems disclosed herein is that since the present technology enables nodes to be evaluated and to detect and/or counter at least one potentially suspicious pattern, attacks such as a 51% attack, i.e., when a majority of nodes attempt to take over a decisional power in the network to perform malicious actions such as maliciously updating at least one block and/or generating at least one malicious block in a blockchain and/or generating and/or processing at least one malicious transaction in a blockchain, could be detectable and/or possible to counter. In one or more exemplary and non-limiting embodiments, a system using the present technology could counter a 51% attack by adding rules and/or strategies such as:
a) A rule aiming at preventing a given node to act as an enforcer, a generator and/or any other relevant role by reducing its reliability metric value when it performs a recognizable and potentially suspicious pattern, thereby reducing the reliability metric value related to said given node below a determined region in a reliability metric value distribution, such as an enforcer region or a blacklist region;
b) A strategy aiming at enabling sharding, where a given generator and/or requester and/or any other relevant role is only authorized to interact with a respective enforcer and/or a partner and/or any other relevant role if said respective enforcer and/or a partner and/or any other relevant role is comprised in a different shard than said given generator and/or requester and/or any other relevant role, the given generator and/or requester and/or any other relevant role being associated with said shard based on a given blockchain-related event, the given blockchain-related event being triggered when a given condition is met, such as a determined number of at least one block, a determined amount of time elapsed, and/or the like;
c) A strategy aiming at limiting a given node to repeatedly produce transactions of a given type to at least one of a given wallet and a given other computing node over a determined period of time, thereby limiting said computing node from repeatedly interacting with at least one specific computing node and/or producing transactions of a given type to at least one specific wallet. In at least one embodiment, the strategy further comprises requiring an amount of at least one asset comprised in a wallet associated with said given node to be comprised in a determined range to be able to act as an enforcer, a generator and/or any other relevant role, thereby limiting a mass creation of malicious wallets and/or nodes. In at least one embodiment, the strategy also comprises limiting said computing node to interact with at least one other node associated with at least one other wallet comprising an amount of at least one asset below a minimum threshold, said minimum threshold being either static or determined based on a plurality of wallets; and/or
d) A strategy aiming at updating, after a determined number of at least one block, the reliability metric value associated with a given node if said reliability metric value is over an upper limit in a reliability metric value distribution in relation to an average reliability metric value, said average reliability metric value being based on a plurality of nodes, thereby limiting said given node from repeatedly interacting with a specific enforcer, generator and/or any other relevant role. In at least one embodiment, the strategy further comprises temporarily requiring said given node to act as an enforcer, a generator and/or any other relevant role in relation to a reliability-related event, such as said reliability metric value updating after the determined number of at least one block, until at least one node can act as an enforcer, a generator and/or any other relevant role.

### BRIEF DESCRIPTION OF THE DRAWINGS

Having thus generally described the nature of the invention, reference will now be made to the accompanying drawings, showing by way of illustration example of at least one embodiment thereof and in which:

FIG. 1 is a flowchart illustrating an embodiment of a method for generating a block of a blockchain, in accordance with at least one embodiment;

FIG. 2 is a schematic diagram illustrating an embodiment of a method involving a node generating a new blockchain-related number, in accordance with at least one embodiment;

FIG. 3 is a chart illustrating an embodiment of a distribution of at least one reliability metric, such as a reliability metric value, of at least one entity, such as a node, or associated wallet thereof, part of a blockchain, in accordance with at least one embodiment;

FIG. 4 is a flowchart illustrating an embodiment of a processing step of at least one embodiment of the method of FIG. 1, wherein a first node (also referred to as a generator) is selecting a second node (also referred to as an enforcer), in accordance with at least one embodiment;

FIG. 5 is a flowchart illustrating an embodiment of a processing step of the method of FIG. 1, wherein a first node compares at least one portion of its mempool and/or transaction list with at least one portion of at least one second node's mempool and/or transaction list, in accordance with at least one embodiment;

FIG. 6 is a schematic diagram illustrating an embodiment of a system comprising a plurality of nodes part of a blockchain wherein a given node (also referred to as a generator) is involved in an adding of a block, in accordance with at least one embodiment;

FIG. 7 is a flowchart illustrating an embodiment of a method for generating a transaction to be associated with a block, in accordance with at least one embodiment;

FIG. 8 is a flowchart illustrating an embodiment of a processing step of at least one embodiment of the method of FIG. 7, wherein a first node (also referred to as a requester) is selecting a second node (also referred to as a partner), in accordance with at least one embodiment;

FIG. 9 is a schematic diagram illustrating an embodiment of a system comprising a plurality of nodes part of a blockchain wherein a given node (also referred to as a generator) is involved in a generating of a transaction, in accordance with at least one embodiment;

FIG. 10 is a schematic diagram illustrating an electronic device which may be used in accordance with one or more non-limiting embodiments of the present technology;

FIG. 11 is a flowchart illustrating an embodiment of a method for generating a block of a blockchain, in accordance with at least one embodiment;

FIG. 12 is a flowchart illustrating an embodiment of a method for generating a transaction to be comprised in a block, in accordance with at least one embodiment;

FIG. 13 is a schematic diagram illustrating an embodiment of at least one part of a structure of a block, in accordance with at least one embodiment;

FIG. 14 is a flowchart illustrating an embodiment of a method for processing a distributed ledger enabled system's structured data unit, in accordance with at least one embodiment;

FIG. 15 is a flowchart illustrating an embodiment of a method for validating at least one portion of a distributed ledger enabled system's structured data unit, in accordance with at least one embodiment;

FIG. 16 is a flowchart illustrating an embodiment of a method for obtaining a trackable number, in accordance with at least one embodiment;

FIG. 17 is a flowchart illustrating an embodiment of a method for generating a transaction to be added to a distributed ledger enabled system's structured data unit, in accordance with at least one embodiment; and

FIG. 18 is a flowchart illustrating an embodiment of a method for validating at least one size of at least one structured data unit, in accordance with at least one embodiment.

### DETAILED DESCRIPTION

In the following description of multiple of embodiments of the invention, references to the accompanying drawings are by way of illustration of an example by which at least one embodiment of the invention may be practiced.

The terms “an aspect”, “an embodiment”, “embodiment”, “embodiments”, “the embodiment”, “the embodiments”, “at least one embodiment”, “some embodiments”, “certain embodiments”, “one embodiment”, “another embodiment”, “one exemplary embodiment”, “at least one embodiment” and the like typically refers to “one or more (but not all) embodiments of the disclosed invention(s),” unless expressly specified otherwise.

The terms “including”, “comprising” and variations thereof may be used to mean to “including but not limited to”, unless expressly specified otherwise.

The terms “one”, “one or more”, “a”, “an”, “another” and “the” may be used to mean “at least one”, unless expressly specified otherwise.

The expressions “a number of”, “an amount of”, “a quantity of”, “a range of” and like terms typically refer to at least one of at least one determined subject, unless specified otherwise.

The verbs “select”, “choose”, and like verbs may be used interchangeably.

The term “plurality” typically refers to “two or more”, unless expressly specified otherwise.

The verbs “add”, “provide” and like verbs typically refer to at least one of at least one adding, at least one providing, at least one putting in, at least one connecting, at least one joining, at least one appending, at least one attaching and at least one including related to at least one determined subject, unless expressly specified otherwise.

The expression “associated with”, “associated to” and like expressions may be used to have at least one portion of at least one determined subject at least one of relate to and associate with at least one other subject.

The term “herein” means “in the present application”, unless expressly specified otherwise.

The term “e.g.” and like terms mean “for example”, unless expressly specified otherwise.

The term “i.e.” and like terms mean “that is”, unless expressly specified otherwise.

The term “either” and like terms mean “one of”, unless expressly specified otherwise.

The term “node” and the expression “computing node” typically refer to the same element herein, unless specified otherwise. The skilled addressee will appreciate that a node comprises at least one of a processor, a storage system and a communication interface, and is typically associated with at least one wallet. In at least one embodiment, the node is selected from a group comprising a computer, a laptop, a cellphone, a smartphone, a desktop computer, a server, a device, a tablet, a processing device, a storage device, a device comprising a digital interface and the like, unless expressly specified otherwise.

The term “transaction” typically refers to a transfer of an asset, an instruction, or data from one or more parties to one or more other parties. However, various forms of digital information and/or data may be transferred in a transaction, such as non-fungible tokens (NFTs), digital identities, and/or any data of any type, form, shape, nature and/or scope involving at least one entity part of a distributed ledger enabled system, wherein said digital information and/or data may or may not have monetary value, according to at least one embodiment, unless expressly specified otherwise.

The expression “data of a blockchain” typically refers to at least one indication of at least one portion of data related to a distributed ledger enabled system, unless expressly specified otherwise.

The expression “store a blockchain”, “storing a blockchain” and like expressions typically refers to storing data relating to a blockchain, such as at least one indication of one or more previously verified transactions in the blockchain, unless expressly specified otherwise.

The plural form of given terms, such as “transactions”, “generators”, “enforcers”, “rules”, “nodes”, “patterns”, “resources”, “wallets”, “computing nodes”, “assets”, “reliability metric values”, “smart contracts”, “events”, “blocks” and like terms may be used to refer to their singular form depending on at least one of at least one context and at least one embodiment, unless expressly specified otherwise.

The term “mempool” typically refers to a data storing system for storing information, such as at least one indication of at least one portion of at least one transaction, related to at least one entity, such as at least one node, or associated wallet thereof, part of a distributed ledger enabled system, unless expressly specified otherwise.

The verbs “avoid”, “limit”, “prevent”, “stop”, “intercept”, “shut out”, “block”, “arrest”, “suppress”, “prohibit”, “disallow”, “forbid”, “excluding”, “proscribing” and like verbs typically refer to at least one of at least one avoiding, at least one limiting, at least one preventing, at least one stopping, at least one intercepting, at least one shutting out, at least one blocking, at least one arresting, at least one suppressing, at least one prohibiting, at least one disallowing, at least one forbidding, at least one excluding and at least one proscribing related to at least one determined subject, unless expressly specified otherwise.

The term “generator” typically refers to a given role associated with at least one entity, such as at least one node, or associated wallet thereof, related to a distributed ledger enabled system. Said role participates in at least one generating process of at least one structured data unit by at least one of processing at least one at least initiated blockchain-related action, processing at least one at least initiating blockchain-related action and at least initiating at least one blockchain-related action related to at least one indication of data related to said at least one generating process, unless expressly specified otherwise.

The term “enforcer” typically refers to a given role associated with at least one entity, such as at least one node, or associated wallet thereof, related to a distributed ledger enabled system. Said role participates, such as by performing at least one portion of at least one validating process, in at least one generating process of at least one structured data unit, at least one enforcer and/or generator participating thereof, by at least one of processing at least one at least initiated blockchain-related action, processing at least one at least initiating blockchain-related action and at least initiating at least one blockchain-related action related to at least one indication of data related to at least one of at least one generator and at least one enforcer, unless expressly specified otherwise.

The term “requester” typically refers to a given role associated with at least one entity, such as at least one node, or associated wallet thereof, related to a distributed ledger enabled system. Said role participates in at least one transaction generation process, such as by at least enabling, such as by at least initiating, said transaction generation process, processing at least one indication of at least one portion of at least one related transaction and/or related transaction generation process' step(s), unless expressly specified otherwise.

The term “partner” typically refers to a given role associated with at least one entity, such as at least one node, or associated wallet thereof, related to a distributed ledger enabled system. Said role participates in at least one transaction generation process, such as by at least enabling of at least one providing of at least one indication of at least one number to at least one node related to said transaction generation process and/or related transaction generation process' step(s), unless expressly specified otherwise.

The term “reliability metric value” and like terms/expressions typically refer to a metric, such as a score, related to at least one entity, such as at least one node, or associated wallet thereof, and influenced by at least one of at least one blockchain-related event, at least one at least initiated blockchain-related action, at least one activity, at least one behavior, at least one indication of at least one portion of provided data and the like made by said at least one entity in a distributed ledger enabled system, unless expressly specified otherwise.

The term “rule” typically refers to at least one of at least one machine readable instruction and at least one of various types of interpretable instruction provided in various forms in which a computing node is determined in relation to at least one set of at least one parameter and at least one condition. The at least one rule is at least enabled for at least one portion of a plurality of computing nodes and relates to at least one reliability metric value associated with at least one computing node, unless expressly specified otherwise.

The term “blockchain” typically refers to at least one portion of an implementation of a distributed ledger enabled system, unless expressly specified otherwise.

The term “block” typically refers to at least one indication of at least one structured data unit related to a distributed ledger enabled system, unless expressly specified otherwise.

The term “a portion” typically refers to an entirety or at least one subset of at least one determined subject, unless expressly specified otherwise.

The expression “system manager” typically refers to at least one entity, such as at least one node, or associated wallet thereof, which possesses at least one of at least one type of authority varying in at least one of a form, a shape, a nature and a scope granting at least one superiority aspect over at least one other entity, such as at least one node, or associated wallet thereof, related to a distributed ledger enabled system, such as:
having a capacity of at least enabling at least one rule,
defining at least one value in at least one of a determining process, a relating process and an enabling process,
bypassing a reliability metric system to at least one of relate, assign and enable at least one node in relation to a specific role,
enabling and/or authorizing a blockchain-related event including: enabling a processing of an at least initiated blockchain-related action, enabling a processing of a blockchain-related action, initiating a blockchain-related action related to an indication of data related to the distributed ledger enabled system, and other privileged initiated blockchain-related action and/or the like, unless expressly specified otherwise.

The term “hash”, “hashing” typically refers to any kind and/or variant of at least one “one-way cryptographic encryption”, unless expressly specified otherwise.

The expression “block size” typically refers to at least one of an adjustable and a non-adjustable size, such as one calculated thereof, associated with at least one data structure related to a distributed ledger enabled system, such as one related to at least one number associated with at least one indication of at least one portion of at least one transaction associated with at least one data structure related to a distributed ledger enabled system, unless expressly specified otherwise.

The expressions “maximum transaction threshold” and “maximum threshold size” typically refer to at least one number related to at least one maximum number of at least one indication of at least one portion of at least one transaction for at least one indication of data related to a distributed ledger enabled system, unless expressly specified otherwise.

The expressions “minimum transaction threshold” and “minimum threshold size” typically refer to at least one number related to at least one minimum number of at least one indication of at least one portion of at least one transaction for at least one indication of data related to a distributed ledger enabled system, unless expressly specified otherwise.

The term “reliable” typically refers to at least one of at least enabling, establishing, assessing and determining of at least one of a status, behavior, network usage, data movement, available at least one resource and at least one at least initiated blockchain-related action of at least one entity, such as at least one node, or associated wallet thereof, at least enabling at least one predicting related to at least one probability of at least one at least initiating of at least one at least partially anomalous blockchain-related action associated with at least one given entity, such as the at least one entity and/or at least one entity related to the at least one entity, related to a distributed ledger enabled system, unless expressly specified otherwise.

The verb “compare” typically refers to at least one of at least one interacting, at least one comparing, at least one corresponding, at least one contrasting, at least one analyzing, at least one at least initiating of at least one blockchain-related action, at least one at least enabling of at least one processing of at least one blockchain-related action, at least one at least enabling of at least one processing of at least one at least initiated blockchain-related action and at least one determining related to at least one part related to at least one determined subject, unless expressly specified otherwise.

The verb “sign” typically refers to at least one of at least one determining, at least one signing and at least one processing of at least one determined subject, in which at least one cryptographic algorithm, such as at least one asymmetric encryption algorithm, is involved, unless expressly specified otherwise.

The term “wallet” typically refers to at least one of at least one device, at least one physical medium, at least one storage medium, at least one program, at least one machine readable instruction, at least one service, at least one portion and/or at least one result of at least one cryptography related algorithm and at least one system, in which at least one cryptographic algorithm, such as at least one asymmetric encryption algorithm, is involved and that at least enables at least one of at least one ownership and at least one processing of at least one asset, at least one encrypting of information, at least one signing of information and at least one relevant information, such as at least one cryptography related key, unless expressly specified otherwise.

The verb “compiling” typically refers to at least one obtaining, at least one assembling, at least one gathering, at least one evaluating, at least one interaction with at least one entity, such as at least one node, or associated wallet thereof, part of a distributed ledger enabled system, at least one processing and at least one compiling in relation to at least one determined subject, unless expressly specified otherwise.

The term “determine” typically refers to at least one of at least one entity that has been identified and/or is identified as at least related to a given context and at least one entity that may be subject to at least one of at least one determining, at least one classifying, at least one selecting, at least one gathering, at least one specifying, at least one recording, at least one of putting, at least one choosing, at least one deciding, at least one compiling, at least one separating, at least one recording, at least one electing, at least one comprising, at least one receiving, at least one verifying, at least one inserting, at least one confirming, at least one validating, at least one detecting, at least one allowing, at least one acquiring, at least one establishing, at least one interacting, at least one rebalancing, at least one indicating, at least one creating, at least one at least initiating of at least one blockchain-related action, at least one at least enabling, at least one evaluating, at least one performing, at least one deeming, at least one of separating, at least one modifying, at least one specifying, at least one processing, at least one considering, at least one obtaining and at least one providing in relation to at least one determined subject, unless expressly specified otherwise.

The terms “verification”, “validation”, “confirmation” and like terms and the verbs “verify”, “validate”, “confirm” and like verbs typically refer to at least one of:
enabling of at least one process related to a blockchain-related action,
enabling of at least one process related to at least one initiated blockchain-related action,
initiating of at least one blockchain-related action,
verifying, at least one verification, at least one validating, at least one validation, at least one confirming, at least one confirmation, at least one establishing, at least one determining and at least one blockchain-related event related to at least one determined subject, unless expressly specified.

The expression “any other relevant role” typically refers to at least one of various other relevant role which may be implemented in at least one embodiment of the present technology, unless expressly specified otherwise.

The term “blacklist” typically refers to at least one punishing, at least one demarking and at least one penalizing of at least one entity, such as at least one node, or associated wallet thereof, part of a distributed ledger enabled system, unless expressly specified otherwise.

The verbs “punish”, “penalize”, “disadvantage” and like verbs typically refer to at least enabling at least one of at least one penalizing, at least one punishing, at least one disadvantaging, at least one diminishing, at least one handicapping and at least one sanctioning of at least one entity, such as at least one node, or associated wallet thereof, of a distributed ledger enabled system, unless expressly specified otherwise.

The verbs “generate”, “obtain” typically refer to at least one of at least one generating, at least one obtaining, at least one acquiring and at least one of at least enabling a processing of an at least initiated blockchain-related action, at least enabling a processing of an at least initiating blockchain-related action and at least initiating a blockchain-related action related to at least one subject, unless expressly specified otherwise.

The terms “fraudulent”, “malicious”, “suspicious” and like terms typically refer to at least one at least potentially unwanted blockchain-related event, such as at least one of at least one determined fraudulent blockchain-related event, at least one determined suspicious blockchain-related event and at least one determined malicious blockchain-related event, unless expressly specified otherwise.

The expression “indication” typically refers to at least one of at least one number which is at least one of a smaller size, a greater size and a similar size in relation to a related indicated at least one value, binary data related to the indicated at least one value, at least one identifier related to the indicated at least one value, at least one series of characters which is at least one of a smaller size, a greater size and a similar size in relation to the related indicated at least one value, at least one machine readable instruction allowing at least one obtaining of the at least one value, at least one blockchain-related event related to the indicated at least one value and the indicated at least one value itself, unless expressly specified otherwise.

The term “number” as used herein may refer to a trackable number, unless indicated otherwise.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed technologies are widely applicable to numerous embodiments, as is readily apparent from the disclosure. One of ordinary skill in the art will recognize that the disclosed technologies may be practiced with various modifications and alterations, such as structural and logical modifications. Although particular features of the disclosed technologies may be described with reference to one or more particular embodiments and/or drawings, it should be understood that such features are not limited to usage in the one or more particular embodiments or drawings with reference to which they are described, unless expressly specified otherwise.

The skilled addressee will appreciate that the technology presented herein is not bound to any particular brand and/or label, whether already widely known or not. The skilled addressee will appreciate that a technology part of a blockchain is often labelled and/or branded to relate to transparency, attractiveness and/or understandability, which may help in a process of establishing trust, determining at least one incentive and/or engaging with the branded and/or the labelled technology in relation to a consumer. The technology presented herein may be referred to as Proof of Randomness (PoR), Proof of Ethic (PoE), and/or any suitable brand and/or label per se. The skilled addressee will appreciate that the above-mentioned brands and/or labels may be associated with one or more other technology not related to the one presented herein. At least one of the above-mentioned brands and/or labels may still be considered as relevant for the branding and/or the labelling of the current technology.

With all this in mind, at least one embodiment of the present invention is directed to methods and systems for achieving a consensus and its use thereof.

At least one embodiment of the present invention will be described in detail hereinafter with reference to the drawings and specific embodiments.

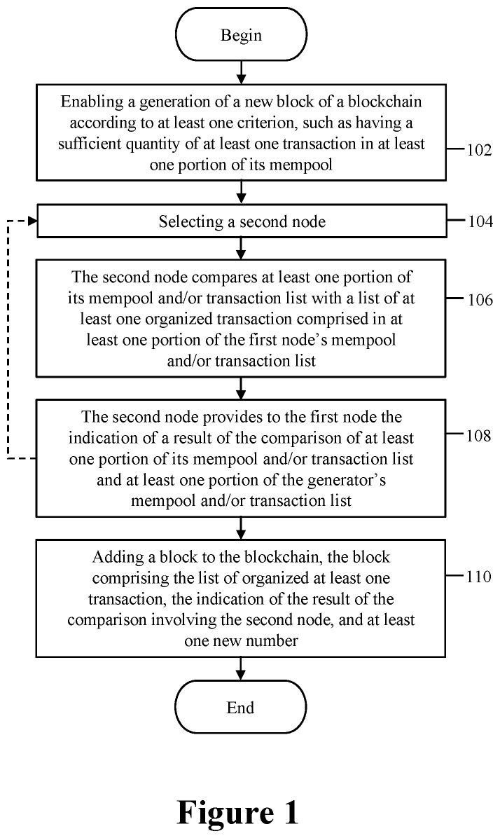

FIG. 1 is a flowchart illustrating an embodiment of a method for generating a block of a blockchain. To generate a block using the present technology, a first node (hereinafter referred to as a generator), according to at least one criterion and/or blockchain-related event, such as a criterion being determined as having a relevant number of at least one transaction in at least one portion of its mempool determines a second node (hereinafter referred to as an enforcer) to compare at least one transaction related to at least one portion of their respective mempool and/or transaction list. In at least one embodiment, the generator selects an enforcer amongst other nodes part of the blockchain. In at least one embodiment, the transaction list comprises an organized portion of the transactions part of the at least one portion of the mempool associated with the generator. In at least one embodiment, at least one of the at least one portion of the mempool of the generator and the at least one portion of the mempool of the enforcer is at least one of organized and unorganized prior the determining of the second node. In at least one embodiment, the at least one portion of the mempool comprises only validated transactions, while unvalidated transactions are stored in a different storage medium and/or storage system.

One optional or a required role of a node is storing in at least one portion of its mempool a transaction that occurred involving the node and/or any other node part of the blockchain. In at least one embodiment, a node relates to at least one criterion and/or blockchain-related event, such as a criterion determined as having a sufficient number of at least one transaction in the at least one portion of the node's mempool, which enables the node to generate a block and to potentially add it to the blockchain. In at least one embodiment, the node adds the block to the blockchain. In at least one related embodiment, at least one other node processes the block prior the node adding it to the blockchain. In at least one embodiment, a plurality of nodes is involved in the generating of the block, at least one node of said plurality of nodes processing data associated with the block and/or the block itself prior at least one other node and/or the node and/or said at least one node adding it to the blockchain. In at least one embodiment, a second node obtains at least one portion of said block from the node, processes it and adds it to the blockchain. The skilled addressee will appreciate that the processing of data and/or the processing of the block and/or the processing of the at least one portion of the block may be provided in various forms, such as validating at least one portion of the data and/or the block and/or the at least one portion of the block, removing a portion of said data and/or said block and/or said at least one portion of the block, altering a portion of said data and/or said block and/or said at least one portion of the block, signing a portion of said data and/or said block and/or said at least one portion of the block and at least one of adding additional data to said data and/or said block and/or said at least one portion of the block and combining additional data with said data and/or said block and/or said at least one portion of the block in association with a given node involved in the processing of data and/or the processing of the block and/or the processing of the at least one portion of the block. The skilled addressee will also appreciate that a verification of a transaction associated with the block and/or the data and/or the at least one portion of the block enables to avoid comprising fraudulent transactions, and/or multiple forms of fraudulent data per se, in the block and/or the data and/or the at least one portion of the block. In at least one embodiment, a given optional or required role of a node involves storing data of the blockchain within its memory. In at least one embodiment, another given optional or a required role and/or an extension of a given optional or a required role can be at least partially delegated to another entity part of the blockchain, such as a node. The skilled addressee will appreciate that said delegating enables a supporting of less powerful devices to act as nodes, such as phones, tablets, and/or the like.

According to processing step 102, a first node (hereinafter referred to as generator) enables a generation of a new block of a blockchain according to at least one criterion, such as having a sufficient number of at least one transaction in at least one portion of its mempool. The skilled addressee will appreciate that at least one criterion and/or blockchain-related event may be of various types, some of which are detailed hereinbelow.

In at least one embodiment, the generator enables a generating of a block once at least one portion of its mempool comprises at least one transaction. In at least one other embodiment, the generator enables a generating of a block once at least one portion of its mempool is completely filled with transactions. In at least one embodiment, an enabling of a generation of a block is enabled according to at least one criterion and/or blockchain-related event, such as a condition determined as a determined amount of time elapsing and/or a determined number of at least one block generated in relation to a determined blockchain-related event such as an indication of a generating of a previous block, a determining of a previous transaction and/or the like. In at least one embodiment, the generator enables a generating of a block according to at least one machine readable instruction and/or request enabling the generation of said block, which involves a smart contract, a system manager, a server, a computing node, a processing device and/or a software.

According to processing step 104, the first node (hereinafter referred to as generator) selects a second node (hereinafter referred to as enforcer). In at least one embodiment, to select the second node, the first node first obtains a number associated with at least one identifier associated with the first node, or associated wallet thereof, and with at least one previous and/or current block. The skilled addressee will appreciate that the number is used for various functions, mechanisms, systems and methods part of the blockchain, such as recording and/or generating a transaction and/or a block part of the blockchain, selecting and/or communicating and/or interacting with an entity and/or a wallet and/or a node part of the blockchain and/or the like. The skilled addressee will also appreciate that the at least one previous and/or current block may be selected from a range in a block distribution recoverable from the blockchain in accordance with the at least one embodiment.

In at least one embodiment, the second node, or associated wallet thereof, is associated with at least one additional role, the at least one role being at least one of a partner role, a generator role, and/or any other relevant role, an enabling of the at least one additional role being associated with at least one previous and/or current block and/or a blockchain-related state part of the blockchain. In at least one embodiment, the at least one additional role is enabled by a processing of a plurality of blocks part of the blockchain, such as by evaluating at least one blockchain-related action performed by and/or involving the second node, or associated wallet thereof. In at least one embodiment, the first node selects a second node according to at least one machine readable instruction and/or request involving a smart contract, a system manager, a server, a computing node, a processing device and/or a software. In at least one embodiment, instead of a first node selecting a second node, a given second node selects the first node according to at least one emitted blockchain-related event by at least one of the first node, a smart contract, a system manager, a server, a computing node, a processing device and/or a software, such as a blockchain-related event indicating that the first node is ready to interact with a second node for a blockchain-related action requiring said given second node. In at least one embodiment, the first node requests at least one of a smart contract, a system manager, a server, another computing node, a processing device and a software to select the second node. The skilled addressee will appreciate that a process similar to a selecting of a second (first) node by a first (second) node may be suited for various other relevant roles and/or other relevant interacting and/or communication processes between at least two entities part of the blockchain, enabling a traceability of said interacting and/or communication process, the traceability being enabled due to the nature of said interacting and/or communication process.

After obtaining the number, the first node obtains a reliability metric value distribution associated with at least one node part of the blockchain. In at least one embodiment, in a case where a second node, or associated wallet thereof, associated with the reliability metric value distribution has a reliability metric value smaller or smaller or equal to an upper limit of a blacklist region comprised in the reliability metric value distribution, the first node reprocesses step 104. In at least one embodiment, the first node obtains, using said number, a reliability metric value subset in the reliability metric value distribution according to at least one determined reliability metric value threshold. In at least one embodiment, the at least one determined reliability metric value threshold comprises a lower bound reliability metric value threshold and an upper bound reliability metric value threshold. In at least one embodiment, the at least one determined reliability metric value threshold is at least one of determined and redetermined according to at least one criterion and/or blockchain-related event, such as a number of active enforcers part of the blockchain, a right or restriction granted or imposed to a given entity, such as a node, by another entity part of the blockchain, a determined number of at least one block generated, a rule and/or the like. In at least one embodiment, the first node selects a second node based on the subset of the reliability metric value distribution. In at least one related embodiment, the first node uses an additional evaluation method, such as another reliability metric system based on a different set of rules than the reliability metric value, when selecting the second node. The skilled addressee will appreciate that by determining at least one reliability metric value threshold in the reliability metric value distribution for selecting the second node, the second node is guaranteed to have followed at least one determined rule part of the blockchain and is therefore more likely to perform at least one given blockchain-related action legitimately. In at least one embodiment, the subset is involved in a plurality of selections of second nodes. In at least one embodiment, the subset is reobtained after a defined quantity of at least one selection. The skilled addressee will appreciate by the skilled addressee that the reliability metric value distribution may be obtained for various other purposes than to obtain a reliability metric value or a reliability metric value subset thereof, and that these two operations are independent from one another. In at least one embodiment where a plurality of numbers is obtained by a given first node instead of a single number, each number may be associated with a different evaluation metric distribution, such as a reliability metric value distribution, and a corresponding subset of each different evaluation metric distribution is obtained and processed, such as by allocating a weight of importance to each subset prior evaluating their importance, prior determining at least one second node. In at least one embodiment, instead of a single first node, a plurality of first nodes participates in a selecting of a second node. In at least one embodiment, at least one signature and/or co-signature is involved in a given selecting of a second node and/or, in at least one embodiment, an interacting between a plurality of first nodes. In at least one embodiment, a plurality of first nodes is involved in the generating of the block instead of a single first node, for instance by contributing and/or processing different part of block-related data and/or reprocessing and/or approving block-related data, such as by providing at least one signature and/or co-signature.

According to processing step 106, the second node (enforcer) compares at least one portion of its mempool and/or transaction list with a list of at least one organized transaction comprised in at least one portion of the first node's (generator) mempool and/or transaction list. In at least one embodiment, the at least one portion of the second node's mempool and/or transaction list is compared with a list of unorganized transactions. The skilled addressee will appreciate that at least one first portion of a node's mempool and/or transaction list may differ from at least one second portion of another node's mempool and/or transaction list due to blockchain-related latency, a fraudulent intent and/or the like. In at least one embodiment, since a node may delegate part or all of its mempool to another node prior generating a block, the other node, if fraudulent, may attempt to record a fraudulent transaction in the blockchain by providing the node said fraudulent transaction or recording it in the blockchain thereof if acting as a generator. The skilled addressee will appreciate that a comparison of at least one transaction associated with the at least one portion of the mempool and/or transaction list of the enforcer with one associated with the at least one portion of the mempool and/or transaction list of the generator attempt at least enabling a determining of legitimacy, such as determining if the generator purposedly aims at including and/or excluding at least one specific transaction in the to be generated block, which could be malicious behavior, according to at least one embodiment. In at least one embodiment, the determining of legitimacy comprises comparing a quantity of at least one difference between the at least one portion of the generator's mempool and/or transaction list and the at least one portion of the enforcer's mempool and/or transaction list with at least one determined difference threshold. In at least one embodiment, a role of an enforcer is to determine that the at least one transaction comprised in the at least one portion of the generator's mempool and/or transaction list is organized according to its associated number, determining if the generator is including and/or excluding at least one specific transaction to be and/or not to be compared, which could be malicious behavior. In at least one embodiment, at least one transaction comprised in the at least one portion of the generator's mempool and/or transaction list and/or the at least one portion of the enforcer's mempool and/or transaction list comprises a plurality of associated numbers. In at least one related embodiment, at least one mathematical operation is performed on at least one portion of the plurality of associated numbers to obtain a single number representing said at least one portion of the plurality of associated numbers. In at least one embodiment, at least one portion of at least one of the generator's mempool and/or transaction list and the at least one portion of the enforcer's mempool and/or transaction list is organized differently than at least one other portion of at least one of the generator's mempool and/or transaction list and the at least one portion of the enforcer's mempool and/or transaction list according to at least one criterion, at least one condition and/or at least one blockchain-related event, such as a rule and/or an instruction of another entity, such as a node, part of the blockchain. In at least one embodiment, at least one portion of the mempool and/or transaction list of at least one given computing node is compared with the at least one portion of the enforcer's mempool and/or transaction list, and so, complementarily and/or in relation with the at least one portion of the generator's mempool and/or transaction list. The skilled addressee will appreciate that a form, shape, amount, nature and/or scope associated with the comparison may vary, according to at least one embodiment.

In at least one embodiment, the enforcer compares at least one portion of its mempool and/or transaction list with at least one portion of the mempool and/or transaction list associated with the generator. The enforcer thereafter obtains an indication of a result of said comparing, the indication being associated with at least one indication of at least one transaction comprised in the at least one portion of the generator's mempool and/or the transaction list and not comprised in at least one portion of its mempool and/or transaction list and/or at least one transaction that is comprised in at least one portion of its mempool and/or transaction list and is not comprised in the at least one portion of the generator's mempool and/or the transaction list. In at least one embodiment, at least one portion of the transactions comprised in the respective mempool and/or transaction list of the generator and the enforcer is organized by a number associated with at least part of the transactions in an ascending order, a descending order, or any relevant ordering mechanism. In at least one embodiment, at least one portion of the transactions comprised in the respective at least one portion of the mempool and/or transaction list of the generator and the enforcer is organized in relation to at least one criterion selected from a group comprising a fee associated with a given transaction, a quantity of at least one transaction made by a computing node associated with a given transaction, a quantity of at least one asset associated with a given transaction, a quantity of at least one different type of transaction(s) involving a computing node associated with a given transaction and the like. In at least one embodiment, at least one portion of the transactions comprised in the respective at least one portion of the mempool and/or transaction list of the generator and the enforcer is unorganized, and an organization of the respective at least one portion of the mempool and/or transaction list of the generator and the enforcer may be processed afterwards. In at least one embodiment, the generator performs the comparison instead of the enforcer, after the generator obtained the at least one portion of the enforcer's mempool and/or transaction list and, optionally, at least one other witness node obtained the at least one portion of the enforcer's mempool and/or transaction list. In at least one embodiment, the comparison is performed by a witness node instead of the generator, after at least one other comparing node obtained the respective at least one portion of the mempool and/or transaction list of the generator and the enforcer. In at least one embodiment, at least one of the comparison, the obtaining of the at least one portion of the generator's mempool and/or transaction list, the obtaining of the at least one portion of the enforcer's mempool and/or transaction list and a transfer of at least one of the at least one portion of the generator's mempool and/or transaction list and the at least one portion of the enforcer's mempool and/or transaction list from a first other computing node to a second other computing node involves a signature, such as a signature from at least one of the enforcer and another computing node.

In at least one embodiment, the comparison between transactions could be processed on any portion of data suitable for identifying a concerned transaction, such as details of at least one part of the concerned transaction, an indication associated with at least one part of the concerned transaction, a date and/or time associated with at least one part of the concerned transaction, an amount of at least one type of resource(s) involved in at least one part of the concerned transaction, a number and/or nature of any party and/or all parties involved in at least one part of the concerned transaction and/or the like. In at least one embodiment, if a determined portion of data, such as a one-way cryptographic encryption, compared between two or more transactions is the same, the two or more transactions are considered to be the same. The skilled addressee will appreciate by the skilled addressee that a positive comparison may refer to a comparison between two or more identical transactions, and that a negative comparison may refer to a comparison between two or more different transactions. In at least one embodiment, the comparison between transactions further comprises an additional processing step of verifying at least one part of at least one portion of at least one concerned transaction, at least one of prior, in parallel to, during, and after said comparison.

According to processing step 108, the second node (hereinafter referred to as enforcer) provides to the first node (hereinafter referred to as generator) the indication of a result of the comparison of at least one portion of its mempool and/or transaction list and at least one portion of the generator's mempool and/or transaction list. In at least one embodiment, the generator includes said result in a new block. In at least one embodiment, the second node also provides to the first node a first new number associated with the second node and a previous or current block. In at least one corresponding embodiment, the first number is generated by the second node. In at least one embodiment, the generator is either allowed or prohibited to add the block to the blockchain by a smart contract, a system manager, a server, a computing node, a processing device and/or a software, in relation to the indication of the result of the comparison. In at least one embodiment, in the case where the result of the comparison is not deemed at least partially anomalous, such as a number of differences above a determined difference threshold, the block is added to the blockchain and the enforcer and/or the generator may either gain and/or lose reliability metric value in relation to the comparison and/or on another rule. In at least one embodiment, the block is determined by an allowed node part of the blockchain. In at least one embodiment, the block may not be determined by any given node and the generator may lose reliability metric value according to a rule, if the block is at least partially anomalous and/or negative. In at least one embodiment where the generator performs the comparison instead of the enforcer, the generator obtains the result of the comparison after performing said comparison. In at least one related embodiment, the enforcer signs at least one portion of the result of the comparison. In at least one embodiment where the comparison is performed by a witness node instead of the generator, the generator obtains the result from the witness node. In at least one related embodiment, the witness node signs at least one portion of the result of the comparison.

In at least one embodiment, the generator does processing steps 104-108 multiple times to obtain at least one indication of at least one result of a plurality of comparisons between at least one portion of an obtained transaction list and/or mempool and at least one corresponding portion of a plurality of mempools and/or transaction lists associated with a plurality of enforcers. In at least one embodiment, the enforcer compares at least one portion of the at least one portion of the obtained mempool and/or transaction list with at least one portion of at least one other enforcer's mempool and/or transaction list, and provides at least one indication of at least one result of at least one comparison with the at least one other enforcer to the generator and/or enforcer thereafter.

According to processing step 110, the generator adds a block to the blockchain, the block comprising the list of organized at least one transaction, the indication of the result of the comparison involving the second node, and at least one new number. In at least one embodiment, the block further comprises at least one indication of at least one result of at least one comparison between at least one respective portion of a plurality of mempools and/or transaction lists obtained by two or more enforcers. In at least one embodiment, the block comprises an indication of a determining of the enforcer involved in the generating of the block. In at least one embodiment, the block further comprises data indicating a role of at least one of the generator and the enforcer prior and/or when the generating said block was performed. In another embodiment, the block comprises an indication of a determining of at least one partner and/or at least one entity involved in at least one transaction involved in the comparing. In relation to the generating of the block, the generator adds the block to the blockchain. In at least one embodiment, the at least one new number of the generator and/or the enforcer(s) will become the at least one new number associated with the block. In at least one embodiment, the block is associated with a plurality of number. In at least one related embodiment, at least one mathematical operation is performed on at least one portion of the plurality of associated numbers to obtain a single number representing said at least one portion of the plurality of associated numbers. The skilled addressee will appreciate that, depending on the result of the comparison between the at least one portion of the obtained transaction list and/or mempool of the generator and the at least one portion of the mempool and/or transaction list of an enforcer, processing steps 104-110 may be repeated, involving at least one other entity, such as a node, part of the blockchain. In at least one related embodiment, the at least one other entity has additional authority compared to at least one other node part of the blockchain. In at least one embodiment, a smart contract, a system manager, a server, a computing node, a processing device and/or a software at least enables the adding of the block by including at least one portion of the generator's transaction list and/or mempool in the block and/or signs at least one portion of the generator's transaction list and/or mempool, with or without the determining of at least a portion of the enforcers.

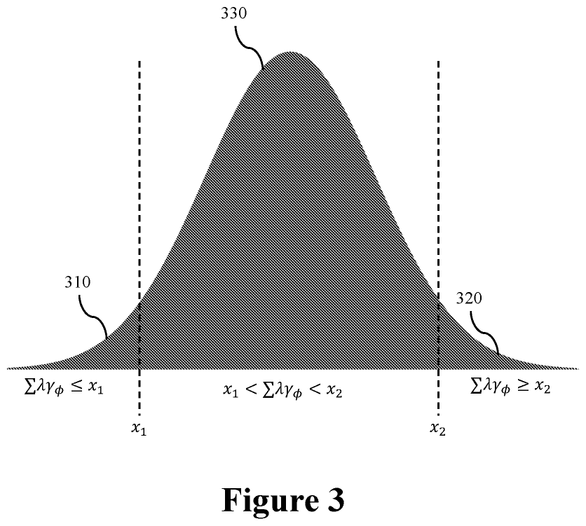

In at least one embodiment, in a case where at least one of the enforcer and the generator, or associated wallet thereof, is considered to be reliable and that the comparison is determined valid by the enforcer, the result of the comparison is not included in the to be generated block; instead, the enforcer signs at least one portion of the transaction list and/or mempool of the generator. In at least one embodiment, the reliability is determined by at least one other entity part of the blockchain. The skilled addressee will appreciate that the reliability can be provided in various forms, according to at least one embodiment, such as at least one embodiment of FIG. 3. In at least one related embodiment, the at least one other entity has additional authority compared to at least one other node part of the blockchain.

In at least one embodiment, a system manager is provided in the form of a smart contract, a server, a computing node, a processing device, a software and/or at least one machine readable instruction. The skilled addressee will appreciate that an authority the system manager has compared to at least one other node part of the blockchain may vary according to at least one embodiment. For instance, the system manager may have the authority to select one of an enforcer, a partner, a requester, a generator and/or any other relevant role according to at least one relevant blockchain-related action and/or to at least enable a modifying of at least one rule. In at least one embodiment, a node part of the blockchain is able to create a smart contract. The skilled addressee will appreciate that the smart contract may be more or less decentralized, according to the at least one embodiment. In at least one embodiment, the system manager is an oracle.

In at least one embodiment, a node part of the blockchain provides the system manager a vote concerning at least one blockchain-related aspect, mechanism, system and/or function, such as a maximum and/or minimum quantity of at least one asset allowed in a transaction, a fee associated with a given transaction type, a determining state for a type of transaction, which node should be assigned to a role for a blockchain-related action, such as an enforcer for a block generating mechanism and/or a partner for a transaction generating mechanism, a determining of a blacklisted status for a given potentially malicious node, and/or the like. In at least one embodiment, at least one portion of at least one computing node part of the distributed ledger enabled system provides the system manager with at least one corresponding vote for updating at least one machine readable instruction part of the distributed ledger enabled system. It will be understood that a given vote provided to the system manager may or may not influence a decision made by the system manager, according to the at least one embodiment. For instance, in at least one corresponding embodiment, if the given vote provided to the system manager does not correspond to a majority of votes provided to the system manager by a plurality of other nodes, the given vote may be discarded, and, in at least one embodiment, result in a given node associated with said given vote to be punished. In at least one corresponding embodiment, the punishing involves the given node to lose reliability metric value in a reliability metric system and/or involves the given node to become blacklisted. In at least one embodiment, the system manager is associated with a role such as a generator, an enforcer, a partner and/or any other relevant role. In at least one embodiment, a node having a defined reliability metric value may provide to at least one other node a poll, and depending on the poll result, a blockchain-related event may occur, such as the node gaining authority over at least one other node part of the blockchain. In at least one embodiment, the system manager is designated by at least one node part of the blockchain, such as a result of a poll. In at least one embodiment, the system manager cannot gain nor lose authority in the blockchain. In at least one embodiment, the system manager is hardcoded in the blockchain.

In at least one embodiment, a node can generate up to a determined quantity of each at least one transaction type per block and/or per range of blocks, incentivizing generation of meaningful transactions. In at least one corresponding embodiment, the block range is defined as a number of previous and/or current block(s). In at least one embodiment, a node can generate up to a quantity of at least one transaction per transaction type per block and/or block range as the quantity of at least one transaction type(s) included in a previous block and/or previous blocks range. In at least one embodiment, an identifier, such as a numerical identifier, is associated with a transaction upon and/or prior generation thereof. The skilled addressee will appreciate by the skilled addressee that said transaction may be determined and/or provided in various forms. In at least one embodiment, the transaction comprises at least one signature of at least one party involved therein and data relating to the transaction.

In at least one embodiment, after generating and/or upon generating of a new block, at least one reward (compensation) is allocated and/or distributed to an involved generator, an involved enforcer and/or any other relevant role. The skilled addressee will appreciate that the at least one reward may be allocated and/or distributed by various means and/or according to various embodiments. The skilled addressee will also appreciate that the at least one reward may be provided in various forms. In at least one embodiment, rewards are evenly distributed and/or allocated between the generator, the enforcer and/or any other relevant role having performed at least one blockchain-related action in the current block and/or in previous blocks and/or have been determined as worthy of receiving a reward. In at least one embodiment, rewards are unevenly distributed between the generator, the involved enforcer and/or any other relevant role, such as entirely to the generator, to the enforcer and/or any other relevant role or based on determined weights, for instance. In at least one embodiment, a smart contract, a system manager, a server, a computing node, a processing device and/or a software selects which node will receive and/or be allocated rewards. The skilled addressee will appreciate that the at least one reward distribution and/or allocation may be determined in various ways. In at least one embodiment, a reward may take the form of right to a role. In at least one embodiment, the rewards are selected from a group comprising tokens, coins, transaction fees, an additional authority compared to at least one other node part of the blockchain, reliability metric value augmentation and/or various forms of asset and/or rights and/or privileges of the like.

In at least one embodiment, only at least one enforcer involved in given a block generation receives a reward, the at least one enforcer being determined according to at least one criterion selected from a group comprising a corresponding reliability metric value associated with the at least one enforcer, a number involving the at least one enforcer, a quantity of at least one transaction made by the at least one enforcer, a total quantity of at least one asset included in a transaction related to the at least one enforcer, a quantity of at least one different type of transaction(s) made by the at least one enforcer and the like.

In at least one embodiment, at least one entity selected from a group comprising an enforcer, a partner, a requester, a generator, and/or any other relevant role taken from a previous and/or a current block part of the blockchain is determined to receive at least one reward in relation to at least one criterion such as a reliability metric value associated with the at least one determined entity, a number associated with the at least one determined entity, a quantity of at least one transaction associated with the at least one determined entity, a quantity of at least one transaction associated with the block, a quantity of at least one type of transaction(s) associated with the block, a total quantity of at least one asset included in a transaction involving the at least one determined entity, a quantity of at least one different type of transaction(s) associated with the block, a quantity of at least one different type of transaction(s) associated with the at least one determined entity and/or the like.

A method for selecting an enforcer will be described hereinbelow.

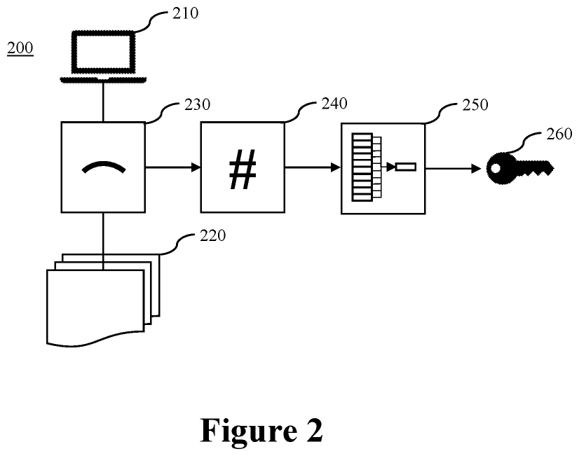

FIG. 2 is a schematic diagram illustrating an embodiment of a method involving a node generating a new blockchain-related number, in accordance with at least one embodiment. First, a number 210 associated with the node is combined with a number 220 associated with a previous and/or a current block part of a blockchain. In at least one embodiment, the number 210 is a result of operations performed on an associated series of characters, a GUID, a one-way cryptographic function's result, a public key and/or the like. The skilled addressee will appreciate by the skilled addressee that, in at least one embodiment, an early form of said number 210 underwent at least one processing step before becoming said number 210, where the at least one processing step and the early form of said number 210 may be taking various forms, according to the at least one embodiment. In at least one embodiment, the number 210 corresponds to a node's identification number. In at least one embodiment, the number 210 may correspond to a number associated with a previous and/or a current block. In another embodiment, the number 210 is obtained from a smart contract, a system manager, a server, a computing node, a processing device and/or a software. The skilled addressee will appreciate that the number 210 is preferably traceable, i.e., in at least one embodiment, that the number 210 is associated with at least one of a node part of the blockchain and a previous and/or a current block. In at least one embodiment where the number 210 is obtained from a smart contract, a system manager, a server, a computing node, a processing device and a software, traceability is established via at least one entity part of the blockchain obtaining a proof of an authenticity of the obtaining and, in at least one related embodiment, a proof of authority. In at least one embodiment where the number 210 is a random number, at least one of a proof of said randomness and/or a proof of authority must be provided to at least one other entity part of the blockchain.

In at least one embodiment, the number 210 and the number 220 thereafter undergo a concatenation 230 to form a series of characters. After being concatenated, the series of characters undergoes at least one hashing 240. The skilled addressee will appreciate that the hashing 240 may take various forms. In at least one embodiment, the hashing 240 is selected from a group of hash functions comprising cyclic redundancy checks, checksums, universal hash functions, non-cryptographic hash functions, keyed cryptographic hash functions, unkeyed cryptographic hash functions and the like.

In at least one embodiment, a result from the hashing is provided in a form of a numerical array which thereafter undergoes a numerical reduction 250. The skilled addressee will appreciate that the numerical reduction 250 may be executed in various forms. In at least one embodiment, the numerical reduction 250 is processed by averaging the numbers of the numerical array from the hashing 240. In at least one other embodiment, the numerical reduction 250 is processed by determining an arbitrary or calculated value from the numerical array. In at least one embodiment, the numerical reduction 250 is processed by obtaining a determined quantity of at least one number from the numerical array and by making a sum thereof. In at least one embodiment, a result from the numerical reduction 250 is the number 260 related to the node.

The skilled addressee will appreciate that the above-mentioned concatenation, hashing and numerical reduction are only examples, and at least one mathematical operation related to a combination of a number 210 with a number 220 associated with a previous and/or current block may be of various forms. It will thus be appreciated that the combination may be any form of reproducible mathematical operation(s) involving the number 210 of a given node and the number 220 associated with the previous and/or the current block. In at least one embodiment, instead of being processed through the mathematical operations of FIG. 2, the number 210 is summed with the number 220 associated with the previous and/or the current block to obtain a new number 260. In at least one other embodiment, instead of being processed through the mathematical operations of FIG. 2, the smallest number between the number 210 and the number 220 thereafter undergo a normalization process, bringing the smallest number's length, using techniques such as padding, to the length of the largest number. Then, an exclusive or (XOR) operation is performed on the normalized number and the largest number, forming the number 260. In at least one related embodiment, the number 260 undergoes at least one of a lossy compression technique and a number mapping technique.

In at least one embodiment, when establishing a first block of a blockchain, i.e. a genesis block, instead of combining the number 210 with the number 220, since no previous block is in the blockchain, the number 210 is combined with a random or pseudo-random and/or arbitrary number. In various embodiments, the number may be determined by a source selected from a group comprising a physical measurement, an empirical resampling, atmospheric noises, quantum fluctuations, a pseudo-random number generator, a simulation, a rejection sampling, a transform method and the like. In at least one embodiment, the first number is hardcoded. The skilled addressee will appreciate that, in at least one embodiment, a number resulting from a manipulation involving a number of a previous and/or a current block will be considered a pseudo-random number or a random number if the manipulation directly involves a random source.

In at least one embodiment, a smart contract, a system manager, a server, a computing node, a processing device and/or a software at least one of stores and generates a number 260 and/or enables a generating of a number 260 and provides it to a node upon request. In at least one embodiment, the number 260 is stored in a memory accessible by a smart contract, a system manager, a server, a computing node, a processing device and/or a software.

In at least one embodiment, a number, such as the number 260, has at least one of an upper limit and a lower limit. In at least one embodiment, a number of active nodes part of the blockchain impacts at least one of the upper limit and the lower limit. In at least one embodiment, at least one of the upper limit and lower limit is defined as a parameter part of the blockchain.

The skilled addressee will appreciate that the number 260 may be used in various operations, functions, mechanisms, systems and methods involved in an implementation, such as a blockchain, using the present technology, as it may be used for selecting nodes, obtaining new numbers, ordering transactions in at least one portion of mempools and/or transaction lists and/or the like.

FIG. 3 is a chart illustrating an embodiment of a distribution of at least one reliability metric, such as a reliability metric value, of at least one entity, such as a node, or associated wallet thereof, part of a blockchain, in accordance with at least one embodiment. The skilled addressee will appreciate that at least one of a reliability metric value and a reliability of a given node is influenced by at least one rule, preferably a plurality of rules. In at least one embodiment, a set of at least one rule ϕ is associated with a corresponding weight γ, which can be provided in a form of a number, and with a given corresponding indicator λ, which can be either positive or negative. Below is listed an example set of at least one rule ϕ associated to a corresponding weight γ and a corresponding indicator λ. The skilled addressee will thus appreciate that the present technology is not limited by the below-listed rules, weights and indicators, and that various other rules, weights and indicators may be provided, possibly influencing at least one of a reliability metric value and a reliability of at least one given node, or associated wallet thereof, part of the blockchain.

TABLE 1
Example set of at least one rule, corresponding weight(s) and corresponding indicator(s)

| | Rule number | Weight | Indicator |
|---|---|---|---|
| Rule overview | ϕ | γ | λ |
| Having generated a different number than a node's partner (as | 1 | 1 | + |
| a requester) | | | |
| Having spent a determined time (and/or quantity of at least | 2 | 2 | + |
| one generated block) in a blockchain since existence thereof. | | | |
| Having generated a number that is not frequent in a newly | 3 | 1 | + |
| generated block | | | |
| Generating a block | 4 | 3 | + |
| Acting as an enforcer | 5 | 3 | + |
| Having generated a different number than a node's requester | 6 | 1 | + |
| (as the partner) | | | |
| Having generated a same number as a node's partner (as a | 7 | 1 | − |
| requester) | | | |
| Having generated a same number as a node's requester (as a | 8 | 2 | − |
| partner) | | | |
| Frequently using a same partner | 9 | 3 | − |
| Being related to a number which is frequent in a block's | 10 | 2 | − |
| transactions | | | |
| Having similar wallets in blocks (as a generator) | 11 | 1 | − |
| Having an average reliability metric value in a block under a | 12 | 1 | − |
| determined value (as a generator) | | | |
| Including its own transaction in a block (as a generator) | 13 | 2 | − |
| Having a same enforcer within a determined number of | 14 | 3 | − |
| previous blocks (as a generator) | | | |
| Having a same generator within a determined number of | 15 | 3 | − |
| previous blocks | | | |
| Having an anomalous behavior as an enforcer, a generator, a | 16 | 3 | − |
| requester and/or a partner determined by machine learning | | | |
| and/or any other relevant identification algorithm | | | |

It will thus be understood that the above-mentioned set of at least one rule is presented by way of example, and that a rule can be added and/or removed from the set of at least one rule and/or updated in the set of at least one rule at any time, according to at least one criterion, such as at least one vote involving at least one voting computing node, such as a poll. Furthermore, the skilled addressee will appreciate that each of the above rules are a very simplified indication of what at least one corresponding machine readable instruction associated with a corresponding at least one rule at least one of verifies, executes and determines in relation to various conditions for at least one of a given node, wallet and entity part of the blockchain. In at least one embodiment, at least one machine learning algorithm, at least one deep learning algorithm and/or the like are used to at least one of analyze, determine and verify the behavior of at least one node, at least one wallet and/or at least one entity part of the blockchain and/or to provide at least one modification to the set of at least one rule, which may improve the quality, such as the security, of the system. In at least one embodiment, a system manager has the authority to add a rule and/or modify a rule and/or remove a rule, the system manager being automated and/or controlled by at least one operator. In at least one embodiment, a result of at least one machine readable instruction associated with at least one rule is part of the blockchain, for instance in the form of a transaction and/or an indication recorded in at least one part of the blockchain. In at least one embodiment, a node may vote on modifying, adding and removing at least one rule.

In at least one embodiment, at least one of at least one node, at least one wallet and at least one entity part of the blockchain needs to comply with at least one rule to at least initiate a blockchain-related action, such as transferring at least one asset.

Referring again to FIG. 3, an exemplary reliability metric value distribution of at least one of at least one node, at least one wallet and at least one entity is presented in a form of a normal distribution. The skilled addressee will appreciate that, depending on a behavior of the at least one of at least one node, at least one wallet and at least one entity and on at least one rule, the distribution may be provided in various forms. The skilled addressee will also appreciate that, in at least one embodiment, a reliability metric value associated with at least one of at least one node, at least one wallet and at least one entity is calculated using a determined formula: Σλγ_{ϕ}, which translates to a sum of a weight and an indicator associated to at least one given rule. In at least one embodiment, the at least one given rule concerns a specific role. In at least one embodiment, the at least one given rule concerns at least one specific blockchain-related action, such as generating a transaction, interacting repetitively with a given node, and/or the like. The skilled addressee will appreciate that a reliability metric value associated with at least one of a at least one node, at least one wallet and at least one entity may also be affected by other factors, such as by at least one non-deterministic rule, such as a machine learning algorithm, and/or an evaluation by a smart contract, a system manager, a server, a computing node, a processing device and/or a software part of the blockchain. The skilled addressee will appreciate that a given factor affecting said reliability metric value may vary in accordance with the embodiment, and that various other factors may impact said reliability metric value. It will this be appreciated by the skilled addressee that at least one of at least one node, at least one wallet and at least one entity part of the blockchain is often considered reliable in relation to its reliability metric value. The skilled addressee will appreciate that the reliability can be provided in various forms, according to at least one embodiment, such as at least one embodiment of FIG. 3. In at least one embodiment, a plurality of reliability metric values associated with a corresponding at least one rule determines the reliability of at least one of at least one node, at least one wallet and at least one entity part of the blockchain. In at least one embodiment, a system manager as an authority to determines the reliability of at least one of at least one node, at least one wallet and at least one entity part of the blockchain, regardless of at least one reliability metric value associated thereof. In at least one embodiment, the reliability is determined by at least one other entity part of the blockchain. In at least one embodiment, a combination of a plurality of reliability metric values associated with a given entity, such as a node, or associated wallet thereof, determines at least one enabling of at least one right, authority, allowed action and/or privilege in the blockchain. In at least one embodiment, once a given reliability metric value reached a maximum reliability metric value, a second reliability metric is adjusted and/or, in at least one embodiment, said given reliability metric value is adjusted. For instance, the given reliability metric value may be set to a lower value than it was, and the second reliability metric value may be set to a higher value than it was. In at least one embodiment, the second reliability metric value determines at least one right, authority and/or privilege of a given node, or associated wallet thereof, and/or determines an allowing of at least one action for a given node, or associated wallet thereof, part of the blockchain.

In at least one embodiment, two threshold values, i.e., x₁ and x₂, where x₁ is less than x₂, define three regions 310, 320, 330 within the reliability metric value distribution. The skilled addressee will appreciate that the values of x₁ and x₂ may be provided in various forms. In at least one embodiment, a single threshold value, such a x₁, is provided. In at least one embodiment, a plurality of regions are defined in accordance to at least one corresponding threshold value. In at least one embodiment, a given threshold defines at least one role associated with at least one of at least one node, at least one wallet and at least one entity part of the blockchain.

In at least one embodiment, at least one of a node, a wallet and an entity part of the blockchain has a reliability metric value which is equal to or lower than x₁, which defined the upper limit of the blacklist region 310. The at least one of a node, a wallet and an entity that has a reliability metric value in the blacklist region 310 typically presents a suspicious behavior and is prohibited from performing at least one blockchain-related action, such as generating a block, acting as an enforcer, acting as a requester, acting as a partner, acting as any other relevant role and/or the like. In at least one embodiment, at least one of a node, a wallet and an entity having a reliability metric value comprised in the blacklist region 310 may be subject to at least one slash, which involves a corresponding penalization. A slash can take various forms and may change form according to at least one criterion, at least one blockchain-related event, at least one blockchain-related feature and/or the like, according to at least one embodiment. In at least one embodiment, the penalizing could take a form of prohibiting and/or limiting said at least one of a node, a wallet and an entity from using a loan-related system if one is available, have a loan-related interest fee increased by determined amount and/or any other relevant consequence. In at least one embodiment, at least one of a blacklisted node, a blacklisted wallet and a blacklisted entity is unable to interact with and/or withdraw all or a portion of at least one asset associated thereof for a specific amount of time and/or number of at least one block to be generated. In another embodiment, at least one of a blacklisted node, a blacklisted wallet and a blacklisted entity is strictly prohibited from doing any blockchain-related action until its reliability metric value is back over x₁. The skilled addressee thus appreciate that a slash may greatly vary depending on an implementation and at least one embodiment of the present technology. In at least one embodiment, other factors may affect a given slash, such as a quantity of at least one previous slash received by at least one of a node, a wallet and an entity, the reliability metric value associated with at least one of a node, a wallet and an entity, the quantity of at least one occasion at least one of a node, a wallet and an entity was considered blacklisted, a voting involving at least one entity part of the blockchain and/or the like. In at least one embodiment, the slash may affect the value of at least one of x₁, x₂, x₃ and any other threshold part of the distribution.

In at least one embodiment, at least one of a node, a wallet and an entity part of the blockchain having a reliability metric value which is equal or greater than x₂ is determined to have an outstanding behavior and thus to be reliable. The at least one of a node, a wallet and an entity having a reliability metric value comprised in the region equal or greater than x₂ is thereby considered to be comprised in an enforcer region 320. In at least one embodiment, the enforcer region further comprises a threshold x₃ (not depicted in FIG. 3), which determines an enforcer role (over or equal to x₃) and a generator role (below x₃). In at least one embodiment, the enforcer role is determined for any reliability metric value above x₃ and the generator role is determined for any reliability metric value under x₃. As mentioned hereinabove, a node acting as an enforcer is comparing at least one portion of its mempool and/or transaction list with at least one portion of a transaction list and/or mempool related to a generator. Because, in at least one embodiment, a node or a wallet associated with said node thereof comprised in the enforcer region 320 is determined as reliable, a comparison between at least one portion of its mempool and/or transaction list and at least one portion of a transaction list and/or mempool associated with a generator usually determines a legitimacy of said generator. The skilled addressee will appreciate that if an enforcer and/or a generator behaves in an anomalous way, it may be penalized in relation to at least one rule, such as having its at least one associated reliability metric value reduced. The skilled addressee will also appreciate that more variables xₙ may be defined in the distribution to set boundaries between at least one role, at least one right of access, at least one privilege and/or at least one authority in the blockchain.

In at least one embodiment, the value of x₁, x₂ and/or x₃ is influenced according to at least one criterion selected from a group comprising a quantity of at least one asset included in at least one transaction of a previous and/or a current block, a quantity of at least one transaction made by at least one enforcer, at least one partner, at least one generator, and/or at least one of any other relevant role, a reliability metric value distribution involving at least one of at least one node, at least one wallet and at least one entity part of the blockchain, a quantity of at least one transaction recorded in at least one previous and/or a current block and the like. In at least one embodiment, at least one of a node, a wallet and an entity comprised in the enforcer region refers to a smart contract, a system manager, a server, a computing node, a processing device and/or a software to act as an enforcer, a generator and/or any other relevant role.

In at least one embodiment, at least one of a node, a wallet and an entity part of the blockchain having a reliability metric value greater than x₁ and lower than x₂ is considered to have a reliability metric value comprised in the standard region 330. The at least one of a node, a wallet and an entity associated with the standard region 330 is typically determined as having a reliable behavior, i.e., that is not outstanding nor suspicious. In at least one embodiment, the at least one of a node, a wallet and an entity associated with the standard region 330 is allowed to act as a requester, a partner and/or any other relevant role, but is prohibited from acting as an enforcer, a generator and/or any other relevant role. In at least one embodiment, at least one of a node, a wallet and an entity associated with the standard region refers to a smart contract, a system manager, a server, a computing node, a processing device and/or a software to act as a partner and/or any other relevant role.

In at least one embodiment, x₁ is omitted. For instance, a distribution where only x₂ is used to determine a limit between the enforcer region 320 and the standard region 330 may be provided. However, at least one embodiment in which x₁ is omitted is typically riskier than an embodiment in which x₁ is included, as a node, or associated wallet thereof, being associated with a suspicious behavior would, in at least one embodiment, still be able to act as a partner, a requester and/or any other relevant role even if a reliability metric value associated with said node may be considered low. In at least one embodiment, neither x₁ nor x₂ are present, and a probabilistic system in which chances of a given node, wallet and/or entity part of the blockchain of suffering slashes and/or penalizing decreases with an increase of at least one associated reliability metric value thereof and chances of said node, or a node associated with said wallet thereof, of being associated with a given role such as a generator, an enforcer, a partner and/or any other relevant role correlates with an increase of the at least one associated reliability metric value thereof. The skilled addressee will thus appreciate that a given association of at least one given role may vary and is not limited to the distribution of FIG. 3.

In at least one embodiment, a node can only be associated with a role such as an enforcer, a partner, a requester and/or any other relevant role based on a relation (superior, inferior, equal, similar or different) between its at least one reliability metric value and at least one reliability metric value associated with at least one corresponding generator (hereinafter referred to as enforcer) and/or requester (hereinafter referred to as partner) and/or any other relevant role.

In at least one embodiment, at least one rule of the set of at least one rule presented in table 1 may not affect the reliability metric value associated with at least one computing node, but enables an access to and/or a right to one or more elements of at least one of a participation in at least one part of the blockchain, a computing node, a system manager, a blockchain-related event, a feature, a role, a blockchain-related action and the like.

In at least one embodiment, for at least one of at least one computing node, at least one wallet and at least one entity part of the blockchain, at least one subset of the set of at least one rule is organized in a determined way. In at least one embodiment, the determined way may be altered by at least one blockchain-related event part of the blockchain, at least one criterion and/or at least one blockchain-related action, which may or may not be associated with the at least one computing node, according to at least one embodiment. The skilled addressee will appreciate that an organizing of the at least one subset of the set of at least one rule may improve execution performance in at least one embodiment, according to a nature of said at least one subset of said set of at least one rule, and/or change an execution result if, for instance, a given rule depends on another one being processed prior said given rule.

In at least one embodiment, at least one computing node, according to at least one criterion such as joining the blockchain and/or synchronizing at least one part of the blockchain, said synchronizing involving at least one other entity part of said blockchain, must provide at least one of an identifier, a type, a nature and a scope associated with at least one of the at least one computing node and a blockchain-related action thereof, such as a node type, said node type indicating, in at least one embodiment, if said at least one computing node is storing a large portion of the blockchain's data, i.e. at least one full node, or storing a smaller portion of the blockchain's data, i.e. at least one lightweight node. In at least one related embodiment, at least one blockchain-related action associated with at least one role is dependent on said node type, such as a given node associated with a lightweight role generating a block wherein said lightweight role is relying on a storer role to provide blockchain-related data therefore enabling a given node associated with said lightweight role to save memory usage at a cost of, in at least one embodiment, less and/or no reward(s) and/or compensation(s) earned when generating a given block. In at least one embodiment, an indication of the at least one of an identifier, a type, a nature and a scope is comprised in at least one block part of the blockchain. In at least one embodiment, the at least one of an identifier, a type, a nature and a scope involves at least one of at least one signature and/or at least one co-signature of the at least one computing node and a processing thereof.

The skilled addressee will appreciate that other roles than the ones presented above may be included in the present technology, such as the ones presented below. The skilled addressee will further appreciate that the below roles are presented by way of example, and that various other roles may be included in the present technology, according to at least one embodiment.

### Storer Role

In at least one embodiment, the present technology further comprises a storer role. The skilled addressee will appreciate that a storer role is a role which, when associated to at least one computing node, involves said at least one computing node storing data of at least one part of a blockchain.

In at least one first embodiment, a computing node seeking to be a storer node would interact, based on an enabling of an admission process, with at least one first storer node part of the blockchain using a number associated with said seeking node as a criterion, such as only being able to interact with the at least one first storer node after obtaining at least one subset of a reliability metric value distribution using said number, said subset being associated with at least one reliability metric value associated with the at least one first storer node. In at least one embodiment, the enabling of the admission process is also associated with at least one criterion, at least one blockchain-related event and/or a blockchain-related action, such as a number of generated blocks, an establishing of a reliability of the seeking node, at least one vote involving at least one voting computing node, such as a poll, and/or the like. In at least one embodiment, said admission process involves the seeking node providing to at least one first other computing node part of the blockchain an indication of a first desire to be admitted, the seeking node obtaining from at least one of the at least one first other computing node an indication of an acknowledgement of said first desire and the seeking node selecting, after a processing involving at least one of the at least one of the at least one first other computing node, said processing comprising an evaluation thereof in at least one embodiment, at least one of the at least one of the at least one of the at least one first other computing node to provide it blockchain-related data according to at least one criterion, such as a blockchain height associated with the at least one of the at least one of the at least one of the at least one first other computing node. In at least one embodiment, the interacting comprises the seeking node obtaining a second number associated with the at least one first storer node. In at least one embodiment, the interacting comprises at least one of the seeking node and at least one witness node, such as a system manager and/or another computing node, storing on a storage medium any interaction between said seeking node and said at least one first storer node and/or between a plurality of involved storer nodes. In at least one alternative embodiment, the at least one first storer node selects said seeking node using a similar process as described in the at least one first embodiment. In at least one embodiment, the interacting comprises the seeking node obtaining at least one signature and/or at least one co-signature associated with the at least one first storer node and/or the at least one witness node, such as for validating an authenticity of a given interaction. In at least one embodiment, the at least one first storer node obtains at least one input, such as an input comprising at least one signature and/or at least one co-signature, of at least one other storer node to select said seeking node using, in at least one embodiment, a similar process as described in the at least one first embodiment upon the obtaining of the at least one input. In at least one related embodiment, the at least one storer node also obtains the number associated with the seeking node.

The at least one first storer node and the seeking node now determined, an admission process involving at least one portion of the at least one first storer node and the seeking node continues. In at least one embodiment, the admission process involves the at least one first storer sending blockchain-related data to the seeking node, thereby enabling the seeking node to act as a storer node. In at least one embodiment, the blockchain-related data comprises at least one of at least one signature and at least one co-signature. In at least one embodiment, at least one of the interacting and the admission process involves at least one third node, the at least one third node acting as an intermediate between the seeking node and at least one of the at least one first storer node. In at least one embodiment where the at least one first storer obtains the input from the at least one other storer, an additional node acts as an intermediate between said at least one first storer and the at least one other storer.

In at least one embodiment, the seeking node selects a storer node from the at least one first storer node using a similar process as described in the at least one first embodiment. In at least one embodiment, the admission process involves at least one of the at least one first storer node to evaluate the seeking computing node according to at least one criterion, such as at least one associated reliability metric value thereof, a reliability of said seeking node and/or the like. Based on the evaluation, the seeking computing node obtains at least a portion of the rights associated with the storer node role. In at least one embodiment, the seeking node evaluates at least one of the at least one first storer node prior the interaction and/or the admission thereof.

In at least one embodiment, the evaluation of at least one of the seeking node and the at least one of the at least one first storer node involves an evaluating of at least one portion of blockchain-related digital interaction part of said blockchain involving said at least one of the seeking node and the at least one of the at least one first storer node, such as a blockchain-related event emitted by a deterministic or non-deterministic algorithm, such as a machine learning algorithm, a rule, a blockchain-related event emitted from a smart contract, a system manager, a server, a computing node, a processing device and/or a software, and/or the like.

In at least one embodiment, at least one of the at least one first storer node is in communication with and may delegate tasks to at least one of a smart contract, a system manager, a server, a computing node, a processing device and a software, such as a task involving a storage of at least one portion of the data part of the blockchain. In at least one embodiment, the computing node is another storer node. In at least one embodiment, the delegating comprises a selection process, the selection process being similar to the process described in the at least one first embodiment. In at least one corresponding embodiment, at least one node interaction comprised in the delegating comprises least one signature and/or at least one co-signature of at least one of the other storer node, the at least one of the at least one first storer node, and/or an additional computing node acting as an intermediary in any of said at least one node interaction.

In at least one embodiment, a plurality storer nodes part of the at least one first storer node, according to at least one of a given blockchain-related event and a given criterion, such as a number of generated blocks, a parameter part of the blockchain and/or the like, reach consensus aiming at uniformizing of at least one portion of data part of the blockchain between said plurality. In at least one embodiment, the consensus comprises at least one signature and/or at least one co-signature of at least one of the at least one first storer and/or another entity part of the blockchain. In at least one corresponding embodiment, the at least one signature and/or the at least one co-signature involves the at least one portion of data part of the blockchain. In at least one embodiment, the at least one signature and/or the at least one co-signature involves at least one interaction between a plurality of storer nodes part of the consensus and/or at least one other relevant node, such as at least one other intermediary node involved in at least one interaction in the consensus. In at least one embodiment, the at least one other entity is a system manager. In at least one embodiment, the consensus involves at least one witness entity part of the blockchain, such as a system manager, a server, a computing node, a processing device and a software. In at least one embodiment, the consensus comprises a comparison of blockchain-related data stored between a plurality of storers of the at least one storer node. In at least one embodiment, an indication of at least one of an initiating of said consensus, a completion of said consensus and an executing of said consensus is provided to at least one node part of the blockchain.

In at least one embodiment, at least one storer node involved in the admitting of a new storer node receives at least one reward in relation to said admitting.

In at least one embodiment, a blockchain-related event identifier is related with an admitting of a new storer node and a validating of a conformity of at least one portion of a version of the blockchain.

In at least one embodiment, a given malicious node attempting to maliciously be considered associated with a storer role while being prohibited to according to at least one criterion is subject to at least one of a penalizing and a poll, such as a poll enabled, such as started, by at least one participating computing node which identified the malicious behavior of the given malicious node, wherein at least one other authorized computing node provides a vote on said malicious behavior and based on the at least one provided vote reward and/or punish the at least one participating node and/or at least one portion of the at least one other authorized computing node based on a result associated with a given vote associated with a given node of the at least one other authorized computing node.

### Speedster Role

In at least one embodiment, the present technology further comprises a speedster role. The skilled addressee will appreciate that a speedster role is a role which, when associated to at least one computing node, involves said at least one computing node altering a minimum transaction threshold and/or a maximum transaction threshold of a blockchain-related structured data unit, such as a block. In at least one embodiment, said altering relies on a rate of at least one type of at least one blockchain-related activity of at least one given type provided by at least one node and/or entity, such as at least one other node, said at least one computing node and/or a system manager, part of the blockchain.

In at least one first embodiment, a computing node seeking to be a speedster node would interact, based on an enabling of an admission process, with at least one first speedster node part of the blockchain using a number associated with said seeking node as a criterion, such as only being able to interact with the at least one first speedster node after obtaining at least one subset of a reliability metric value distribution using said number, said subset being associated with at least one reliability metric value associated with the at least one first speedster node. In at least one embodiment, the enabling of the admission process is also associated with at least one criterion, at least one blockchain-related event and/or a blockchain-related action, such as a number of generated blocks, an establishing of a reliability of the seeking node, at least one vote involving at least one voting computing node, such as a poll, and/or the like. In at least one embodiment, said admission process involves the seeking node providing to at least one first other computing node part of the blockchain an indication of a first desire to be admitted, the seeking node obtaining from at least one of the at least one first other computing node an indication of an acknowledgement of said first desire and the seeking node selecting, after a processing involving at least one of the at least one of the at least one first other computing node, said processing comprising an evaluation thereof in at least one embodiment, at least one of the at least one of the at least one of the at least one first other computing node to provide it blockchain-related data according to at least one criterion, such as a blockchain height, at least one indication of at least one pending and/or generated transaction of at least one type, at least one indication of at least one rate of at least one pending and/or generated transaction of at least one type and/or the like, associated with the at least one of the at least one of the at least one of the at least one first other computing node. In at least one embodiment, the interacting comprises the seeking node obtaining a second number associated with the at least one first speedster node. In at least one embodiment, the interacting comprises at least one of the seeking node and at least one witness node, such as a system manager and/or another computing node, storing on a storage medium any interaction between said seeking node and said at least one first speedster node and/or between a plurality of involved speedster nodes. In at least one alternative embodiment, the at least one first speedster node selects said seeking node using a similar process as described in the at least one first embodiment. In at least one embodiment, the interacting comprises the seeking node obtaining at least one signature and/or at least one co-signature associated with the at least one first speedster node and/or the at least one witness node, such as for validating an authenticity of a given interaction. In at least one embodiment, the at least one first speedster node obtains at least one input, such as an input comprising at least one signature and/or at least one co-signature, of at least one other speedster node to select said seeking node using, in at least one embodiment, a similar process as described in the at least one first embodiment upon the obtaining of the at least one input. In at least one related embodiment, the at least one speedster node also obtains the number associated with the seeking node.

The at least one first speedster node and the seeking node now determined, an admission process involving at least one portion of the at least one first speedster node and the seeking node continues. In at least one embodiment, the admission process involves the at least one first speedster sending blockchain-related data to the seeking node, thereby enabling the seeking node to act as a speedster node. In at least one embodiment, the blockchain-related data comprises at least one of at least one signature and at least one co-signature. In at least one embodiment, at least one of the interacting and the admission process involves at least one third node, the at least one third node acting as an intermediate between the seeking node and at least one of the at least one first speedster node. In at least one embodiment where the at least one first speedster obtains the at least one input from the at least one other speedster, an additional node acts as an intermediate between said at least one first speedster and the at least one other speedster.

In at least one embodiment, the seeking node selects a speedster node from the at least one first speedster node using a similar process as described in the at least one first embodiment. In at least one embodiment, the admission process involves at least one of the at least one first speedster node to evaluate the seeking computing node according to at least one criterion, such as at least one associated reliability metric value thereof, a reliability of said seeking node and/or the like. Based on the evaluation, the seeking computing node obtains at least a portion of the rights associated with the speedster node role. In at least one embodiment, the seeking node evaluates at least one of the at least one first speedster node prior the interaction and/or the admission thereof.

In at least one embodiment, the evaluation of at least one of the seeking node and the at least one of the at least one first speedster node involves an evaluating of at least one portion of blockchain-related digital interaction part of said blockchain involving said at least one of the seeking node and the at least one of the at least one first speedster node, such as a blockchain-related event emitted by a deterministic or non-deterministic algorithm, such as a machine learning algorithm, a rule, a blockchain-related event emitted from a smart contract, a system manager, a server, a computing node, a processing device and/or a software, and/or the like.

In at least one embodiment, at least one of the at least one first speedster node is in communication with and may delegate tasks to at least one of a smart contract, a system manager, a server, a computing node, a processing device and a software, such as a task involving a processing of at least one indication of at least one pending and/or generated transaction of at least one type, at least one indication of at least one rate of at least one pending and/or generated transaction of at least one type, at least initiating, such as by providing, at least one vote representing of said at least one of the at least one first speedster node and/or the like. In at least one embodiment, the computing node is another speedster node. In at least one embodiment, the delegating comprises a selection process, the selection process being similar to the process described in the at least one first embodiment. In at least one corresponding embodiment, at least one node interaction comprised in the delegating comprises least one signature and/or at least one co-signature of at least one of the other speedster node, the at least one of the at least one first speedster node, and/or an additional computing node acting as an intermediary in any of said at least one node interaction.

In at least one embodiment, a plurality speedster nodes part of the at least one first speedster node, according to at least one of a given blockchain-related event and a given criterion, such as a number of generated blocks, a determined number of provided vote(s) by at least one speedster node, at least one change of at least one rate of blockchain-related activity(ies), a parameter part of the blockchain and/or the like, reach consensus aiming at uniformizing and/or determining, between said plurality, at least one portion of at least one processing step, which may involve at least one parameter's value, of a voting process and/or a change determining process and/or the like. In at least one embodiment, the consensus comprises at least one signature and/or at least one co-signature of at least one of the at least one first speedster and/or another entity part of the blockchain. In at least one embodiment, the at least one signature and/or the at least one co-signature involves at least one interaction between a plurality of speedster nodes part of the consensus and/or at least one other relevant node, such as at least one other intermediary node involved in at least one interaction in the consensus. In at least one embodiment, the at least one other entity is a system manager. In at least one embodiment, the consensus involves at least one witness entity part of the blockchain, such as a system manager, a server, a computing node, a processing device and a software. In at least one embodiment, the consensus comprises a comparison of blockchain-related data stored, calculated and/or shared between a plurality of speedsters of the at least one speedster node. In at least one embodiment, an indication of at least one of an initiating of said consensus, a completion of said consensus and an executing of said consensus is provided to at least one node part of the blockchain.

In at least one embodiment, at least one speedster node involved in an admitting process of a new speedster node receives at least one reward in relation to said admitting process.

In at least one embodiment, a blockchain-related event identifier is related with an admitting process of a new speedster node and a validating of a conformity of at least one portion of blockchain-related data and/or a processing of said blockchain-related data thereof.

In at least one embodiment, at least one given speedster node, according to at least one criterion, such as a determining of at least one change of at least one rate of blockchain-related activity(ies) associated thereof and/or associated with at least one other node part of the blockchain, a reliability metric value associated thereof, a period of time elapsing and/or a number of at least one block being generated, a given poll aiming at altering at least one of the minimum transaction threshold and the maximum transaction threshold is determined. The skilled addressee will appreciate that a poll is typically recorded in a blockchain. In at least one embodiment, if a plurality of polls is determined by a plurality of speedster nodes, one poll amongst said plurality of polls is determined according to at least one criterion, such as a determining of a time associated with a creation of said one poll, a reliability metric associated with at least one node involved in a creation of said one poll and/or the like. In at least one embodiment, at least one given speedster node can only determine up to a number of at least one poll in according to at least one criterion, such as an associated reliability metric value, a given time period and/or the like.

In at least one embodiment, a given node, according to at least one first criterion, such as at least one event, such as a creation-related event, emitted in relation to a given poll, provides a given vote, said vote being related to a given poll. In at least one embodiment, the at least one first criterion is redetermined based on at least one event emitted by said given poll, such as a number of at least one vote provided by at least one node, an average of at least one reliability metric value associated with at least one node involved therewith, and/or the like.

In at least one embodiment, according to at least one criterion, such as when a determined number of at least one node provided at least one vote to said given poll, a period of time elapsing, a number of at least one block being generated, when at least one entity with a given authority provides an indication related thereof and/or when at least one node involved in a determining of said given poll provides an indication related thereof, a completion of said poll is established. The skilled addressee will appreciate that a vote associated with a poll is typically recorded in a blockchain. In at least one embodiment, said completion involves, according to at least one criterion, such as at least one value of at least one vote associated with at least one voting node, at least one reliability metric value associated with at least one voting node, a number of at least one voting node associated with said poll and/or a number of at least one voting node associated with at least one voting value associated with said poll, at least one of penalizing and/or at least one compensating of at least one node associated with, such as by participating, said poll is determined. In at least one embodiment, the establishing of the completion involves at least one emitting, which typically involve at least one recording, of at least one event associated thereof.

In at least one embodiment, instead of directly altering the at least one of the minimum transaction threshold and the maximum transaction threshold, at least one value associated thereof is altered. The skilled addressee will appreciate that a combining of a given value with at least one of the minimum transaction threshold and the maximum transaction threshold determines at least one of the minimum transaction threshold and the maximum transaction threshold thereof. For instance, a given value combined with the minimum transaction threshold, such as by at least performing an addition operation, could determine the maximum transaction threshold, wherein said determining may, in at least one embodiment, also involve an altering thereof. In at least one embodiment, at least one portion of at least one node part of the blockchain may be associated with at least one different minimum and/or maximum threshold than at least one other portion of at least one node part of the blockchain.

In at least one embodiment, a given malicious node attempting to maliciously be considered associated with a speedster role while being prohibited to according to at least one criterion is subject to at least one of a penalizing and a poll, such as a poll enabled, such as started, by at least one participating computing node which identified the malicious behavior of the given malicious node, wherein at least one other authorized computing node provides a vote on said malicious behavior and based on the at least one provided vote reward and/or punish the at least one participating node and/or at least one portion of the at least one other authorized computing node based on a result associated with a given vote associated with a given node of the at least one other authorized computing node.

### Sentinel Role

In at least one embodiment, the present technology further comprises a sentinel role. The skilled addressee will appreciate that a sentinel role is a role which, when associated to at least one computing node, involves said at least one computing node to perform at least one task, said at least one task consisting of monitoring, modifying, adding and/or terminating at least one machine readable instruction, such as artificial intelligence (AI) related algorithm, a machine learning (ML) algorithm and/or the like, part of the blockchain, and/or determining at least one type of anomalous behavior of at least one node and/or algorithm part of the blockchain. In at least one embodiment, said at least one task relies on a rate of at least one type of at least one blockchain-related activity of at least one given type provided by at least one node and/or entity, such as at least one other node, said at least one computing node and/or a system manager, part of the blockchain.

In at least one first embodiment, a computing node seeking to be a sentinel node would interact, based on an enabling of an admission process, with at least one first sentinel node part of the blockchain using a number associated with said seeking node as a criterion, such as only being able to interact with the at least one first sentinel node after obtaining at least one subset of a reliability metric value distribution using said number, said subset being associated with at least one reliability metric value associated with the at least one first sentinel node. In at least one embodiment, the enabling of the admission process is also associated with at least one criterion, at least one blockchain-related event and/or a blockchain-related action, such as a number of generated blocks, an establishing of a reliability of the seeking node, at least one vote involving at least one voting computing node, such as a poll, and/or the like. In at least one embodiment, said admission process involves the seeking node providing to at least one first other computing node part of the blockchain an indication of a first desire to be admitted, the seeking node obtaining from at least one of the at least one first other computing node an indication of an acknowledgement of said first desire and the seeking node selecting, after a processing involving at least one of the at least one of the at least one first other computing node, said processing comprising an evaluation thereof in at least one embodiment, at least one of the at least one of the at least one of the at least one first other computing node to provide it blockchain-related data according to at least one criterion, such as a blockchain height, at least one indication of at least one pending and/or generated transaction of at least one type, at least one indication of at least one rate of at least one pending and/or generated transaction of at least one type, at least one indication of a behavior, which may be considered anomalous, of at least one entity, such as at least one node and/or algorithm, which may be non-deterministic, such as at least one decision of at least one non-deterministic algorithm, associated with the at least one of the at least one of the at least one of the at least one first other computing node and/or the blockchain. In at least one embodiment, the interacting comprises the seeking node obtaining a second number associated with the at least one first sentinel node. In at least one embodiment, the interacting comprises at least one of the seeking node and at least one witness node, such as a system manager and/or another computing node, storing on a storage medium any interaction between said seeking node and said at least one first sentinel node and/or between a plurality of involved sentinel nodes. In at least one alternative embodiment, the at least one first sentinel node selects said seeking node using a similar process as described in the at least one first embodiment. In at least one embodiment, the interacting comprises the seeking node obtaining at least one signature and/or at least one co-signature associated with the at least one first sentinel node and/or the at least one witness node, such as for validating an authenticity of a given interaction. In at least one embodiment, the at least one first sentinel node obtains at least one input, such as an input comprising at least one signature and/or at least one co-signature, of at least one other sentinel node to select said seeking node using, in at least one embodiment, a similar process as described in the at least one first embodiment upon the obtaining of the at least one input. In at least one related embodiment, the at least one sentinel node also obtains the number associated with the seeking node.

The at least one first sentinel node and the seeking node now determined, an admission process involving at least one portion of the at least one first sentinel node and the seeking node continues. In at least one embodiment, the admission process involves the at least one first sentinel sending blockchain-related data to the seeking node, thereby enabling the seeking node to act as a sentinel node. In at least one embodiment, the blockchain-related data comprises at least one of at least one signature and at least one co-signature. In at least one embodiment, at least one of the interacting and the admission process involves at least one third node, the at least one third node acting as an intermediate between the seeking node and at least one of the at least one first sentinel node. In at least one embodiment where the at least one first sentinel obtains the at least one input from the at least one other sentinel, an additional node acts as an intermediate between said at least one first sentinel and the at least one other sentinel.

In at least one embodiment, the seeking node selects a sentinel node from the at least one first sentinel node using a similar process as described in the at least one first embodiment. In at least one embodiment, the admission process involves at least one of the at least one first sentinel node to evaluate the seeking computing node according to at least one criterion, such as at least one associated reliability metric value thereof, a reliability of said seeking node and/or the like. Based on the evaluation, the seeking computing node obtains at least a portion of the rights associated with the sentinel node role. In at least one embodiment, the seeking node evaluates at least one of the at least one first sentinel node prior the interaction and/or the admission thereof.

In at least one embodiment, the evaluation of at least one of the seeking node and the at least one of the at least one first sentinel node involves an evaluating of at least one portion of blockchain-related digital interaction part of said blockchain involving said at least one of the seeking node and the at least one of the at least one first sentinel node, such as a blockchain-related event emitted by a deterministic or non-deterministic algorithm, such as a machine learning algorithm, a rule, a blockchain-related event emitted from a smart contract, a system manager, a server, a computing node, a processing device and/or a software, and/or the like.

In at least one embodiment, at least one of the at least one first sentinel node is in communication with and may delegate tasks to at least one of a smart contract, a system manager, a server, a computing node, a processing device and a software, such as a task involving a processing of at least one indication of at least one pending and/or generated transaction of at least one type, at least one indication of at least one rate of at least one pending and/or generated transaction of at least one type, at least one indication of a behavior, which may be considered anomalous, of at least one entity, such as at least one node and/or algorithm, which may be non-deterministic, such as at least one decision of at least one non-deterministic algorithm, at least initiating, such as by providing, at least one vote representing of said at least one of the at least one first sentinel node and/or the like. In at least one embodiment, the computing node is another sentinel node. In at least one embodiment, the delegating comprises a selection process, the selection process being similar to the process described in the at least one first embodiment. In at least one corresponding embodiment, at least one node interaction comprised in the delegating comprises least one signature and/or at least one co-signature of at least one of the other sentinel node, the at least one of the at least one first sentinel node, and/or an additional computing node acting as an intermediary in any of said at least one node interaction.

In at least one embodiment, a plurality sentinel nodes part of the at least one first sentinel node, according to at least one of a given blockchain-related event and a given criterion, such as a number of generated blocks, a determined number of provided vote(s) by at least one sentinel node, at least one change of at least one rate of blockchain-related activity(ies), at least one determining of at least one indication of a behavior, which may be considered anomalous, of at least one entity, such as at least one node and/or algorithm, which may be non-deterministic, such as at least one decision of at least one non-deterministic algorithm, a parameter part of the blockchain and/or the like, reach consensus aiming at uniformizing and/or determining, between said plurality, at least one portion of at least one processing step, which may involve at least one parameter's value, of a voting process and/or a change determining process and/or the like. In at least one embodiment, the consensus comprises at least one signature and/or at least one co-signature of at least one of the at least one first sentinel and/or another entity part of the blockchain. In at least one embodiment, the at least one signature and/or the at least one co-signature involves at least one interaction between a plurality of sentinel nodes part of the consensus and/or at least one other relevant node, such as at least one other intermediary node involved in at least one interaction in the consensus. In at least one embodiment, the at least one other entity is a system manager. In at least one embodiment, the consensus involves at least one witness entity part of the blockchain, such as a system manager, a server, a computing node, a processing device and a software. In at least one embodiment, the consensus comprises a comparison of blockchain-related data stored, calculated and/or shared between a plurality of sentinels of the at least one sentinel node. In at least one embodiment, an indication of at least one of an initiating of said consensus, a completion of said consensus and an executing of said consensus is provided to at least one node part of the blockchain.

In at least one embodiment, at least one sentinel node involved in an admitting process of a new sentinel node receives at least one reward in relation to said admitting process.

In at least one embodiment, a blockchain-related event identifier is related with an admitting process of a new sentinel node and a validating of a conformity of at least one portion of blockchain-related data and/or a processing of said blockchain-related data thereof.

In at least one embodiment, at least one given sentinel node, according to at least one criterion, such as a determining of at least one change of at least one rate of blockchain-related activity(ies) associated thereof and/or associated with at least one other node part of the blockchain, a reliability metric value associated thereof, a period of time elapsing, a number of at least one block being generated and/or at least one determining of at least one indication of a behavior, which may be considered anomalous, of at least one entity, such as at least one node and/or algorithm, which may be non-deterministic, such as at least one decision of at least one non-deterministic algorithm, a given poll aiming at performing at least one of said at least one task is determined. The skilled addressee will appreciate that a poll is typically recorded in a blockchain. In at least one embodiment, if a plurality of polls is determined by a plurality of sentinel nodes, one poll amongst said plurality of polls is determined according to at least one criterion, such as a determining of a time associated with a creation of said one poll, a reliability metric associated with at least one node involved in a creation of said one poll and/or the like. In at least one embodiment, at least one given sentinel node can only determine up to a number of at least one poll in according to at least one criterion, such as an associated reliability metric value, a given time period and/or the like.

In at least one embodiment, a given node, according to at least one first criterion, such as at least one event, such as a creation-related event, emitted in relation to a given poll, provides a given vote, said vote being related to a given poll. In at least one embodiment, the at least one first criterion is redetermined based on at least one event emitted by said given poll, such as a number of at least one vote provided by at least one node, an average of at least one reliability metric value associated with at least one node involved therewith, and/or the like.

In at least one embodiment, according to at least one criterion, such as when a determined number of at least one node provided at least one vote to said given poll, a period of time elapsing, a number of at least one block being generated, when at least one entity with a given authority provides an indication related thereof and/or when at least one node involved in a determining of said given poll provides an indication related thereof, a completion of said poll is established. The skilled addressee will appreciate that a vote associated with a poll is typically recorded in a blockchain. In at least one embodiment, said completion involves, according to at least one criterion, such as at least one value of at least one vote associated with at least one voting node, at least one reliability metric value associated with at least one voting node, a number of at least one voting node associated with said poll and/or a number of at least one voting node associated with at least one voting value associated with said poll, at least one of penalizing and/or at least one compensating of at least one node associated with, such as by participating, said poll is determined. In at least one embodiment, the establishing of the completion involves at least one emitting, which typically involve at least one recording, of at least one event associated thereof. In at least one embodiment, according to at least one criterion, such an emitting of a completion-related event of a poll, at least one portion of at least one machine readable instruction being a subject in said poll, therefore being a subject in the performing of the at least one task, is modified, added to at least one portion of the blockchain, terminated and/or determined.

In at least one embodiment, a given malicious node attempting to maliciously be considered associated with a sentinel role while being prohibited to according to at least one criterion is subject to at least one of a penalizing and a poll, such as a poll enabled, such as started, by at least one participating computing node which identified the malicious behavior of the given malicious node, wherein at least one other authorized computing node provides a vote on said malicious behavior and based on the at least one provided vote reward and/or punish the at least one participating node and/or at least one portion of the at least one other authorized computing node based on a result associated with a given vote associated with a given node of the at least one other authorized computing node.

In at least one embodiment, at least one machine readable instruction is an artificial intelligence (AI) related algorithm, a machine learning (ML) algorithm, and/or any relevant algorithm.

In at least one embodiment, the system comprises at least one of a single storer node, a single speedster node and a single sentinel node instead of a corresponding plurality of at least one of storer nodes, speedster nodes and sentinel nodes.

In at least one embodiment, the system does not comprise a storer node, a speedster node and/or a sentinel node.

The skilled addressee will appreciate that other roles not detailed herein may be included in the present technology.

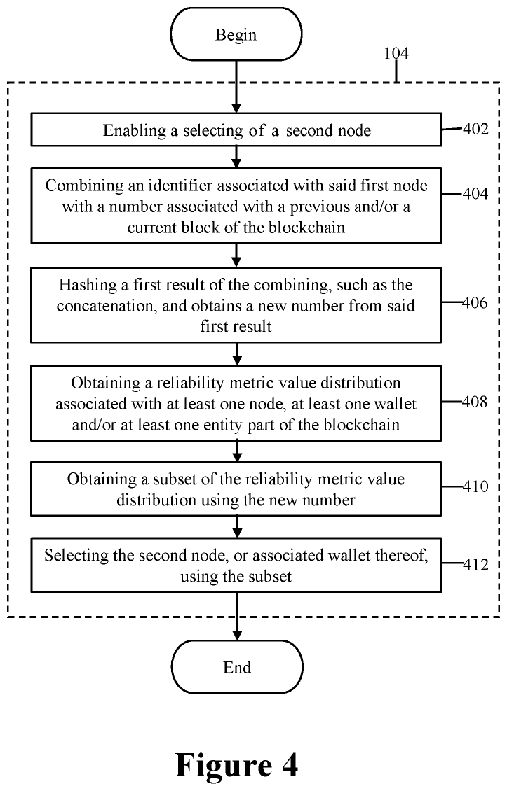

FIG. 4 is a flowchart illustrating an embodiment of a processing step of at least one embodiment of the method of FIG. 1, wherein a first node (also referred to as a generator) is selecting a second node (also referred to as an enforcer), in accordance with at least one embodiment.

According to processing step 402 the generator is ready for a selecting of a second node (hereinafter referred to as enforcer), said selecting being enabled by at least one criterion and/or blockchain-related event, such as a criterion determined as having a relevant number of at least one transaction in at least one portion of its mempool, according to the embodiments presented above.

According to processing step 404, the first node combines an identifier associated with said first node with a number associated with a previous and/or a current block of the blockchain. In at least one embodiment, the identifier is associated with a wallet, said wallet being associated with said first node. In at least one embodiment, the combining involves a concatenating of the identifier and the number. In at least one embodiment, the combining comprises a normalization process, such as a process comprising operations aiming at making the identifier and the number a similar length prior, in at least one embodiment, performing an exclusive or (XOR) operation thereof. In at least one embodiment, a plurality of identifiers is used instead of a single identifier, said plurality undergoing at least one operation, such as a combining, which, in at least one embodiment, comprises a concatenating. In at least one embodiment, at least one previous and/or current block is used, said at least one previous and/or current block undergoing at least one operation, such as a combining, which, in at least one embodiment, comprises a concatenating. In at least one embodiment, the combining involves adding at least one value of at least one indication of the identifier with at least one value of at least one indication of the number.

According to processing step 406, in at least one embodiment where the combining involves a concatenating, the first node hashes a first result of the concatenation and obtains a new number from said first result. In at least one embodiment, the obtaining involves obtaining a numerical array of numbers, each number being associated with at least one part of the hashed first result. In at least one corresponding embodiment, the obtaining further comprises reducing said array of numbers to a single number, thus the new number, such as by obtaining an average of said numbers in said array and/or the like. The skilled addressee will appreciate that the new number is, in at least one embodiment, involved in multiple blockchain-related processes, such as a selection of an enforcer. The skilled addressee will appreciate that the concatenation, hashing, and normalization mentioned in the above embodiments are examples, and that various other mathematical operations provided in various forms may be used in the combining, such as a modulus operation, a lossy numerical compression process, and/or the like.

According to processing step 408, the first node obtains a reliability metric value distribution associated with at least one node, at least one wallet and/or at least one entity part of the blockchain. The skilled addressee will appreciate that a given reliability metric value associated with a node, a wallet and/or an entity part of the blockchain can be recovered from the blockchain from at least one blockchain-related event, such as a plurality of previous events involving said node, wallet and/or entity, at least one blockchain state and/or at least one result from at least one non-deterministic algorithm part of the blockchain. In at least one embodiment, the given reliability metric value is stored in each blockchain state. In at least one embodiment, the given reliability metric value is recovered from at least one update of said given reliability metric value, the at least one update being comprised in at least one blockchain state, at least one transaction, at least one blockchain-related event and/or at least one result from at least one non-deterministic algorithm part of the blockchain.

According to processing step 410, the first node obtains a subset of the reliability metric value distribution using the new number. In at least one embodiment, the new number is used as a randomization seed in a shuffling of at least one subset comprised in the reliability metric value distribution prior the obtaining of the subset. In at least one embodiment, the new number is used for determining a position of the subset in the reliability metric value distribution. In at least one embodiment, the new number is also used for determining a size of the subset. In at least one embodiment, the size of a subset is determined in the reliability metric value distribution so that a given subset comprises approximately a similar number of at least one of at least one node, at least one wallet and at least one entity as another subset. In at least one embodiment, the subset is the enforcer region of the reliability metric value distribution, and the new number is used to determine the position of at least one node, wallet and/or entity associated with the subset. In at least one embodiment, a smart contract, a system manager, a server, a computing node, a processing device and/or a software determines the subset according, in at least one embodiment, to the new number. In at least one embodiment, the subset is selected from an entirety of the reliability metric value distribution. In at least one corresponding embodiment, in a case where the subset is not comprised in the enforcer region, the generator reprocesses processing steps 404-410 again to obtain a subset comprised in the enforcer region. In at least one embodiment, at least one signature and/or at least one co-signature is provided with the new number and/or the subset, such as a signature of the first node, a wallet associated with the first node and/or a signature from a smart contract and/or a co-signature of at least one other computing node and/or at least one other wallet associated with at least one other computing node part of the blockchain.

According to processing step 412, the first node selects the second node, or associated wallet thereof, using the subset. In at least one embodiment, the generator determines the enforcer, or associated wallet thereof, according to at least one criterion, such as a result of an evaluation of data related to the enforcer, or associated wallet thereof, such as previous transactions and/or previous updates associated with at least one reliability metric value associated with the enforcer and/or previous malicious actions and/or the like. In another embodiment, the generator arbitrarily selects the enforcer, or associated wallet thereof, associated with the subset. In another embodiment, the generator randomly or pseudo-randomly selects the enforcer, or associated wallet thereof, associated with the subset according to at least one criterion and/or blockchain-related event and/or rule, such as a temporary permission granted and/or an obligation imposed by a smart contract and/or a system manager and/or a rule part of the blockchain based on a trustworthiness of said generator, such as an history of outstanding behavior or an history of potentially malicious behavior.

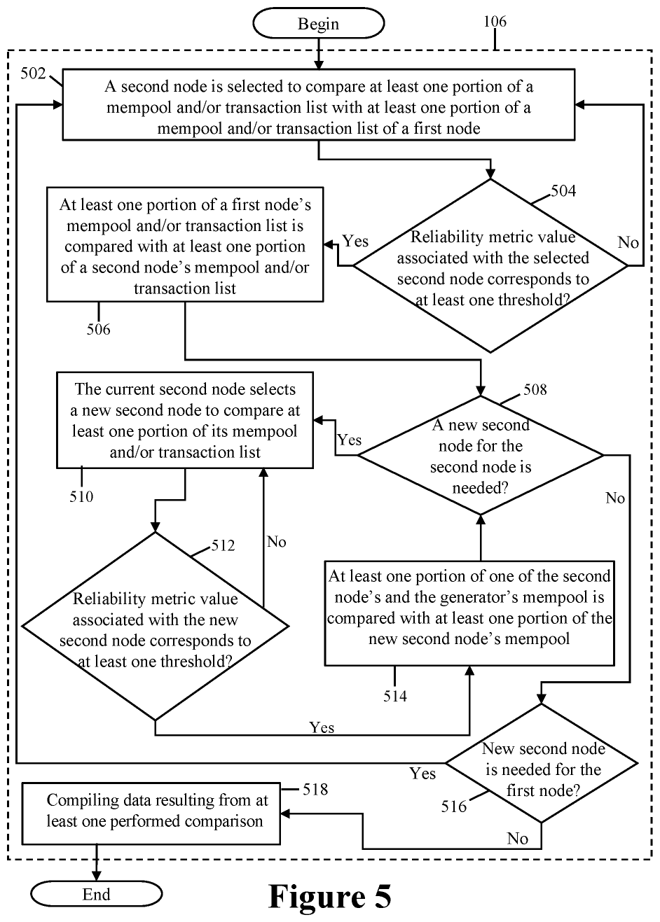

FIG. 5 is a flowchart illustrating an embodiment of a processing step of the method of FIG. 1, wherein a first node compares at least one portion of its mempool and/or transaction list with at least one portion of at least one second node's mempool and/or transaction list, in accordance with at least one embodiment.

According to processing step 502, a second node is selected to compare at least one portion of a mempool and/or transaction list with at least one portion of a mempool and/or transaction list of a first node (hereinafter referred to as generator). In at least one embodiment, the generator selects the second node, or associated wallet thereof, based on a new number. In at least one embodiment, the generator selects the second node, or associated wallet thereof, according to at least one portion of a reliability metric value distribution and compare at least one portion of its mempool and/or transaction list with at least one portion of the second node's mempool and/or transaction list. The skilled addressee will appreciate that the selecting of the second node can be provided in various forms, according to at least one embodiment, such as at least one embodiment of FIG. 4.

According to processing step 504, in at least one embodiment, the generator determines whether a reliability metric value associated with the selected second node, or associated wallet thereof, corresponds to at least one threshold. In at least one embodiment, the associated reliability metric value must be over or over or equal to a first threshold and, in at least one embodiment, under or under or equal to a second threshold. In at least one embodiment, the first threshold determines a lower limit of an enforcer region comprised in a reliability metric value distribution. In at least one embodiment, in a case where the associated reliability metric value is under the second threshold, the generator reprocesses step 502 and discards and/or ignore and/or disregard data associated with the selecting of the second node, or associated wallet thereof. In at least one other embodiment, a smart contract, a system manager, a server, a computing node, a processing device and/or a software determines if the second node is suitable for acting as an enforcer.

According to processing step 506, the second node, or associated wallet thereof, has been determined as an enforcer at processing step 504 and at least one portion of a first node's (hereinafter referred to as generator) mempool and/or transaction list is compared with at least one portion of a second node's (hereinafter referred to as enforcer) mempool and/or transaction list. In at least one embodiment, the enforcer provides to the generator a comparison result representing at least one transaction comprised in at least one portion of the mempool and/or transaction list provided by the generator and not comprised in at least one portion of its mempool and/or transaction list and/or at least one transaction comprised in at least one portion of its mempool and/or transaction list and not comprised in at least one portion of the mempool and/or transaction list provided by the generator. In at least one embodiment, the comparison result comprises a number associated with the second node. In at least one embodiment, the comparison result involves at least one signature and/or at least one co-signature, such as a signature of the second node. In at least one embodiment, at least one compared transaction is not comprised in a provided comparison result according to at least one criterion and/or rule, such as if a given number associated with a given transaction is considered out of bounds of the at least one portion of the generator's mempool and/or transaction list, if a given transaction is considered to have been very recently generated and therefore may not have been received by the generator yet, and/or the like.

According to processing step 508, a need for a new second node (hereinafter referred to as new enforcer) for the second node (hereinafter referred to as enforcer) is determined. In at least one embodiment, at least one of the second node and the generator determines if a new second node is needed according to at least one determined value, at least one criterion and/or at least one rule, such as if an indication of a result of a comparison represents and/or comprises a determined number of at least one transaction, if a determined number of at least one enforcer is involved in a process comprising steps 502 to 516 and/or the like. In at least one embodiment, the needing of a new second node is a parameter part of the blockchain. In at least one embodiment, a number of at least one enforcer needed for a given process 106 is a parameter part of the blockchain. The skilled addressee will appreciate the determining of the needing of a new second node may be enabled based on various criteria, such as a reliability metric value associated with the generator and/or a given determined enforcer.

In at least one embodiment, in a case a new second node is needed for a comparing involving at least one portion of its mempool and/or transaction list, the second node selects a new second node (hereinafter referred to as new enforcer), according to processing step 510. In at least one embodiment, the enforcer selects a subset comprised in the reliability metric value distribution using its number and selects a node, or associated wallet thereof, associated with said subset. In at least one embodiment, the enforcer selects the new second node, or associated wallet thereof, from the reliability metric value distribution. In at least one embodiment, the enforcer arbitrarily selects the new second node, or associated wallet thereof, associated with the subset. In another embodiment, the enforcer randomly or pseudo-randomly selects the new second node, or associated wallet thereof, associated with the subset according to at least one criterion and/or blockchain-related event and/or rule, such as a temporary permission granted and/or an obligation imposed by a smart contract and/or a system manager and/or a rule part of the blockchain based on a trustworthiness of said enforcer, such as an history of outstanding behavior or an history of potentially malicious behavior.

According to processing step 512, in at least one embodiment, the enforcer determines whether a reliability metric value associated with the new second node, or associated wallet thereof, corresponds to at least one threshold. In at least one embodiment, the corresponding involves the associated reliability metric value being over or over or equal to a first threshold and, in at least one embodiment, under or under or equal to a second threshold. In at least one embodiment, the first threshold determines a lower limit of one of an enforcer region and a new enforcer region comprised in a reliability metric value distribution. In at least one embodiment, the new enforcer region is associated with at least one different threshold from the at least one threshold and represents a new enforcer role, the new enforcer role enabling at least one given entity part of the blockchain, such as a node, to act as a new enforcer. In at least one embodiment, in a case where the associated reliability metric value is under the second threshold, the enforcer reprocesses steps 510 and 512 and discards and/or ignore and/or disregard data associated with the selecting of the new second node, or associated wallet thereof. In at least one other embodiment, a smart contract, a system manager, a server, a computing node, a processing device and/or a software determines if the new second node is suitable for acting as an enforcer. In at least one embodiment, the generator determines the new second node.

According to processing step 514, the new second node, or associated wallet thereof, has been determined as an enforcer at processing step 512 and at least one portion of one of the second node's and the generator's mempool and/or transaction list is compared with at least one portion of the new second node's mempool and/or transaction list. In at least one embodiment, the new second node provides to at least one of the second node and the generator a comparison result representing at least one transaction comprised in at least one portion of the second node's mempool and/or transaction list and not comprised in at least one portion of its mempool and/or transaction list and/or at least one transaction comprised in at least one portion of its mempool and/or transaction list and not comprised in at least one portion of the second node's mempool and/or transaction list. In at least one embodiment, the second node provides to the generator the comparison result. In at least one embodiment, the comparison result comprises a number associated with the new second node. In at least one embodiment, the comparison result involves at least one signature and/or at least one co-signature, such as a signature of the new second node and/or a signature of the second node. In at least one embodiment, at least one compared transaction is not comprised in a provided comparison result according to at least one criterion and/or rule, such as if a given number associated with a given transaction is considered out of bounds of the at least one portion of the second node's mempool and/or transaction list, if a given transaction is considered to have been very recently generated and therefore may not have been received yet by the second node, and/or the like.

In at least one embodiment, the new second node executes step 508, now acting as the second node in step 508. The skilled addressee will appreciate that an advantage of the previous at least one embodiment is a potential increase in security and accuracy of at least one portion of at least one of the generator's and the second node's mempool and1/or transaction list.

According to processing step 516, a need for a new second node (hereinafter referred to as new enforcer) for the generator is determined. In at least one embodiment, at least one of the second node and the generator determines if a new second node is needed according to at least one determined value, at least one criterion and/or at least one rule, such as if an indication of a result of a comparison represents and/or comprises a determined number of at least one transaction, if a determined number of at least one enforcer is involved in a process comprising steps 502 to 516 and/or the like. In at least one embodiment, the needing of a new second node is a parameter part of the blockchain. In at least one embodiment, a number of at least one enforcer needed for a given process 106 is a parameter part of the blockchain. The skilled addressee will appreciate the determining of the needing of a new second node may be enabled based on various criteria, such as a reliability metric value associated with the generator and/or a given determined enforcer. The skilled addressee will also appreciate that, in at least one embodiment, if a new enforcer is needed, step 502 is therefore processed an additional time, otherwise step 518 is processed. In at least one embodiment, step 518 is also performed after one or more of the comparing steps 504, 508, 512, for example after each comparing step 504, 508, 512 by at least one of the second node, a new second node, a given enforcer involved in process 106, such as an enforcer which performed a comparing, and the generator, i.e. step 506 and, in at least one embodiment, step 514.

According to processing step 518, the generator compiles data resulting from at least one performed comparison. The skilled addressee will appreciate that the compiled comparison data in processing step 518 is associated with at least one difference and/or similarity obtained from at least one comparing. The skilled addressee will appreciate that there is typically a direct correlation between a processing time of a process 106 and a number of at least one enforcer involved in said process 106. The skilled addressee will also appreciate that using a plurality of enforcers also typically increases a legitimacy of a block, at a cost of higher processing time and, oftentimes, additional storage needed in the block. The skilled addressee will also appreciate that a diminishing return can also typically be observed when a large number of enforcers are needed, in at least one embodiment. In at least one embodiment, data resulting from at least one comparison is stored off-chain, for instance by using a second layer architecture and/or a storage system such as InterPlanetary File System (IPFS). The skilled addressee will also appreciate that a given result of a given comparison and/or given compiled comparison data may be provided in a form of at least one indication thereof or said raw given result thereof.

In at least one embodiment, at least one comparison result associated with at least one enforcer involved in process 106 is not provided to the generator until the end of processing step 106, i.e., at processing step 518.

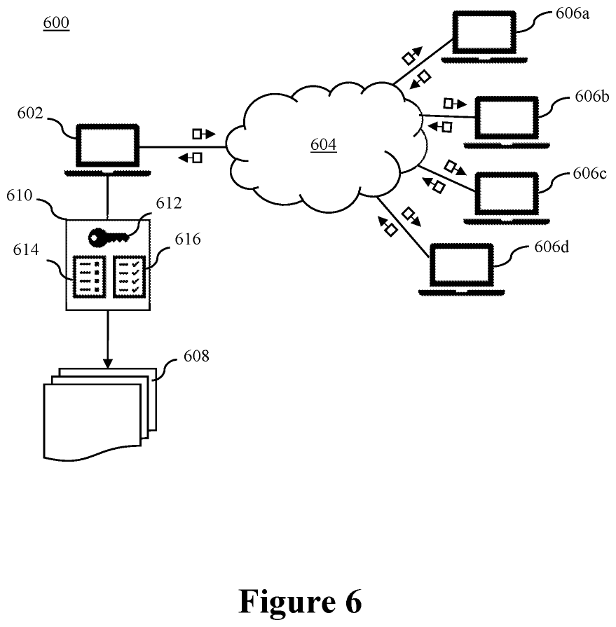

FIG. 6 is a schematic diagram illustrating an embodiment of a system 600 comprising a plurality of nodes 602, 606a-d part of a blockchain 608 wherein the node 602 (also referred to as a generator 602) is involved in an adding of a block 610, in accordance with at least one embodiment. The skilled addressee will appreciate that the generator 602 is a node connected to a network 604, the network 604 being connected to a plurality of other nodes 606a-d. The skilled addressee will also appreciate that embodiments are not limited to four nodes 606a-d as depicted in FIG. 6, and that the number of nodes part of the blockchain may be provided in various forms. In at least one embodiment, each node 602, 606a-d stores data part of and is part of the blockchain 608. In at least one other embodiment, the blockchain 608 presented in the system 600 is related to a system enabling to delegate a storing of at least one portion of data part of the blockchain 608 to at least one of the nodes 602, 606a-d, thereby implying that at least one portion of the nodes 602, 606a-d not storing an entirety of data of the blockchain 608 would query at least one node storing the blockchain 608 in order to obtain relevant data thereto, such as historical transaction-related data.

The skilled addressee will appreciate that the network 604 may be of various types. In at least one embodiment, the network 604 is selected from a group comprising local area networks (LAN), metropolitan area networks (MAN) and wide area networks (WAN). In at least one embodiment, the network 604 is a peer-to-peer network which is related to the Internet.

In at least one embodiment, the generator 602 is generating a block 610 comprising a number 612, a transaction list 614 and compiled comparison data 616. In at least one embodiment, the generator 602 obtains the number 612 by obtaining a number of a previous and/or a current block part of the blockchain, combining the number of the previous and/or the current block part of the blockchain 608 with an identifier, or indication thereof, associated with the generator 602, or associated wallet thereof, performing mathematical operation(s) on a result of the combining, such as a hashing and reducing a result of the hashing to a single number, thereby producing a new single number. In at least one embodiment, the combining involves a concatenating. The skilled addressee will appreciate that the foregoing concatenation, hashing and numerical reduction are examples, and the mathematical operation(s) given to the identifier combined with the number associated to the previous and/or current block may be provided in various forms.

In at least one embodiment, the generator 602 obtains the transaction list 614 by compiling at least one transaction part of at least one portion of its mempool in a transaction list 614, the at least one transaction being organized based on its at least one associated number. In at least one embodiment where a plurality of numbers is associated with a given transaction, the organization involves obtaining one number from the plurality of numbers to perform said organization, such as by reducing said plurality of numbers to a single number or selecting a number from the plurality of numbers using, in at least one embodiment, an additional number associated with the generator 602. In at least one embodiment, the at least one transaction comprised in at least one portion of the generator 602's mempool and/or transaction list is selected according to at least one criterion selected from a group comprising a fee associated with a transaction, a number of at least one transaction made by a requester involved in a transaction, a total quantity of at least one asset included in at least one transaction of a requester involved in a transaction, a quantity of at least one different type of transaction(s) made by a requester involved a transaction and the like. The skilled addressee will appreciate that the organizing of the at least one transaction is not limited by the presented embodiments, and that the organizing of the at least one transaction may vary.

The skilled addressee will appreciate that the compiled comparison data may be obtained from an enforcer comprised in the plurality of nodes 606a-d. In at least one embodiment, the generator 602 selects, using its number 612, at least one node 606a-d, or associated wallet thereof, being associated with a reliability metric value greater than a determined threshold determined suitable to act as an enforcer, and provides the at least one node 606a-d the transaction list 614 through the network 604. In at least one embodiment, a plurality of numbers 612 is provided, each number being associated with at least one previous or current block part of the blockchain 608 and at least one identifier, or indication thereof, associated with the generator 602. The skilled addressee will appreciate that the at least one identifier may be provided in various forms, as long as said form allows to differentiate the generator 602 from another node part of the blockchain 608. In at least one other embodiment, a smart contract, a system manager, a server, a computing node, a processing device and/or a software determines if the selected node is suitable to act as an enforcer. In at least one embodiment, a smart contract, a system manager, a server, a computing node, a processing device and/or a software determines an enforcer. Upon receiving the transaction list 614, the at least one node 606a-d compares the transaction list 614 with at least one portion of its mempool and/or transaction list and obtains a comparison result. In at least one embodiment, the comparison result comprises a number associated with at least one of the at least one node 606a-d. In at least one embodiment, the comparison result is associated with the compiled comparison data 616 in accordance with at least one embodiment of FIG. 5. In at least one embodiment, the compiled comparison data 616 is provided using the network 604 to the generator in accordance with at least one embodiment of FIG. 5. In at least one embodiment, the compiled comparison data 616 is validated at least one of before the adding process can be completed and after the adding process, such as when a given node 606a-d part of the blockchain receives said block after the adding process. In at least one embodiment, the validation involves comparing at least one number associated with the compiled comparison data 616 with at least one of at least one number associated with the generator 602 and at least one other number associated with the compiled comparison data 616.

After the determining of the number 612, the associating of the transaction list 614 and the associating of the compiled comparison data 616 with the block 610, the generator 602 adds the block 610 to the blockchain 608, using to the network 604. In at least one embodiment, in a case of a conflict between two or more blocks and/or blockchain versions, a verdict is determined. The skilled addressee will appreciate that the determining of the verdict may be provided in various forms. In at least one embodiment, in a case where two or more generators are simultaneously pushing their respective block(s) and/or version of the blockchain, a smart contract, a system manager, a server, a computing node, a processing device and/or a software selects at least one block from the block(s) and/or selects a version to be determined, according to at least one criterion such as a number associated with at least one block from the block(s) and/or at least one block from the blockchain version, a reliability metric value associated with the generator and/or any relevant entity, such as a node, involved in at least one transaction obtained from the respective block(s) and/or versions and/or the like.

In at least one embodiment, the transaction list 614 and the compiled comparison data 616 are associated with at least one signature and/or co-signature from at least one respective involved entity, such as a requester, a partner, a generator, an enforcer, any other relevant role, a given wallet associated with a given involved computing node, a proxy node and/or the like. In at least one embodiment, a given public key, such as one associated with a given wallet, associated with the generator 602 and/or at least one of the nodes 606a-d, or a respective wallet thereof, is provided to at least one node part of the blockchain 608. In at least one embodiment, the block 610 also comprises at least one signature and/or co-signature, for instance a signature of the generator and/or a plurality of generators contributing to a generating of said block 610.

The skilled addressee will appreciate that the system 600 depicted in FIG. 6 is decentralized, i.e., at least one of the involved node 602, 606a-d therein stores in its memory data part of the blockchain 608 and thereby generally possess a same authority as at least one other node 602, 606a-d for at least one common feature of the system. The skilled addressee will appreciate that, in at least one embodiment, at least one of the node 602, 606a-d is subject to slashes and/or penalizations, such as slashes and/or penalizations described in reference to FIG. 3. In at least one embodiment, a node 602, 606a-d first delegates to at least one other node and/or entity part of the blockchain a storing of at least one transaction part of at least one portion of its mempool and/or a generating of a given block comprising at least a portion of the delegated at least one transaction. In at least one embodiment, the first delegating further comprises a delegating of storage of at least one previous block part of the blockchain. In at least one embodiment, the first delegating further comprises storing by at least one of the delegating node and at least one other witness node at least one delegating proof of at least one element involved in such delegating and/or a way of retrieving such delegated at least one element, such as storing at least one block header for a delegating comprising a delegating of at least one previous block part of the blockchain and/or such as storing at least one transaction hash for a delegating comprising a delegating of at least one transaction part of at least one portion of a delegating node's mempool and/or the like. In at least one embodiment, said at least one delegating proof comprises at least one signature and/or co-signature, such as a signature of the delegating node, at least one co-signature of at least one witness node and/or the like. In at least one embodiment, a delegating also comprises delegating a blockchain-related action, such as a blockchain-related action enabled by a given role, such as acting as an enforcer, to the at least one other node and/or entity part of the blockchain. The skilled addressee will appreciate that a delegating allows a delegating node to continue a participating in at least one type of at least one activity without, for instance, the delegating node currently having an active network connection. In at least one embodiment, said at least one entity comprises a specialized physical device configured to perform a given delegated process, such as a blockchain-related action, and/or storage, such as a storage of at least one transaction and/or a storage of at least one previous block. In at least one embodiment, a delegating involves reducing and/or removing at least one future reward and/or compensation concerning the delegating node, such as block-related rewards and/or compensations and/or transaction fees-related rewards and/or compensations. In at least one embodiment where a given delegating node wants to act as a generator, an enforcer, a partner and/or any other relevant role, it would request access to at least one portion of its delegated at least one transaction and/or at least one of its delegated element, such as at least one previous block. In at least one embodiment, a delegating involves a given node to first receive at least one transaction in at least one portion of its mempool, process it, such as by associating at least one signature and, optionally, a timestamp and/or block number associated with the receiving of the at least one transaction and providing it to at least one entity part of the blockchain, such as a node, storing such at least one transaction. The skilled addressee will appreciate that a similar process, although slightly altered, as the previous at least one embodiment may be used for various delegating, such as a delegating of previous block storage and/or a delegating of at least one blockchain-related action, such as a blockchain-related action enabled by a given role.

In at least one embodiment, the system 600 involves a sharding technique, which determines nodes into distinct subsets (hereinafter referred to as shards). The skilled addressee will appreciate that, in at least one embodiment, a shard is associated with a determined quantity of at least one node, wherein a validity of at least one generating transaction and/or block is determined according to at least one criterion and/or rule, such as at least one partner and/or any first other relevant role to be associated with said at least one transaction must be associated with a different shard than at least one requester and/or any second other relevant role involved in said at least one transaction, or, in at least one other embodiment, in a same shard thereof, and/or such as at least one enforcer and/or any third other relevant role to be associated with said at least one block must be associated with a different shard than at least one generator and/or any fourth other relevant role involved in said at least one block, or, in at least one other embodiment, in a same shard thereof, and/or the like.

In at least one embodiment where the system is less decentralized, an additional authority part of the blockchain 608 is associated to at least one additional smart contract, a system manager, a server, a computing node, a processing device and/or a software, such as an authority granting an entity a right to enable, such as start, at least one specific poll type and/or the like. It will thus be appreciated that the nature of the system 600 may be provided in various forms.

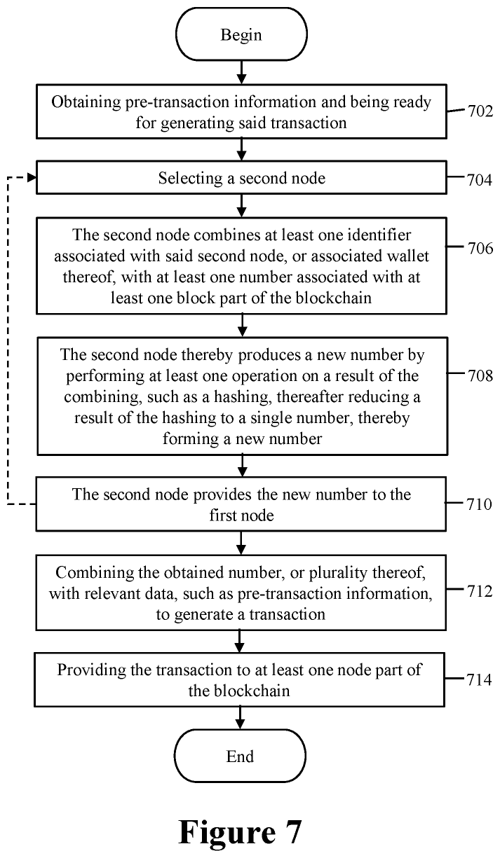

FIG. 7 is a flowchart illustrating an embodiment of a method for generating a transaction to be associated with a block, in accordance with at least one embodiment.

According to processing step 702, a first node (hereinafter referred to as requester) obtains pre-transaction information and is ready for generating said transaction. In at least one embodiment, pre-transaction information consists of at least one information selected from a group comprising at least one of an identifier of a node, or associated wallet thereof, involved in the transaction, data and/or quantity of at least one asset being transferred, a time of transaction such as a timestamp and/or any transaction-related information. The skilled addressee will appreciate that a given pre-transaction information of a given transaction may be provided in various forms. In at least one embodiment, at least one portion of a given pre-transaction information for a given transaction is obtained in any one of steps 702 to 712.

In at least one embodiment, pre-transaction information may comprise a unique identifier to associate with a given transaction, such as an identifier representing a given transaction type. In at least one embodiment, pre-transaction information may comprise a token and/or a quantity of at least one asset to transfer. In at least one embodiment, the quantity of at least one asset a requester is allowed to transfer and/or allow access to is influenced by at least one criterion, such as a reliability metric value associated with the requester and/or at least one receiving entity in the transaction, a quantity of at least one transaction associated with a corresponding transaction type made by the requester and/or the at least one receiving entity in the transaction, a total quantity of at least one asset included in at least one transaction made by the requester and/or the at least one receiving entity in the transaction, a quantity of at least one different type of transaction(s) made by the requester and/or the at least one receiving entity in the transaction, a frequency of transactions made by the requester and/or the at least one receiving entity in the transaction and/or the like. In at least one embodiment, a plurality of requesters participate in a generating of the transaction for a given transaction type, such as a given transaction type requiring a co-signature of at least one other node to be considered valid. In at least one embodiment, the requester adds the transaction to at least one portion of its mempool after generating said transaction.

According to processing step 704, a second node (hereinafter referred to as partner) is selected. In at least one embodiment, to select the second node, the first node first obtains a number associated with at least one identifier associated with the first node, or associated wallet thereof, and with at least one previous and/or current block. The skilled addressee will appreciate that the number is used for various functions, mechanisms, systems and methods part of the blockchain, such as recording and/or generating a transaction and/or a block part of the blockchain, selecting and/or communicating and/or interacting with an entity and/or a wallet and/or a node part of the blockchain and/or the like. The skilled addressee will also appreciate that the at least one previous and/or current block may be selected from a range in a block distribution recoverable from the blockchain in accordance with the at least one embodiment.

In at least one embodiment, the second node, or associated wallet thereof, is associated with at least one additional role, the at least one role being at least one of an enforcer role, a generator role, and/or any other relevant role, an enabling of the at least one additional role being associated with at least one previous and/or current block and/or a blockchain-related state part of the blockchain. In at least one embodiment, the at least one additional role is enabled by a processing of a plurality of blocks part of the blockchain, such as by evaluating at least one blockchain-related action performed by and/or involving the second node, or associated wallet thereof. In at least one embodiment, the first node selects a second node according to at least one machine readable instruction and/or request involving a smart contract, a system manager, a server, a computing node, a processing device and/or a software. In at least one embodiment, instead of a first node selecting a second node, a given second node selects the first node according to at least one emitted blockchain-related event by at least one of the first node, a smart contract, a system manager, a server, a computing node, a processing device and/or a software, such as a blockchain-related event indicating that the first node is ready to interact with a second node for a blockchain-related action requiring said given second node. In at least one embodiment, the first node requests at least one of a smart contract, a system manager, a server, another computing node, a processing device and a software to select the second node. The skilled addressee will appreciate that a process similar to a selecting of a second (first) node by a first (second) node may be suited for various other relevant roles and/or other relevant interacting and/or communication processes between at least two entities part of the blockchain, enabling a traceability of said interacting and/or communication process, the traceability being enabled due to the nature of said interacting and/or communication process.

After obtaining the number, the first node obtains a reliability metric value distribution associated with at least one node part of the blockchain. In at least one embodiment, in a case where a second node, or associated wallet thereof, associated with the reliability metric value distribution has a reliability metric value smaller or smaller or equal to an upper limit of a blacklist region comprised in the reliability metric value distribution, the first node reprocesses step 704. In at least one embodiment, the first node obtains, using said number, a reliability metric value subset in the reliability metric value distribution according to at least one determined reliability metric value threshold. In at least one embodiment, the at least one determined reliability metric value threshold comprises a lower bound reliability metric value threshold and an upper bound reliability metric value threshold. In at least one embodiment, the at least one determined reliability metric value threshold is at least one of determined and redetermined according to at least one criterion and/or blockchain-related event, such as a number of active partners part of the blockchain, a right or restriction granted or imposed to a given entity, such as a node, by another entity part of the blockchain, a determined number of at least one block generated, a rule and/or the like. In at least one embodiment, the first node selects a second node based on the subset of the reliability metric value distribution. In at least one related embodiment, the first node uses an additional evaluation method, such as another reliability metric system based on a different set of rules than the reliability metric value, when selecting the second node. The skilled addressee will appreciate that by determining at least one reliability metric value threshold in the reliability metric value distribution for selecting the second node, the second node is guaranteed to have followed at least one determined rule part of the blockchain and is therefore more likely to perform at least one given blockchain-related action legitimately. In at least one embodiment, the subset is involved in a plurality of selections of second nodes. In at least one embodiment, the subset is reobtained after a defined quantity of at least one selection. The skilled addressee will appreciate by the skilled addressee that the reliability metric value distribution may be obtained for various other purposes than to obtain a reliability metric value or a reliability metric value subset thereof, and that these two operations are independent from one another. In at least one embodiment where a plurality of numbers is obtained by a given first node instead of a single number, each number may be associated with a different evaluation metric distribution, such as a reliability metric value distribution, and a corresponding subset of each different evaluation metric distribution is obtained and processed, such as by allocating a weight of importance to each subset prior evaluating their importance, prior determining at least one second node. In at least one embodiment, instead of a single first node, a plurality of first nodes participates in a selecting of a second node. In at least one embodiment, at least one signature and/or co-signature is involved in a given selecting of a second node and/or, in at least one embodiment, an interacting between a plurality of first nodes. When a second node has been determined, said second node obtains a number, or a plurality thereof, to associate with the transaction. In at least one embodiment, a plurality of first nodes is involved in the generating of the transaction instead of a single first node, for instance by contributing and/or processing different part of transaction-related data and/or reprocessing and/or approving transaction-related data, such as by providing at least one signature and/or co-signature.

According to processing step 706, the second node (hereinafter referred to as partner) combines at least one identifier associated with said second node, or associated wallet thereof, with at least one number associated with at least one block part of the blockchain. In at least one embodiment, the combining involves a concatenating.

According to processing step 708, the second node (hereinafter referred to as partner) thereby produces a new number by performing at least one operation on a result of the combining, such as a hashing, thereafter reducing a result of the hashing to a single number, thereby forming a new number. The skilled addressee will appreciate that the foregoing concatenation, hashing and numerical reduction are examples, and the mathematical operation(s) given to the at least one identifier combined with the at least one number associated to at least one previous and/or current block may be provided in various forms.

According to processing step 710, the second node (hereinafter referred to as partner) provides the new number to the first node (hereinafter referred to as requester). In at least one embodiment, processing steps 704-710 are processed at least one additional time to provide the requester with a plurality of new numbers obtained from a plurality of partners. In at least one embodiment, a given second node processes steps 704-710 at least one time prior providing to the first node at least one new number obtained from said processing. In at least one embodiment, at least one of the requester and the partner selects a plurality of partners based on a sum of reliability metric values obtained from said plurality of partners. In at least one embodiment, a number of needed at least one partner for a given transaction is influenced by at least one criterion, such as a type of said transaction. In at least one embodiment, a needing of at least one additional second node is a parameter part of the blockchain. In at least one embodiment, a number of at least one partner needed to provide at least one new number is a parameter part of the blockchain. The skilled addressee will appreciate the determining of the needing of at least one additional second node may be enabled based on various criteria, such as a reliability metric value associated with the requester and/or at least one receiving entity in the transaction, a quantity of at least one transaction associated with a corresponding transaction type made by the requester and/or the at least one receiving entity in the transaction, a total quantity of at least one asset included in at least one transaction made by the requester and/or the at least one receiving entity in the transaction, a quantity of at least one different type of transaction(s) made by the requester and/or the at least one receiving entity in the transaction, a frequency of transactions made by the requester and/or the at least one receiving entity in the transaction, a given determined second node and/or the like.

In at least one embodiment, the number associated with the transaction is obtained by combining at least one portion of a plurality of numbers obtained from a corresponding partner of a plurality of partners, and/or selecting a given number from the plurality of numbers thereof. The skilled addressee will appreciate that the combining and/or selecting may not necessarily occur during a generation process of a transaction, and/or may occur during a generation of a block instead. In at least one embodiment where the combining and/or selecting occurs at a generating of a block, a generator would select a number of one of the partners, and/or a number representing a combination thereof, which would be associated with the transaction and therefore would determine its positioning in at least one portion of a transaction list and/or mempool to be comprised in a block. In at least one embodiment, a result of the combination and/or selecting is associated with at least one of the generating block and the transaction. The skilled addressee will appreciate that a number associated with the transaction obtained from a plurality of partners may be determined by various means, and that the determining is not limited by the above embodiments. In at least one embodiment, such as an embodiment where a number associated with a given transaction is an average of at least one number obtained from at least one partner, the given transaction is associated with at least one signature and/or co-signature, for instance a signature from at least one of the at least one partner and/or a co-signature from a plurality of partners obtained from the at least one partner.

According to processing step 712, the obtained number, or plurality thereof, is combined with relevant data, such as pre-transaction information, to generate a transaction. In at least one embodiment, at least one number of at least one partner must be associated with a transaction for the transaction to be considered valid, said validity involves at least one of adding said transaction in at least one portion of a given node's mempool and/or transaction list and/or block.

According to processing step 714, the transaction is provided to at least one node part of the blockchain.

In at least one embodiment, the requester provides the pre-transaction information obtained in processing step 702 to a smart contract, a system manager, a server, a computing node, a processing device and/or a software, which thereby processes steps 704-714.

In at least one embodiment, the requester and/or the partner and/or another relevant node of at least one transaction comprised in a block receives a reward and/or compensation which is influenced by at least one criterion selected from a group comprising a reliability metric value associated with the requester and/or partner and/or at least one receiving entity in at least one of the at least one transaction, a quantity of at least one transaction associated with a corresponding transaction type made by the requester and/or partner and/or the at least one receiving entity in at least one of the at least one transaction, a total quantity of at least one asset included in at least one transaction made by the requester and/or partner and/or the at least one receiving entity in at least one of the at least one transaction, a quantity of at least one different type of transaction(s) made by the requester and/or partner and/or the at least one receiving entity in at least one of the at least one transaction, a frequency of transactions made by the requester and/or partner and/or the at least one receiving entity in at least one of the at least one transaction, a given determined second node, a number of at least one requester and/or partner involved in at least one of the at least one transaction and the like. In at least one embodiment, the other relevant node comprises a generator involved in a generating of a block comprising said at least one transaction.

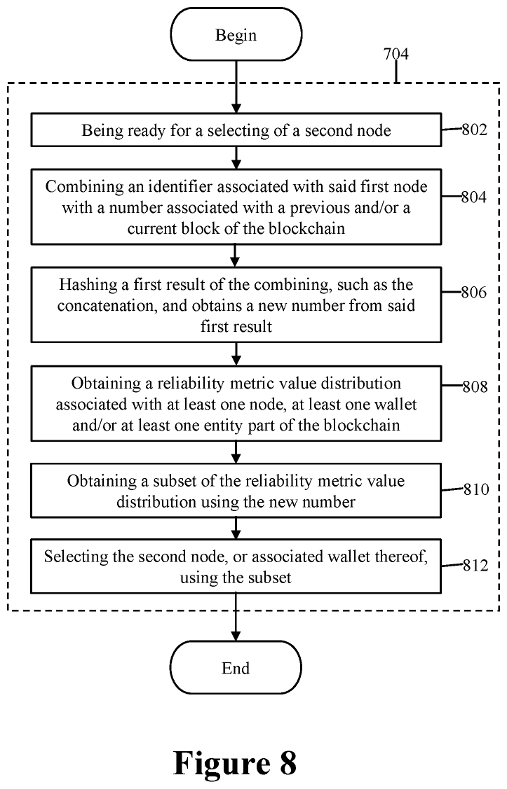

FIG. 8 is a flowchart illustrating an embodiment of a processing step 704 of at least one embodiment of the method of FIG. 7, wherein a first node (also referred to as a requester) is selecting a second node (also referred to as a partner), in accordance with at least one embodiment.

According to processing step 802, the first node is ready for a selecting of the second node, said selecting being enabled by at least one criterion and/or blockchain-related event, such as a criterion determined as a reliability metric value associated with said first node, or associated wallet thereof, being higher than a determined value.

According to processing step 804, the first node combines an identifier associated with said first node with a number associated with a previous and/or a current block of the blockchain. In at least one embodiment, the identifier is associated with a wallet, said wallet being associated with said first node. In at least one embodiment, the combining involves a concatenating of the identifier and the number. In at least one embodiment, the combining comprises a normalization process, such as a process comprising operations aiming at making the indication of the identifier and the number a similar length prior, in at least one embodiment, performing an exclusive or (XOR) operation thereof. In at least one embodiment, a plurality of identifiers is used instead of a single identifier, said plurality undergoing at least one operation, such as a combining, which, in at least one embodiment, comprises a concatenating. In at least one embodiment, at least one previous and/or current block is used, said at least one previous and/or current block undergoing at least one operation, such as a combining, which, in at least one embodiment, comprises a concatenating. In at least one embodiment, the combining involves adding at least one value of at least one indication of the identifier with at least one value of at least one indication of the number.

According to processing step 806, in at least one embodiment where the combining involves a concatenating, the first node hashes a first result of the combining, such as the concatenation, and obtains a new number from said first result. In at least one embodiment, the obtaining involves obtaining a numerical array of numbers, each number being associated with at least one part of the hashed first result. In at least one corresponding embodiment, the obtaining further comprises reducing said array of numbers to a single number, thus the new number, such as by obtaining an average of said numbers in said array and/or the like. The skilled addressee will appreciate that the new number is, in at least one embodiment, involved in multiple blockchain-related processes, such as a selection of a partner. The skilled addressee will appreciate that the concatenation, hashing, and normalization mentioned in the above embodiments are examples, and that various other mathematical operations provided in various forms may be used in the combining, such as a modulus operation, a lossy numerical compression process, and/or the like.

According to processing step 808, the first node (hereinafter referred to as requester) obtains a reliability metric value distribution associated with at least one node, at least one wallet and/or at least one entity part of the blockchain. The skilled addressee will appreciate that a given reliability metric value associated with a node, a wallet and/or an entity part of the blockchain can be recovered from the blockchain from at least one blockchain-related event, such as a plurality of previous events involving said node, wallet and/or entity, at least one blockchain state and/or at least one result from at least one non-deterministic algorithm part of the blockchain. In at least one embodiment, the given reliability metric value is stored in each blockchain state. In at least one embodiment, the given reliability metric value is recovered from at least one update of said given reliability metric value, the at least one update being comprised in at least one blockchain state, at least one transaction, at least one blockchain-related event and/or at least one result from at least one non-deterministic algorithm part of the blockchain.

According to processing step 810, the first node obtains a subset of the reliability metric value distribution using the new number. In at least one embodiment, the new number is used as a randomization seed in a shuffling of at least one subset comprised in the reliability metric value distribution prior the obtaining of the subset. In at least one embodiment, the new number is used for determining a position of the subset in the reliability metric value distribution. In at least one embodiment, the new number is also used for determining a size of the subset. In at least one embodiment, the size of a subset is determined in the reliability metric value distribution so that a given subset comprises approximately a similar number of at least one of at least one node, at least one wallet and at least one entity as another subset. In at least one embodiment, the subset is the partner region of the reliability metric value distribution, and the new number is used to determine the position of at least one node, wallet and/or entity associated with the subset. In at least one embodiment, a smart contract, a system manager, a server, a computing node, a processing device and/or a software determines the subset according, in at least one embodiment, to the new number. In at least one embodiment, the subset is selected from an entirety of the reliability metric value distribution. In at least one corresponding embodiment, in a case where the subset is not comprised in the partner region, the generator reprocesses processing steps 804-810 again to obtain a subset comprised in the partner region. In at least one embodiment, at least one signature and/or at least one co-signature is provided with the new number and/or the subset, such as a signature of the first node, a wallet associated with the first node and/or a signature from a smart contract and/or a co-signature of at least one other computing node and/or at least one other wallet associated with at least one other computing node part of the blockchain.

According to processing step 812, the first node selects the second node, or associated wallet thereof, using the subset. In at least one embodiment, the requester determines the partner, or associated wallet thereof, according to at least one criterion, such as a result of an evaluation of data related to the partner, or associated wallet thereof, such as previous transactions and/or previous updates associated with at least one reliability metric value associated with the partner and/or previous malicious actions and/or the like. In another embodiment, the requester arbitrarily selects the partner, or associated wallet thereof, associated with the subset. In another embodiment, the requester randomly or pseudo-randomly selects the partner, or associated wallet thereof, associated with the subset according to at least one criterion and/or blockchain-related event and/or rule, such as a temporary permission granted and/or an obligation imposed by a smart contract and/or a system manager and/or a rule part of the blockchain based on a trustworthiness of said requester, such as an history of outstanding behavior or an history of potentially malicious behavior.

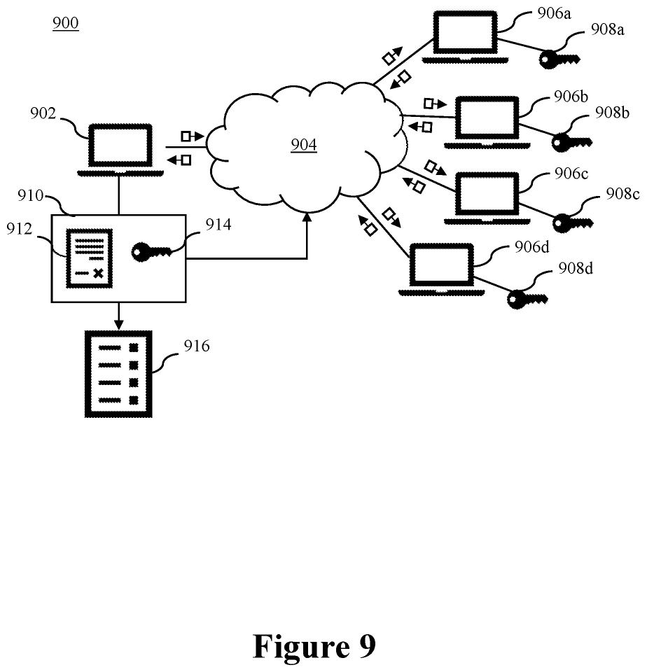

FIG. 9 is a schematic diagram illustrating an embodiment of a system 900 comprising a plurality of nodes 902, 906a-d part of a blockchain 916 wherein the node 902 (hereinafter referred to as the requester 902) is involved in a generating of a transaction 910, in accordance with at least one embodiment. The skilled addressee will appreciate that the requester 902 is a node connected to a network 904, the network 904 being connected to a plurality of other nodes 906a-d. The skilled addressee will also appreciate that embodiments are not limited to four nodes 906a-d as depicted in FIG. 9, and that the number of nodes part of the blockchain may vary greatly and be provided in various forms. In at least one embodiment, each node 902, 906a-d stores data part of and is part of the blockchain 916. In at least one other embodiment, the blockchain 916 presented in the system 900 is related to a system enabling to delegate a storing of at least one portion of data part of the blockchain 916 to at least one of the nodes 902, 906a-d, thereby implying that at least one portion of the nodes 902, 906a-d not storing at least one portion of data of the blockchain 916 would query at least one node storing data part of the blockchain 916 in order to obtain relevant data thereto, such as historical transaction-related data.

The skilled addressee will appreciate that the network 904 may be of various types. In at least one embodiment, the network 904 is selected from a group comprising local area networks (LAN), metropolitan area networks (MAN) and wide area networks (WAN). In at least one embodiment, the network 904 is a peer-to-peer network which is related to the Internet.

In at least one embodiment, the requester 902 enables a generating of a transaction 910, said transaction being associated with at least one first obtained number 914 and pre-transaction information 912, wherein said at least one number 914 is a result of at least one comprising and/or combining of at least one number associated with at least one number 908a-d, wherein said at least one number 908a-d was first obtained from at least one corresponding partner, said at least one corresponding partner having first been determined from a plurality of nodes 906a-d, or a plurality of associated wallets thereof, and wherein said determining involved at least one of the requester 902 and at least one node from the plurality of nodes 906a-d, such as a given partner involved in the transaction 910. In at least one embodiment, the at least one number associated with the at least one number 908a-d comprises a number associated with the requester 902 and at least one previous and/or current block of the blockchain 916. The skilled addressee will appreciate that interactions and/or communications, such as at least one obtaining and/or providing, between a plurality of nodes 902, 906a-d, such as the obtaining of the at least one number 908a-d, typically use the network 904.

The skilled addressee will also appreciate that the determining of the at least one partner can be provided in various forms, according to at least one embodiment, such as the embodiment of FIG. 8. The skilled addressee will also appreciate that the obtaining of the at least one number 908a-d and the combining of the at least one number can be provided in various forms, according to at least one embodiment, such as the embodiment of FIG. 7 and the embodiment of FIG. 8. Finally, the skilled addressee will appreciate that an obtaining of the pre-transaction information 912 and the pre-transaction information 912 can be provided in various forms, according to at least one embodiment, such as the embodiment of FIG. 7.

Once the requester 902 obtained all relevant transaction 910-related elements, such as the pre-transaction information 912 and the at least one number 914, and associated said relevant elements to the transaction 910, the requester 902 thereby provides the transaction 910 to at least one node 906a-d part of the blockchain 916 using the network 904.

In at least one embodiment, at least one of the at least one number 908a-d is associated with at least one signature and/or co-signature from at least one respective involved entity, such as a requester, a partner, a generator, a enforcer, any other relevant role, a given wallet associated with a given involved computing node, a proxy node and/or the like. In at least one embodiment, said at least one signature and/or co-signature comprises at least one signature and/or co-signature from at least one given partner involved in a given generating of at least one given number 908a-d. In at least one embodiment, a given public key, such as one associated with a given wallet, associated with the requester 902 and/or at least one of the nodes 906a-d, or a respective wallet thereof, is provided to at least one node part of the blockchain 916. In at least one embodiment, the transaction 910 also comprises at least one signature and/or co-signature, for instance a signature of the requester and/or a plurality of requesters contributing to a generating of said transaction 910.

The skilled addressee will appreciate that the system 900 depicted in FIG. 9 is decentralized, i.e., at least one of the involved node 902, 906a-d therein stores in its memory data part of the blockchain 916 and thereby generally possess a same authority as at least one other node 902, 906a-d for at least one common feature of the system. The skilled addressee will appreciate that, in at least one embodiment, at least one of the node 902, 906a-d is subject to slashes and/or penalizations, such as slashes and/or penalizations described in at least one embodiment of the FIG. 3. In at least one embodiment, a node 902, 906a-d first delegates to at least one other node and/or entity part of the blockchain a storing of pre-transaction information and/or a generating of a given transaction comprising at least a portion of the delegated pre-transaction information. In at least one embodiment, the first delegating further comprises a delegating of storage of at least one previous block part of the blockchain. In at least one embodiment, the first delegating further comprises storing by at least one of the delegating node and at least one other witness node at least one delegating proof of at least one element involved in such delegating and/or a way of retrieving such delegated at least one element, such as storing at least one block header for delegating at least one previous block part of the blockchain and/or storing at least one transaction hash for delegating at least one transaction part of at least one portion of a delegating node's mempool and/or the like. In at least one embodiment, said at least one delegating proof comprises at least one signature and/or co-signature, such as a signature of the delegating node, at least one co-signature of at least one witness node and/or the like. In at least one embodiment, a delegating also comprises delegating a blockchain-related action, such as a blockchain-related action enabled by a given role, such as acting as a partner, to the at least one other node and/or entity part of the blockchain. The skilled addressee will appreciate that a delegating allows a delegating node to continue a participating in at least one type of at least one activity without, for instance, the delegating node currently having an active network connection. In at least one embodiment, said at least one entity comprises a specialized physical device configured to perform a given delegated process, such as a blockchain-related action, and/or storage, such as a storage of at least one transaction and/or a storage of at least one previous block. In at least one embodiment, a delegating involves reducing and/or removing at least one future reward and/or compensation concerning the delegating node, such as block-related rewards and/or compensations and/or transaction fees-related rewards and/or compensations. In at least one embodiment where a given delegating node wants to act as a generator, an enforcer, a partner and/or any other relevant role, the delegating node would request access to at least one portion of at least one delegated transaction and/or delegated element, such as at least one previous block. In at least one embodiment, a delegating involves a given node to first receive at least one transaction in at least one portion of its mempool, process the received transaction, such as by associating at least one signature and, optionally, a timestamp and/or block number associated with the receiving of the at least one transaction and providing it to at least one entity part of the blockchain, such as a node, storing such at least one transaction. The skilled addressee will appreciate that a similar process, although slightly altered, as the previous at least one embodiment may be used for various delegating, such as a delegating of previous block storage and/or a delegating of at least one blockchain-related action, such as a blockchain-related action enabled by a given role.

In at least one embodiment, the system 900 involves a sharding technique, which determines nodes into distinct subsets (hereinafter referred to as shards). The skilled addressee will appreciate that, in at least one embodiment, a shard is associated with a determined quantity of at least one node, wherein a validity of at least one generating transaction and/or block is determined according to at least one criterion and/or rule, such as at least one partner and/or any first other relevant role to be associated with said at least one transaction must be associated with a different shard than at least one requester and/or any second other relevant role involved in said at least one transaction, or, in at least one other embodiment, in a same shard thereof, and/or such as at least one enforcer and/or any third other relevant role to be associated with said at least one block must be associated with a different shard than at least one generator and/or any fourth other relevant role involved in said at least one block, or, in at least one other embodiment, in a same shard thereof, and/or the like.

In at least one embodiment where the system is less decentralized, an additional authority part of the blockchain 916 is associated to at least one additional smart contract, a system manager, a server, a computing node, a processing device and/or a software, such as an authority granting an entity a right to enable, such as start, at least one specific poll type and/or the like. It will thus be appreciated that the nature of the system 900 may be provided in various forms.

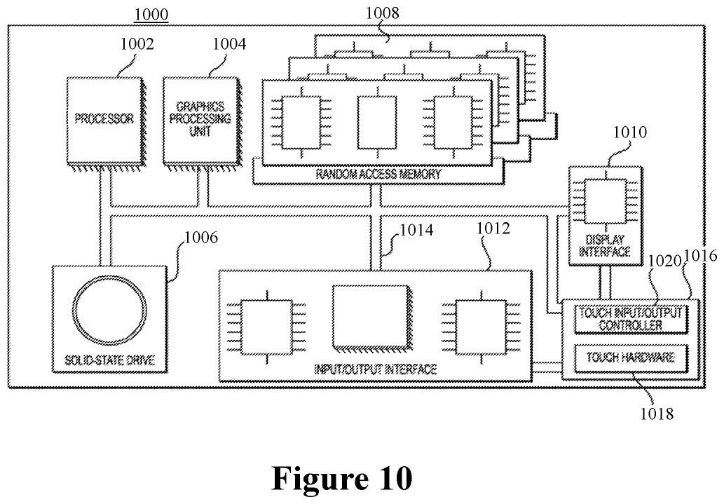

FIG. 10 is a schematic diagram illustrating an electronic device 1000 which may be used in accordance with one or more non-limiting embodiments of the present technology.

Referring to FIG. 10, there is shown an electronic device 1000 suitable for use with at least one implementation of the present technology, the electronic device 1000 comprising various hardware components including one or more single or multi-core processors collectively represented by processor 1002, a graphics processing unit (GPU) 1004, a storage drive such as a solid-state drive 1006, a random-access memory 1008, a display interface 1010, and an input/output interface 1012.

Communication between the various components of the electronic device 1000 may be enabled by one or more internal and/or external buses 1014, such as a PCI bus, universal serial bus, IEEE 1394 “Firewire” bus, SCSI bus, Serial-ATA bus, and/or the like, to which the various hardware components are electronically coupled.

The input/output interface 1012 may be coupled to a touchscreen 1016 and/or to the one or more internal and/or external buses 1014. The touchscreen 1016 may be portion of the display. In at least one embodiment, the touchscreen 1016 is the display. The touchscreen 1016 may equally be referred to as a screen 1016. In the embodiments illustrated in FIG. 1, the touchscreen 1016 comprises touch hardware 1018 (e.g., pressure-sensitive cells embedded in a layer of a display allowing detection of a physical interaction between a user and the display) and a touch input/output controller 1020 allowing communication with the display interface 1010 and/or the one or more internal and/or external buses 1014. In at least one embodiment, the input/output interface 1012 may be connected to a keyboard (not shown), a mouse (not shown) and/or a trackpad (not shown) allowing the user to interact with the electronic device 1000 in addition or in replacement of the touchscreen 1016.

According to implementations of the present technology, the solid-state drive 1006 stores machine readable instructions suitable for being loaded into the random-access memory 1008 and executed by the processor 1002 and/or the GPU 1004 for a blockchain. For example, the program instructions may be a portion of a library and/or an application.

The electronic device 1000 may be implemented as a server, a desktop computer, a laptop computer, a tablet, a smartphone, a given, or a plurality thereof, device comprising and/or being a device capable of executing computer interpretable instructions, such as an ARDUINO©, a personal digital assistant and/or any device that may be configured to implement the present technology, as it may be understood by a person skilled in the art.

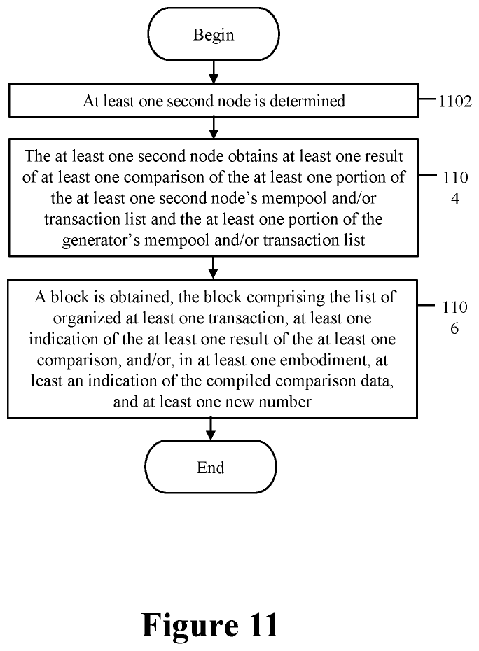

FIG. 11 is a flowchart illustrating an embodiment of a method for generating a block of a blockchain, in accordance with at least one embodiment. To generate a block using the present technology, a first node (hereinafter referred to as a generator), according to at least one criterion, such as a criterion being determined as having a relevant quantity of at least one transaction in at least one portion of its mempool, emits a blockchain-related event indicating a need for at least one second node (hereinafter referred to as an enforcer) to compare at least one portion of at least one transaction comprised in at least one portion of its mempool and/or transaction list with at least one portion of the at least one transaction comprised in at least one portion of the at least one second node's mempool and/or transaction list. In at least one embodiment, a plurality of first nodes is involved in the generating of the block instead of a single first node, for instance by contributing and/or processing different part of block-related data and/or reprocessing and/or approving block-related data, such as by providing at least one signature and/or co-signature.

According to processing step 1102, at least one second node (hereinafter referred to as enforcer) is determined. In at least one embodiment, the at least one second node searches for a given emitted blockchain-related event, such as said emitted blockchain-related event by the first node, amongst at least one portion of at least one entity, such as generator(s), part of the blockchain. In at least one embodiment, at least one second node selects the first node according to at least one criterion, such as said emitted blockchain-related event, at least one reliability metric value associated with said first node, or associated wallet thereof, and/or the like. In at least one embodiment where a plurality of second nodes selects the first node. In at least one embodiment, the first node determines, according to at least one criterion, at least one portion of at least one selecting second node to involve in the generating of the block. In at least one embodiment, a smart contract, a system manager, a server, a computing node, a processing device and/or a software enables a determining of at least one second node, or plurality thereof. In at least one embodiment, the first node determines if at least one second node is suitable to be involved in said block generating according to at least one criterion, such as at least one reliability metric value associated with said at least one second node, or associated wallet thereof, a determined amount of time that elapsed in relation to a given blockchain-related event, such as a generating of at least one previous and/or current block and/or the like. In at least one embodiment, at least one portion of the generator's mempool and/or transaction list and/or at least one portion of the at least one second node's mempool and/or transaction list is organized prior, and/or after in at least one second embodiment, the determining of the at least one second node.

The skilled addressee will appreciate that the determining of the at least one second node can be provided in various forms, according to at least one embodiment, such as the aforementioned selection processes, such as at least one embodiment of FIG. 4.

According to processing step 1104, the at least one second node obtains at least one result of at least one comparison of the at least one portion of the at least one second node's mempool and/or transaction list and the at least one portion of the generator's mempool and/or transaction list. In at least one embodiment, compiled comparison data is also obtained, said compiled comparison data comprising at least one result of said at least one comparison. The skilled addressee will appreciate that the at least one portion of the at least one second node's mempool and/or transaction list may contain at least one additional transaction which is not comprised in the at least one portion of the first node's mempool and/or transaction list, and vice versa. The skilled addressee will appreciate that the at least one comparison and the at least one result of the at least one comparison can be provided in various forms, according to at least one embodiment, such as at least one embodiment of FIG. 1 and, in at least one embodiment, such as at least one embodiment of FIG. 5.

According to processing step 1106, a block is obtained, the block comprising the list of organized at least one transaction, at least one indication of the at least one result of the at least one comparison, and/or, in at least one embodiment, at least an indication of the compiled comparison data, and at least one new number, such as a number associated with an identifier of the first node, or associated wallet thereof, and a number associated with a previous and/or current block part of the blockchain. In at least one embodiment, the block is obtained by the at least one second node using data provided by the first node prior said obtaining of the block.

The skilled addressee will appreciate that the compiled comparison data may be used differently and be provided in various forms, according to at least one embodiment. In at least one embodiment, the compiled comparison data is stored in the block. In at least one embodiment, data resulting from the at least one comparison and/or data comprised in the compiled comparison data is stored off-chain, for instance by using a second layer architecture and/or a storage system such as InterPlanetary File System (IPFS). The skilled addressee will also appreciate that a given result of a given comparison and/or given compiled comparison data may be provided in a form of at least one indication thereof or said raw given result thereof.

In at least one embodiment, at least one of the at least one second node and the first node, or associated wallet thereof, is considered to be reliable. The skilled addressee will appreciate that the reliability can be provided in various forms, according to at least one embodiment, such as at least one embodiment of FIG. 3.

The skilled addressee will appreciate that the embodiment, or a plurality thereof, presented in FIG. 11 corresponds to a broader embodiment, or a plurality thereof, of a method for generating a block of a blockchain than the embodiment, or a plurality thereof, presented in FIG. 1.

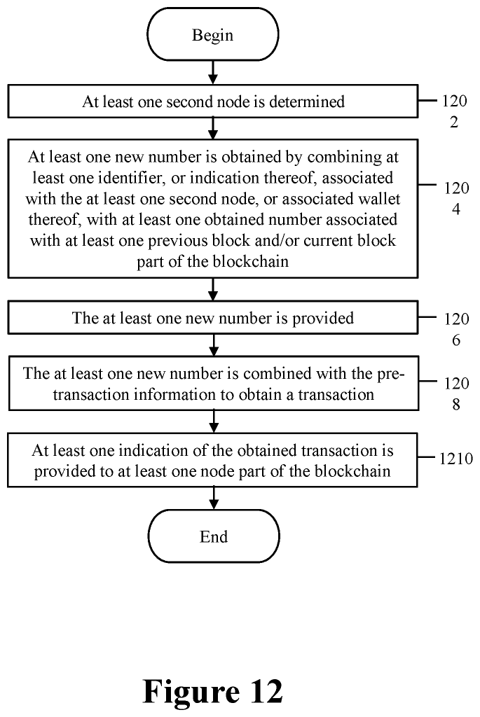

FIG. 12 is a flowchart illustrating an embodiment of a method for generating a transaction to be comprised in a block, in accordance with at least one embodiment. The method is processed by a first node (hereinafter referred to as requester).

According to processing step 1202, at least one second node (hereinafter referred to as partner) is determined. In at least one embodiment, the at least one second node searches for a given emitted blockchain-related event, such as said emitted blockchain-related event by the first node, amongst at least one portion of at least one entity, such as requester(s), part of the blockchain. In at least one embodiment, at least one second node selects the first node according to at least one criterion, such as said emitted blockchain-related event, at least one reliability metric value associated with said first node, or associated wallet thereof, and/or the like. In at least one embodiment where a plurality of second nodes selects the first node. In at least one embodiment, the first node determines, according to at least one criterion, at least one portion of at least one selecting second node to involve in the generating of the transaction. In at least one embodiment, a smart contract, a system manager, a server, a computing node, a processing device and/or a software enables a determining of at least one second node, or plurality thereof. In at least one embodiment, the first node determines if at least one second node is suitable to be involved in said block generating according to at least one criterion, such as at least one reliability metric value associated with said at least one second node, or associated wallet thereof, a determined amount of time that elapsed in relation to a given blockchain-related event, such as a generating of at least one previous and/or current block and/or the like. In at least one embodiment, at least one pre-transaction information is obtained prior and/or after and/or during the determining of the at least one second node. In at least one embodiment, a processing of at least one portion of said pre-transaction information, or the at least one portion thereof, enables said determining, such as by, in at least one embodiment, evaluating a comparison between at least two time measures, such as timestamps. The skilled addressee will appreciate that an obtaining of the pre-transaction information and the pre-transaction information itself can be provided in various forms, according to at least one embodiment, such as at least one embodiment of FIG. 7. In at least one embodiment, at least one first time measure is provided by the first computing node prior said determining and at least one second time measure is provided by at least one given second node upon an interaction of at least one of said at least one given second node with the first node, and an enabling of the determining is enabled by an evaluation of a difference between the at least two time measures. In at least one embodiment, at least one time measure is provided, and in at least one embodiment evaluated, upon an interaction involving a plurality of second nodes. In at least one embodiment, at least one time measure is provided by at least one second node prior an interacting between said at least one node, a second at least one second node and the first node, such as with a periodic executing process. In at least one embodiment, a given time measure comprises a number of at least one block generated upon an obtaining thereof. In at least one embodiment, a combination of multiple time measures is used, such as both two numbers of at least one block and two timestamps, and an enabling of the determining is enabled by a comparing of a plurality of differences obtained from an evaluation of a plurality of time measures, such as by establishing if said plurality of differences corresponds to at least one similarity threshold. In at least one embodiment, said at least one similarity threshold comprises a maximum difference threshold between two corresponding time measures involved in an evaluation, a maximum similarity threshold between two time measure differences, and/or the like. In at least one embodiment, at least one given time measure involves at least one signature and/or co-signature, such as by at least one given entity obtaining said at least one time measure.

The skilled addressee will appreciate that the determining of the at least one second node can be provided in various forms, according to at least one embodiment, such as the aforementioned selection processes, such as at least one embodiment of FIG. 8.

According to processing step 1204, at least one new number is obtained by combining at least one identifier, or indication thereof, associated with the at least one second node, or associated wallet thereof, with at least one obtained number associated with at least one previous block and/or current block part of the blockchain. In at least one embodiment, at least one time measure is obtained, such as derived, using at least one given number associated with at least one of the first computing node and the at least one second node. In at least one embodiment, a given time measure obtained using a given number corresponds to a number, or identifier thereof, of at least one block. The skilled addressee will appreciate that an obtaining and/or providing and/or storing of the at least one number and the at least one number itself can be provided in various forms, according to at least one embodiment, such as at least one embodiment of FIG. 7 and the above-mentioned embodiments of FIG. 8. In at least one embodiment, at least one time measure and/or at least one time measure difference and/or any relevant data enabling at least one time measure related process, such as the at least one number, is comprised in the transaction.

According to processing step 1206, the at least one new number is provided. In at least one embodiment, the at least one second node is providing the at least one new number to the first node. In at least one embodiment, at least one given node of the at last one second node is providing the at least one number to at least one other given node of the at least one second node.

According to processing step 1208, the at least one new number is combined with the pre-transaction information to obtain a transaction. In at least one embodiment, at least one given second node of the at least one second node is processing said combining. In at least one embodiment, the transaction is obtained by the at least one second node from transaction-related data, such as pre-transaction information, obtained prior hand.

According to processing step 1210, at least one indication of the obtained transaction is provided to at least one node part of the blockchain. In at least one embodiment, the at least one indication of the obtained transaction is the obtained transaction. In at least one embodiment, at least one portion of transaction-related data is stored in said obtained transaction. In at least one embodiment, said obtained transaction will typically be stored in a block of the blockchain, given that said obtained transaction is determined valid by at least one node part of the blockchain. In at least one embodiment, at least one portion of data comprised in the obtained transaction is stored off-chain, for instance by using a second layer architecture and/or a storage system such as InterPlanetary File System (IPFS). The skilled addressee will appreciate that the obtained transaction and/or pre-transaction information and/or data comprised in the transaction thereof may be provided in a form of at least one indication thereof or in a raw form thereof. In another embodiment, the at least one indication of the obtained transaction is at least one number and/or series of characters and/or identifier identifying the obtained transaction, such as a Uniform Resource Locator (URL).

The skilled addressee will appreciate that the combining of processing step 1204, the providing of processing step 1206, the combining of processing step 1208 and the providing of step 1210 can be provided in various forms, according to at least one embodiment, such as the embodiment of FIG. 7 or FIG. 8. For instance, in at least one embodiment corresponding to processing step 1204, the combining involves a concatenating of the at least one first identifier with the at least one obtained number from at least one previous and/or current block of the blockchain, hashing a result of the concatenating, and reducing a result of the hashing to a single number.

In at least one embodiment, at least one of the at least one second node, the first node and the at least one other node, or associated wallet thereof, is considered to be reliable. The skilled addressee will appreciate that the reliability can be provided in various forms, according to at least one embodiment, such as at least one embodiment of FIG. 3.

The skilled addressee will appreciate that the embodiment, or a plurality thereof, presented in FIG. 12 corresponds to a broader embodiment, or a plurality thereof, of a method for generating a transaction than the embodiment, or a plurality thereof, presented in FIG. 7.

The skilled addressee will appreciate that the embodiment presented in FIG. 12 may be broader, and may consist of a method in which a first node obtains at least one new number by combining at least one identifier associated with said first node, or associated wallet thereof, with at least one obtained number associated with at least one previous block and/or current block part of the blockchain, combines an pre-transaction information with at least one indication of the obtained new number to obtain a transaction and provides at least one indication of the obtained transaction to at least one node part of the blockchain. In at least one embodiment, said providing involves at least one second node associating at least one second number with the obtained transaction prior at least one of said at least one second node providing the newly-obtained obtained transaction to at least one node part of the blockchain.

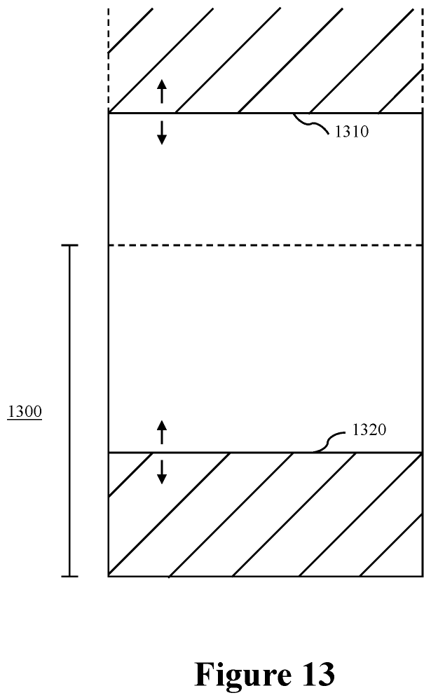

FIG. 13 is a schematic diagram illustrating an embodiment of at least one part of a structure of a block, in accordance with at least one embodiment.

Now referring to FIG. 13, there is shown an exemplary embodiment of a block associated with an adjustable block size 1300, said adjustable block size 1300 being a number associated with a quantity of at least one transaction, or indication thereof, comprised in said block. In at least one embodiment, the adjustable block size 1300 corresponds to at least one threshold. In at least one embodiment, the corresponding involves a numerical result obtained from a combining of at least one portion of the at least one transaction, or indication thereof, comprised in said block being over or over or equal to a first threshold, such as the minimum transaction threshold 1320, and, in at least one embodiment, under or under or equal to a second threshold, such as the maximum transaction threshold 1310.

The skilled addressee will appreciate that prior art blockchains are known to usually use a fixed data quantity limit for their blocks. Doing so ensures a relative decentralization. Thus, because blocks of prior art blockchains typically maintain a fixed data quantity limit, a block in prior art blockchains may comprise both a part of transaction-related data and/or any other type of data desirable to comprise therein and, in some cases, a part of data unrelated to any desirable data type, such as transactional data, which may often be categorized as “filler” data. Some prior art blockchains (e.g. Monero) enable to alter a given data quantity limit of a given block by having at least one specific drawback which differs from the technology presented herein. The skilled addressee will appreciate that the larger a fixed data quantity limit is, the more demanding a given evaluating and/or generating and/or providing and/or obtaining and/or processing of a given block often is, and high-performance hardware is thereby often required to make the process fast and efficient. The skilled addressee will appreciate that since high performance hardware is generally expensive and limited, thereby making it inaccessible to some individuals, such as unprivileged individuals, a data quantity limit is often directly correlated with centralization of the blockchain toward stronger computing nodes. On the other hand, a smaller fixed data quantity limit often limits a scalability aspect of a given blockchain. Oftentimes, prior art blockchains select the fixed data quantity to find equilibrium between maximizing decentralization and minimizing scalability. Yet, such fixed data quantity presents drawbacks, such as drawbacks brought in during and as a result of multiple heated Bitcoin™ debates about block sizes, that the present technology can overcome.

In at least one embodiment, the maximum transaction threshold 1310 corresponds to a maximum value of a combination of at least one number associated with at least one transaction associated with a given block. The skilled addressee will appreciate that the at least one number can be provided in various forms, according to at least one embodiment, such as at least one embodiment of FIG. 8. In at least one embodiment, at least one given node generating a block may be prevented from further associating at least one transaction with said block once the adjustable block size 1300 exceed, or in at least one embodiment equal, the maximum transaction threshold 1310. In at least one embodiment, at least one given node is not allowed to generate a block if a combination of at least one transaction to be associated with said block would result in the adjustable block size 1300 to exceed, or in at least one embodiment equal, the maximum transaction threshold 1310. In at least one embodiment, a node is not restricted by the maximum transaction threshold 1310 when generating a block, but instead may be subject to an enabling and/or a consequence according to at least one criterion, blockchain-related event, condition and/or blockchain-related activity, which may involve a reliability metric value and/or a relevant role associated with said node, or associated wallet thereof, such as a consequence according to at least one criterion and/or blockchain-related event involving exceeding a given transaction(s) number(s) combination threshold determined using a reliability metric value associated with said node, or associated wallet thereof, for a given block. In at least one embodiment, a given value of a given transaction(s) number(s) combination threshold is a parameter part of the blockchain.

In at least one embodiment, a block may be associated with the minimum transaction threshold 1320. In at least one embodiment, the minimum transaction threshold 1320 corresponds to a minimum value associated with a combination of at least one number associated with at least one transaction, or indication thereof, comprised in a given block. The skilled addressee will appreciate that the at least one number can be provided in various forms, according to at least one embodiment, such as at least one embodiment of FIG. 8. In at least one embodiment, an enabling of a generating of a block involves a corresponding of a combination of at least one transaction with the minimum transaction threshold 1320. In at least one embodiment, a given node is not restricted by the minimum transaction threshold 1320 when generating a block, but instead may be subject to an enabling and/or a consequence according to at least one criterion, blockchain-related event, condition and/or blockchain-related activity, which may involve a reliability metric value and/or a relevant role associated with said node, or associated wallet thereof, such as a consequence according to at least one criterion and/or blockchain-related event, such as failing to meet a given transaction(s) number(s) combination threshold determined using a reliability metric value associated with said node, or associated wallet thereof, for a given block.

In at least one embodiment, upon at least attempting to generate a block, a given node is at least one of prohibited to generate said block and penalized according to at least one criterion, such as a criterion involving the adjustable block size 1300 not corresponding to the at least one threshold. In at least one embodiment, if said given node does not respect at least one first criterion from the at least one criterion, said node is required and/or given an option to respect at least one second criterion and if, in at least one embodiment, said node does not respect the at least one second criterion, said node is prohibited to generate said block and/or penalized thereof. In at least one embodiment, a successful corresponding involves the adjustable block size 1300 at least meeting a first transaction(s) number(s) combination threshold, such as the minimum transaction threshold 1320, and/or at least not exceeding a second transaction(s) number(s) combination threshold, such as the maximum transaction threshold 1310. In at least one embodiment, the penalizing involves said given node being required to either send at least one asset to at least one other node and/or lose, such as by using a blockchain-related “burn” mechanism, at least one portion of said at least one asset. In at least one embodiment, an amount of at least one asset to send and/or a size of the portion of the at least one asset to lose is directly correlated with a similarity between at least one of the at least one threshold and the adjustable block size 1300. For instance, in at least one embodiment, the amount of at least one asset to send and/or the size of the portion of the at least one asset to lose increases the closer, or farther in at least one embodiment, the adjustable block size 1300 is to the maximum transaction threshold 1310 and/or the minimum transaction threshold 1320. In at least one embodiment, the at least one criterion comprises a reliability metric value associated with said node, or associated wallet thereof, for a given block.

In at least one embodiment, no asset is required to send and/or lose according to at least one criterion, such as if a reliability metric value associated with a concerned node, or associated wallet thereof, is above, or in at least one embodiment equal to, a certain threshold even if the adjustable block size 1300 is lower than, or in at least one embodiment lower or equal to, the minimum transaction threshold 1320 and/or greater, or in at least one embodiment greater or equal to, the maximum transaction threshold 1310, and a concerned node would be subject to at least one consequence and/or penalizing, such as a negative impact on a reliability-influenced reliability metric value associated thereof, or associated wallet thereof.

In at least one embodiment, at least one entity and/or role part of the blockchain is imposed at least one different criterion than at least one other entity part of the blockchain to generate a given block and/or determine the adjustable block size 1300. For instance, in at least one embodiment, a given node, or associated wallet thereof, considered to be reliable may be authorized to, according to at least one other criterion, such as being involved in a generation of at least one other block and/or a result of a completed challenge, such as a challenge aiming at establishing a reliability of said given node, or associated wallet thereof, ignore at least one imposed block generating criterion. In at least one embodiment, at least one of the at least one threshold, such as the maximum transaction threshold 1310 and/or the minimum transaction threshold 1320, and a nature and/or a form of the adjustable block size 1300 varies according to at least one criterion, such as a result of a completed challenge, such as a challenge aiming at establishing a reliability of a given node, or associated wallet thereof, an authority of a given node, at least one given transaction type associated with at least one transaction to associate and/or associated with said block, a rate of at least one type of at least one blockchain-related activity obtained from at least one node part of the blockchain and/or the like. The skilled addressee will appreciate that the reliability can be provided in various forms, according to at least one embodiment, such as at least one embodiment of FIG. 3.

In at least one embodiment, the combination of at least one number corresponds to one operation, such as a sum, a multiplication, a concatenation and/or the like, and/or a combination thereof. In at least one embodiment, at least one first number associated to a first transaction has more impact on a result of the combination of the at least one number than at least one second number associated to a second transaction in relation to at least one criterion, such as a blockchain parameter, at least one reliability metric value and/or reliability metric, or combination thereof, associated with at least one given node, or associated wallet thereof, involved thereof, at least one reliability metric value and/or reliability metric, or combination thereof, associated with at least one given node, or associated wallet thereof, involved in a block, said block being associated thereof, a result of a processing, such as an evaluating of at least one concerned transaction and/or a block being associated thereof by at least one other entity part of the blockchain, a given type of transaction associated thereof, at least one asset involved in a transfer comprised thereof, at least one rule and/or the like.

In at least one embodiment, at least one of the maximum transaction threshold 1310 and the minimum transaction threshold 1320 can be adjusted in response to at least one events and/or criterion, such as a poll enabled, such as started, by a given entity having such authority, said authority being, in at least one embodiment, granted by at least one entity and/or machine readable instruction part of the blockchain, at least one given role, a rate of at least one type of at least one blockchain-related activity, an update enabled by a given entity having such authority, at least one rule, a result of a completed challenge, such as a challenge aiming at establishing a reliability of a given node, or associated wallet thereof, and/or the like.

In at least one embodiment, the maximum transaction threshold 1310 and/or the minimum transaction threshold 1320 can be adjusted by at least one machine readable instruction part of the blockchain in relation to at least one blockchain-related activity, such as an increase and/or decrease of a number of at least one active entity, such as a node, part of the blockchain, an increase and/or decrease in a rate of at least one generating and/or generated transaction, a vote involving at least one authorized node, or associated wallet thereof and/or the like.

In at least one embodiment, at least one first node part of the blockchain associated with a reliability metric value corresponding to at least one given threshold and/or at least first node part of the blockchain selected by a smart contract, a system manager, a server, a computing node, a processing device and/or a software may adjust the maximum transaction threshold 1310 and/or the minimum transaction threshold 1320 in relation to at least one criterion, such as a determined quantity of at least one vote from at least one entity part of the blockchain, and, in at least one embodiment, relevant data, such as at least one rate of at least one type of at least one blockchain-related activity obtained from at least one other entity part of the blockchain and/or said at least one node, at least one identifier associated with at least one other entity part of the blockchain and/or said at least one node and/or the like. In at least one embodiment, at least one entity, such as a node, part of the blockchain and/or at least one machine readable instruction part of the blockchain may adjust reliability metric value(s) associated with and/or determine punishment(s) and/or determine reward(s) and/or determine compensation(s) to at least one other node, or associated wallet thereof, part of the blockchain in relation to at least one criterion, such as a behavior and/or at least one vote of at least one given node and/or the like. In at least one embodiment, said at least one entity is authorized to filter at least one type of blockchain-related activity it considers potentially malicious, such as transaction(s). In at least one embodiment, said potentially malicious behavior is determined in relation to at least one rule part of the blockchain. The skilled addressee will appreciate that the at least one rule can be provided in various forms, according to at least one embodiment, such as at least one embodiment of FIG. 3.

The skilled addressee will appreciate that a centralization aspect of the blockchain may be affected by a variation of the at least one threshold, such as the maximum transaction threshold 1310 and/or the minimum transaction threshold 1320. More precisely, as a first example, when the minimum transaction threshold 1320 increases significantly, at least one node with less available computational resources than at least one other node part of the blockchain may struggle, i.e. be at a disadvantage, compared to the at least one other node in relation to the minimum transaction threshold 1320. Similarly, as a second example, when the maximum transaction threshold 1310 decreases significantly, at least one node with more available computational resources than at least one other node part of the blockchain may be limited in a block generation and/or processing capacity compared to the at least one other node in relation to the maximum transaction threshold 1310. Similarly, as a third example, when the maximum transaction threshold 1310 increases significantly, at least one node with less available computational resources than at least one other node part of the blockchain may struggle, i.e. be at a disadvantage, as the at least one other node may generate block(s) which exceed their computational limit thereof.

In at least one embodiment, at least one of the maximum transaction threshold 1310 and the minimum transaction threshold 1320 may be adjusted by at least one machine readable instruction and/or entity, such as a node, or associated wallet thereof, considered to be reliable and/or system manager and/or smart contract and/or the like, part of the blockchain to lower the centralization of the blockchain despite at least one provided at least one other blockchain-related activity indicating otherwise, such as at least one vote involving at least one voting computing node, such as a poll, in response to a centralization aspect degree crossing a determined value. The skilled addressee will appreciate that the reliability can be provided in various forms, according to at least one embodiment, such as at least one embodiment of FIG. 3.

In at least one embodiment, an adjustment of at least one of the at least one threshold, such as the maximum transaction threshold 1310 and/or the minimum transaction threshold 1320, may be either permanent or temporary, according to at least one embodiment and/or at least one criterion. For instance, in at least one embodiment, the maximum transaction threshold 1310 and/or the minimum transaction threshold 1320 may be adjusted in response to a significant increase and/or decrease in a rate of at least one type of at least one blockchain-related activity and/or to a variation in a number of at least one active node and/or to a variation in a rate of at least one type of transaction and/or the like, but only, in at least one embodiment, for a given period of time and/or given number of at least one block and/or until the blockchain has reached a determined rate of at least one type of at least one blockchain-related activity. The skilled addressee will appreciate that various other criteria may be used instead, in at least one embodiment. In at least one embodiment, the maximum transaction threshold 1310 and/or the minimum transaction threshold 1320 may be adjusted in only one direction (i.e., only decreased and/or increased) until reaching a first determined value, at what point the maximum transaction threshold 1310 and/or the minimum threshold value may be adjusted in relation to one or more determined or undetermined value. In at least one embodiment, said first determined value is a parameter part of the blockchain.

The skilled addressee will appreciate that, in at least one embodiment, the adjustable block size 1300 in the present technology is enabled by at least one reliability metric value associated with at least one node, or associated wallet thereof, part of the blockchain as well as by an evaluation of at least one blockchain-related activity metric described in the above-mentioned embodiment(s), such as a generation rate of at least one type of transaction. In fact, for prior art blockchains that do not generate and process block(s) in relation to at least one embodiment of the present technology and/or do not implement at least one node-related, or wallet-related thereof, reliability metric, such as described in the above-mentioned embodiment(s) of FIG. 3 and/or do not impose at least one limitation, such as a reliability metric value penalizing and/or slashes, and/or other evaluation method in relation to data obtained from at least one block and/or entity, such as a node and/or system manager, part of the blockchain and/or a very reliable number association mechanism for at least one transaction type in relation to at least one embodiment of the present technology, it would be impractical, or even impossible, to implement the presented adjustable block size 1300, as it may enable a possibility of performing at least one devastating malicious attack known by the skilled addressee, such as severely limiting a rate of confirmation of new transaction(s) by preventing a large portion of node(s) part a blockchain to process at least one generating and/or generated block.

In at least one embodiment, the at least one threshold may be determined in relation with various factors, such as at least one vote involving at least one voting computing node, such as a poll, enabled by at least one entity part of the blockchain, an average reliability metric value associated with at least one node, or associated wallet thereof, comprised in a given subset of a given reliability metric value distribution, a generation rate of at least one type of transaction, a time-related metric rate established using a plurality of confirmations of transactions and/or the like.

The skilled addressee will appreciate that, since a determining of an adjustable block size 1300 and/or at least one threshold, such as the maximum transaction threshold 1310 and/or the minimum transaction threshold 1320, must respect at least one strict criterion and/or established rule as described in the above-mentioned embodiment(s), an attempt to temper with the adjustable block size 1300 and/or the at least one threshold would most likely be identified and countered.

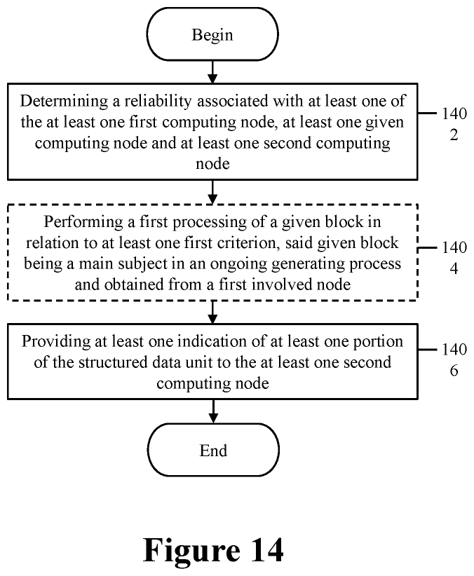

FIG. 14 is a flowchart illustrating an embodiment of a method for processing a structured data unit related to a distributed ledger enabled system, in accordance with at least one embodiment, such as at least one corresponding embodiment mentioned and presented above.

According to processing step 1402, at least one of at least one first computing node and a given computing node, or associated wallet thereof, is determined to be reliable. The skilled addressee will appreciate that, in at least one embodiment, at least one of the at least one first computing node and/or the computing node is subject to slashes and/or penalizations, such as slashes and/or penalizations described in at least one embodiment of the FIG. 3, according to at least one criterion, such as an evaluating of at least one blockchain-related action and/or behavior involving the at least one first computing node and/or the given computing node, wherein said evaluating and/or behavior is thereby often associated with said reliability of the at least one first computing node and/or the given computing node. The skilled addressee will also appreciate that the reliability can be provided in various forms, according to at least one embodiment, such as at least one embodiment of FIG. 3.

According to optional processing step 1404, at least one given node of the at least one first computing node, being involved in an ongoing generating process involving a generator, performs a first processing of a given block in relation to at least one first criterion, such as a result of a completed challenge, such as a challenge aiming at establishing a first reliability of said at least one given node, or associated wallet thereof, said given block being a main subject in the ongoing generating process and obtained from a first involved node, then providing it, according to processing step 1406 described below, to at least one other entity part of the blockchain, such as another entity involved and/or to involve in the ongoing generating process, part of the blockchain. In at least one embodiment, the reliability determining is enabled in accordance to at least one given criterion, such as a number of at least one time said at least one given node participated in a generating process of a block involving a given other computing node involved/to be involved in the ongoing generation process, a number of at least one node involved/to be involved in the generating process, and/or the like.

The skilled addressee will appreciate that step 1402 may be processed at different stage(s) in the ongoing generating process instead of, or in compliment thereof, prior step 1404, according to at least one embodiment.

In at least one embodiment, the first processing involves, according to at least one second criterion, performing at least one first blockchain-related action, such as a removing, adding and/or updating, on at least one portion of data associated with said given block. In at least one embodiment, the at least one second criterion comprises at least one transaction type of at least one transaction associated with the given block. In at least one embodiment, the at least one first blockchain-related action comprises removing potentially malicious data and/or at least one transaction based on its at least one associated number and/or adding and/or updating at least one transaction and/or a signature and/or co-signature.

In at least one embodiment, said first processing involves, according to at least one third criterion, an enabling of at least one processing step and/or a disabling of at least one processing step of the ongoing generating process. In at least one embodiment, the at least one third criterion involves an evaluating and/or validating of at least one portion of said given block, such as determining if the given block comprises malicious data and/or the data comprised in said at least one portion of said given block does not respect at least one fourth block generation criterion, such as an ordering of at least one portion of at least one transaction type of at least one transaction comprised therein. In at least one embodiment, a nature and/or scope and/or form of a given processing step enabled based on the at least one third criterion is determined and/or adjusted according to at least one blockchain-related event and/or criterion, such as a given blockchain-related action enabled by an enforcer involved in the ongoing generating process, a given first processing by at least one given node involved in said ongoing generating process, a result of a completed challenge, such as a challenge aiming at establishing a reliability of at least one given node, such as the given computing node and/or at least one other node of the at least one first computing node, or associated wallet thereof.

According to processing step 1406, at least one indication of at least one portion of the given block is provided to a second computing node. In at least one embodiment, the providing involves at least one second node, such as the given computing node, the at least one second node acting as an intermediate between the at least one given node and the second computing node. In at least one embodiment, the at least one given node, by performing said first processing, finishes the ongoing generating process. In at least one embodiment where the second computing node would perform a first processing, an entirety of the at least one portion of the given block consists of data to process in said first processing. In at least one embodiment, the at least one indication is the at least one portion of the given block. In at least one embodiment, the at least one indication allows the second computing node to obtain the at least one portion of the given block, such as when the at least one indication consists of at least one identifier associated with at least one transaction, said at least one transaction being associated with the at least one portion of the given block. The skilled addressee will appreciate that a first processing, in at least one embodiment, implies that the at least one portion of the given block may differ from the original given block.

In at least one embodiment, the processing further comprises determining that the second computing node, or associated wallet thereof, is reliable, such as a similar determining than the determining at processing step 1402.

The skilled addressee will appreciate that the generating process can be provided in various forms, according to at least one embodiment, such as at least one embodiment of FIG. 1 and/or FIG. 11.

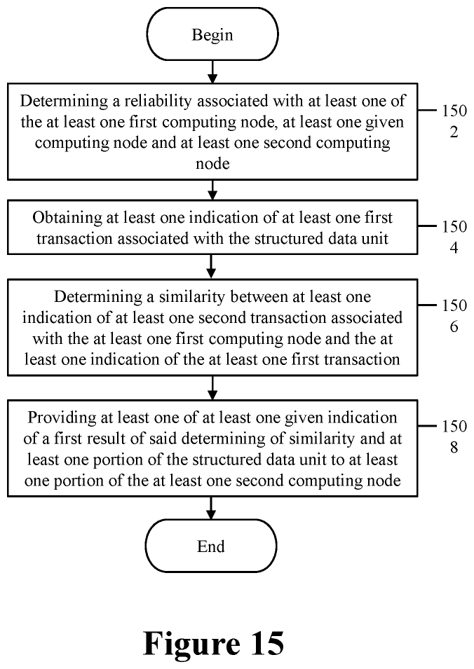

FIG. 15 is a flowchart illustrating an embodiment of a method for validating at least one portion of a distributed ledger enabled system's structured data unit, in accordance with at least one embodiment, such as at least one corresponding embodiment mentioned and presented above.

According to processing step 1502, a reliability of at least one of at least one first computing node and a given computing node, or associated wallet thereof, is determined. The skilled addressee will appreciate that, in at least one embodiment, at least one of the at least one first computing node and/or the given computing node is subject to slashes and/or penalizations, such as slashes and/or penalizations described in at least one embodiment of the FIG. 3, according to at least one criterion, such as an evaluating of at least one blockchain-related action and/or behavior involving the at least one first computing node and/or the given computing node, wherein said evaluating and/or behavior is thereby often associated with said reliability of the at least one first computing node and/or the given computing node. The skilled addressee will also appreciate that the reliability can be provided in various forms, according to at least one embodiment, such as at least one embodiment of FIG. 3.

According to processing step 1504, at least one indication of at least one first transaction associated with the structured data unit is obtained. In at least one embodiment, said obtaining involves the second computing node, or a plurality thereof, and/or at least one given node of the at least one first computing node selecting the at least one of the at least one first computing node. In at least one embodiment, the at least one first computing node selects the second computing node. In at least one embodiment, the selecting involves using at least one reliability metric, such as a reliability metric value, associated with at least one node, or associated wallet thereof, involved in said obtaining, such as a given node being a target of said selecting. The skilled addressee will appreciate that the obtaining can be provided in various forms, according to at least one embodiment, such as at least one embodiment of FIG. 1, FIG. 11 and/or FIG. 14. The skilled addressee will appreciate that the second computing node and the at least one first transaction are both associated with at least one similar distributed ledged enabled system. In at least one embodiment, at least one of the validating and the obtaining further comprises determining that the second computing node, or associated wallet thereof, is reliable, such as a similar determining than the determining at processing step 1502.

According to processing step 1506, at similarity between at least one indication of at least one second transaction associated with the at least one first computing node and the at least one indication of the at least one first transaction is determined. In at least one embodiment, the at least one indication of the at least one second transaction is the at least one second transaction and/or the at least one indication of the at least one first transaction is the at least one first transaction. In at least one embodiment, the at least one indication of the at least one second (first) transaction allows the at least one first (second) computing node, and/or, in at least one embodiment, at least one other node, to obtain the at least one second (first) transaction. In at least one corresponding embodiment, the at least one indication of the at least one second (first) transaction consists of, or, in at least one given embodiment, comprises at least one identifier, such as a numerical identifier and/or a one-way cryptographic encryption. In at least one given embodiment, a given indication is a combination of a plurality of identifiers, a nature of the said given indication's combination being defined according to at least one first criterion, such as a reliability metric value, nature of identifier, etc. In at least one embodiment, an indication is a set of at least one machine readable instruction which enables an obtaining thereof. In at least one embodiment, a given nature of at least one given indication is enabled according to at least one criterion and/or blockchain-related event, such as a type of the transaction, a reliability metric associated with the at least one of the at least one first computing node, or associated wallet thereof, and/or the like. In at least one embodiment, said nature of the given indication's combination is defined according to a parameter part of the distributed ledger enabled system. The skilled addressee will appreciate that the comparing and the determining can be provided in various forms, according to at least one embodiment, such as at least one embodiment of FIG. 1, FIG. 5, FIG. 11 and/or FIG. 14. The skilled addressee will also appreciate that the at least one indication of the at least one second transaction and the at least one indication of the at least one first transaction can be provided in various forms, according to at least one embodiment, such as at least one embodiment of FIG. 7 and/or FIG. 12.

The skilled addressee will appreciate that step 1502 may be processed at different stage(s) in the validating of the block instead of, or in compliment thereof, prior step 1504, such as in step 1506, according to at least one embodiment.

According to processing step 1508, at least one of at least one given indication of a first result of said determining of similarity and at least one portion of the structured data unit to the at least one second computing node is provided to the second computing node. In at least one embodiment, the indication is the first result of said comparing. In at least one embodiment, the indication allows the second computing node to obtain the first result of said comparing, such as when the indication consists of at least one identifier associated with at least one portion of the first result of said comparing. The skilled addressee will appreciate that the indication can be provided in various forms, according to at least one embodiment of the present technology.

In at least one embodiment, FIG. 15 further comprises a first validating, by the at least one of at least one first computing node, at least one given portion of the structured data unit. In at least one embodiment, the first validating involves, according to at least one second criterion, performing at least one first blockchain-related action, such as a removing, adding and/or updating, on at least one portion of data associated with said given structured data unit. In at least one embodiment, the at least one second criterion comprises at least one transaction type of at least one transaction associated with the structured data unit. In at least one embodiment, the at least one first blockchain-related action comprises removing potentially malicious data and/or at least one transaction based on its at least one associated number and/or adding and/or updating at least one transaction and/or a signature and/or co-signature. In at least one embodiment, an indication of a result of said first validating is provided to the second computing node. The skilled addressee will appreciate that a given first validating, in at least one embodiment, implies that the validated at least one given portion of the structured data unit may differ from the original at least one given portion of the structured data unit.

In at least one embodiment, the obtaining, the comparing and/or the providing involves at least one other node, such as the given computing node, the at least one other node acting as an intermediate between a plurality of computing nodes involved thereof, such as the at least one of at least one first computing node and the second computing node according to the obtaining. In at least one embodiment, at least one signature and/or co-signature associated with at least one involved entity, such as a node, or associated wallet thereof, is involved in the obtaining, the comparing and/or the providing, such as at least one from the second computing node and/or at least one of the at least one other node according to the obtaining. The skilled addressee will appreciate that a given signature and/or co-signature technique can be used for various purposes and situations, and can be provided in various forms, according to at least one embodiment. It will therefore be understood that at least one given entity which would have a need to provide data to at least one other blockchain-related entity and/or storage medium in a way that at least one origin, provenance and/or an authenticity of said data would be unaltered while also preserving, in at least one embodiment, an availability aspect to at least one portion of said data typically uses, alongside, in at least one embodiment, other mechanism(s) known by the skilled addressee, at least one signature and/or co-signature to meet said need. Finally, the skilled addressee will appreciate that at least one signature and/or co-signature mentioned in a context of the present technology typically involves an asymmetric encryption algorithm.

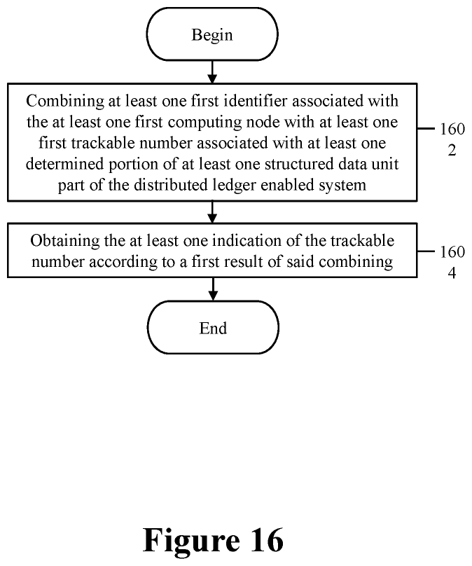

FIG. 16 is a flowchart illustrating an embodiment of a method for obtaining a trackable number, in accordance with at least one embodiment, such as at least one corresponding embodiment mentioned and presented above. The skilled addressee will appreciate that said method is performed by at least one first computing node.

According to processing step 1602, at least one first identifier associated with the at least one first computing node is first combined with at least one first trackable number associated with a determined portion of at least one structured data unit part of the distributed ledger enabled system. In at least one embodiment where a plurality of second numbers is involved, such as when a plurality of structured data units is involved, according to at least one embodiment, said plurality is reduced, using at least one mathematical operation, to a single number prior said first combining. In at least one embodiment where a plurality of identifiers is associated with the at least one first computing node, according to at least one embodiment, said plurality is reduced, using at least one mathematical operation, to a single identifier prior said first combining. In at least one embodiment where a plurality of structured data units is involved in said first combining, a combination of corresponding at least one associated second number is performed, such as by performing an average of the plurality of the corresponding at least one associated number.

In at least one embodiment, the determined corresponding portion of the at least one structured data unit is a dedicated space consisting of the at least one second number. The skilled addressee will appreciate that a given structured data unit added to a given blockchain wherein a given determined portion of said given structured data unit does not consist of, or, in at least one embodiment, comprise said at least one second number is typically considered invalid and may result, by a given blockchain-related process, in a penalizing of at least one computing node involved in said adding of said given structured data unit to said given blockchain.

In at least one embodiment, a given identifier and/or a given number associated with a given structured data unit is separated into a plurality of portions prior said first combining. For instance, in an embodiment where a given identifier is a number, the given identifier could be separated into a plurality of smaller numbers. The skilled addressee will appreciate that, in at least one corresponding embodiment, a first advantage of separating, for instance, a given identifier into a plurality of portions is a saving of storage. For instance, a plurality of portions obtained from a given identifier combined, wherein said combining involves a given number associated with a given structured data unit which may have been altered using at least one mathematical operation, one after the other using an exclusive or (XOR) operation would result in a smaller result of the combining than without performing a separating. The skilled addressee will further appreciate that, in at least one embodiment, a second advantage of separating, for instance, a given identifier into a plurality of portions is a processing time of at least one given process using a resulting trackable number.

In at least one embodiment where a plurality of first computing nodes is involved in the first combining, according to at least one first embodiment, said plurality would reach a consensus, such as by performing a synchronization, prior a completion of said first combining. In at least one related embodiment to the at least one first embodiment, the reaching of the consensus involves at least one portion of said plurality providing their at least one associated identifier to at least one other portion of said plurality. In at least one embodiment where the at least one other portion consists of a single node, at least one given node part of the at least one other portion performs the first combining. In at least one embodiment, the at least one other portion perform a combining and packaging of received data, such as the provided at least one identifier, prior a given node completing said first combining. In at least one embodiment, a first threshold determines a number of at least one first computing node required to be involved in said first combining. In at least one embodiment, the first threshold is a parameter part of the distributed ledger enabled system. In at least one embodiment, at least one signature and/or co-signature is involved in at least one corresponding communication between a plurality of first computing nodes involved in said first combining, such as communications performed in the reaching of the consensus.

In at least one embodiment, at least one first criterion determines an enabling of at least one processing step of said first combining. In at least one embodiment, the at least one first criterion involves at least one reliability metric, or an average thereof, associated with at least one involved first computing node, and/or the like. In at least one embodiment, the at least one processing step is, or, in at least one embodiment, comprises a scope and/or a nature of said first combining, such as a number of at least one node required to be involved in said first combining and/or a plurality of mathematical operations to perform in said first combining between a plurality of required components of a given trackable number.

According to processing step 1604, at least one indication of the trackable number is obtained based on a first result of said first combining. In at least one embodiment, a given first computing node performing the obtaining of the trackable number indicates, such as by emitting a blockchain-related event, to at least one other first computing node that said obtaining was performed thereof. In at least one embodiment, said obtaining involve an obtaining first computing node to sign said tracking number after obtaining it thereof. In at least one embodiment, at least one other first computing node is required to attest said signature, such as by performing an additional signature. In at least one embodiment, a co-signature mechanism is used instead. The skilled addressee will appreciate that the trackable number is used for various functions, mechanisms, systems and methods part of the distributed ledger enabled system, such as recording and/or generating a transaction and/or a given structured data unit, selecting and/or communicating and/or interacting with an entity and/or a wallet and/or a node part of the distributed ledger enabled system and/or the like.

In at least one embodiment, the obtaining of the trackable number further comprises determining that at least one of at least one first computing node and/or at least one other involved computing node is determined to be reliable. The skilled addressee will appreciate that, in at least one embodiment, at least one of the at least one first computing node and/or the other involved computing node is subject to slashes and/or penalizations, such as slashes and/or penalizations described in at least one embodiment of the FIG. 3, according to at least one criterion, such as an evaluating of at least one blockchain-related action and/or behavior involving the at least one first computing node and/or the at least one other involved computing node, wherein said evaluating and/or behavior is thereby often associated with said reliability of the at least one first computing node and/or the at least one other involved computing node. The skilled addressee will also appreciate that the reliability can be provided in various forms, according to at least one embodiment, such as the above-mentioned embodiments of FIG. 3.

The skilled addressee will appreciate that the obtaining of the trackable number and the first combining can be provided in various forms, according to at least one embodiment, such as at least one embodiment of FIG. 4 and/or FIG. 8.

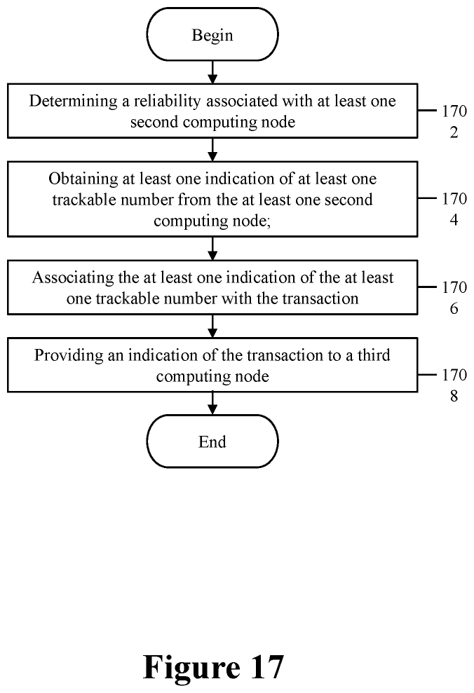

FIG. 17 is a flowchart illustrating an embodiment of a method for generating a transaction to be added to a distributed ledger enabled system's structured data unit, in accordance with at least one embodiment, such as at least one corresponding embodiment mentioned and presented above. The skilled addressee will appreciate that said method is performed by at least one first computing node.

According to processing step 1702, a reliability associated with at least one second computing node, or associated wallet thereof, is determined. The determination may be according to at least one of a first event and a first criterion. In at least one embodiment, the determining further comprises determining that at least one of the at least one first computing node and a given computing node, or associated wallet thereof, is reliable. The skilled addressee will appreciate that, in at least one embodiment, the at least one second computing node, the at least one of the at least one first computing node and/or the given computing node is subject to slashes and/or penalizations, such as slashes and/or penalizations described in at least one embodiment of the FIG. 3, according to at least one criterion, such as an evaluating of at least one blockchain-related action and/or behavior involving the at least one second computing node, the at least one of the at least one first computing node and/or the given computing node, wherein said evaluating and/or behavior is thereby often associated with said reliability of the at least one second computing node, the at least one of the at least one first computing node and/or the given computing node. The skilled addressee will also appreciate that the reliability can be provided in various forms, according to at least one embodiment, such as at least one embodiment of FIG. 3. In at least one first embodiment, the first blockchain-related event is determined as a reliability metric, such as a reliability metric value, associated with at least one of the at least one first computing node, or associated wallet thereof, at least meeting a determined threshold, such as a requester role threshold. In at least one embodiment, the criterion involves at least one of the at least one first computing node solving a challenge. In at least one embodiment involving the at least one first embodiment, upon completion of a first process associated with the first blockchain-related event, the first criterion is processed, said first criterion involving a validating of at least one previous blockchain-related event part of the distributed ledger enabled system and associated with the at least one of the at least one first computing node. The skilled addressee will appreciate that an obtaining of a result of a processing of the at least one previous blockchain-related event is often required to determine said first criterion. The skilled addressee will also appreciate that the first blockchain-related event and/or the first criterion can be provided in various forms, according to at least one embodiment of the present technology.

According to processing step 1704, at least one indication of at least one trackable number is obtained from the at least one second computing node, for example according to at least one of the first event, the first criterion, a second event and a second criterion. In at least one embodiment, said obtaining involves the at least one second computing node, or a plurality thereof, and/or at least one given node of the at least one first computing node selecting the at least one of the at least one first computing node. In at least one embodiment, the at least one first computing node selects the at least one second computing node. In at least one embodiment, the selecting involves using at least one reliability metric, such as a reliability metric value, associated with at least one node, or associated wallet thereof, involved in said obtaining, such as a given node being a target of said selecting. The skilled addressee will appreciate that the obtaining can be provided in various forms, according to at least one embodiment, such as at least one embodiment of FIG. 7, FIG. 8 and/or FIG. 12. The skilled addressee will appreciate that the at least one second computing node and the trackable number are both associated with at least one similar distributed ledged enabled system. In at least one embodiment, at least one of the obtaining and the generating of the transaction further comprises determining that the third computing node, or associated wallet thereof, is reliable, such as a similar determining than the determining at processing step 1702. The second criterion may be any criterion described as an example of the “first criterion” in reference to step 1702. The second event may be any event described as an example of the “first blockchain-related event” in reference to step 1702.

According to processing step 1706, at least one indication of the trackable number is associated to the transaction, for example according to at least one of the first event, the first criterion, the second event, the second criterion, a third event and a third criterion. In at least one embodiment, the at least one indication of the trackable number is the trackable number. In at least one embodiment, the at least one indication of the trackable number allows the at least one first computing node and/or the at least one second computing node and/or the given computing node and/or at least one other node to obtain the trackable number. In at least one corresponding embodiment, the at least one indication of the at least one second (first) transaction consists of, or, in at least one given embodiment, comprises at least one identifier, such as a numerical identifier and/or a one-way cryptographic encryption. In at least one given embodiment, a given indication is a combination of a plurality of identifiers, a nature of the said given indication's combination being defined according to at least one first criterion, such as a reliability metric value, nature of identifier etc. In at least one embodiment, an indication is a set of at least one machine readable instruction which enables an obtaining thereof. In at least one embodiment, a given nature of at least one given indication is enabled according to at least one criterion and/or blockchain-related event, such as a type of the transaction, a reliability metric associated with the at least one of the at least one first computing node, or associated wallet thereof, and/or the like. In at least one embodiment, said nature of the given indication's combination is defined according to a parameter part of the distributed ledger enabled system. The skilled addressee will appreciate that the associating of the at least one indication of the trackable number to the transaction can be provided in various forms, according to at least one embodiment, such as at least one embodiment of FIG. 7, FIG. 8, FIG. 12 and/or FIG. 15. The skilled addressee will also appreciate that the at least one indication of the trackable number can be provided in various forms, according to at least one embodiment, such as at least one embodiment of FIG. 7 and/or FIG. 12. The third criterion may be any criterion described as an example of the “first criterion” in reference to step 1702. The third event may be any event described as an example of the “first blockchain-related event” in reference to step 1702.)

The skilled addressee will appreciate that step 1702 may be processed at different stage(s) in the generating of the transaction instead of, or in compliment thereof, prior step 1704, such as in step 1706, according to at least one embodiment.

According to processing step 1708, an indication of the transaction is provided to a third computing node. In at least one embodiment, the indication is the transaction. In at least one embodiment, the indication allows the third computing node to obtain said transaction, such as when the indication consists of at least one identifier associated with at least one portion of said transaction. The skilled addressee will appreciate that the indication can be provided in various forms, according to at least one embodiment of the present technology.

In at least one embodiment, the obtaining, the associating and/or the providing involves at least one other node, such as the given computing node, the at least one other node acting as an intermediate between a plurality of computing nodes involved thereof, such as the at least one of at least one first computing node and the at least one second computing node according to the obtaining. In at least one embodiment, at least one signature and/or co-signature associated with at least one involved entity, such as a node, or associated wallet thereof, is involved in the obtaining, the associating and/or the providing, such as at least one from the at least one second computing node and/or at least one of the at least one other node according to the obtaining. The skilled addressee will appreciate that a given signature and/or co-signature technique can be used for various purposes and situations, and can be provided in various forms, according to at least one embodiment of the present technology. It will therefore be understood that at least one given entity which would have a need to provide data to at least one other blockchain-related entity and/or storage medium in a way that at least one origin, provenance and/or an authenticity of said data would be unaltered while also preserving, in at least one embodiment, an availability aspect to at least one portion of said data typically uses, alongside, in at least one embodiment, other mechanism(s) known by the skilled addressee, at least one signature and/or co-signature to meet said need. Finally, the skilled addressee will appreciate that at least one signature and/or co-signature mentioned in a context of the present technology typically involves an asymmetric encryption algorithm.

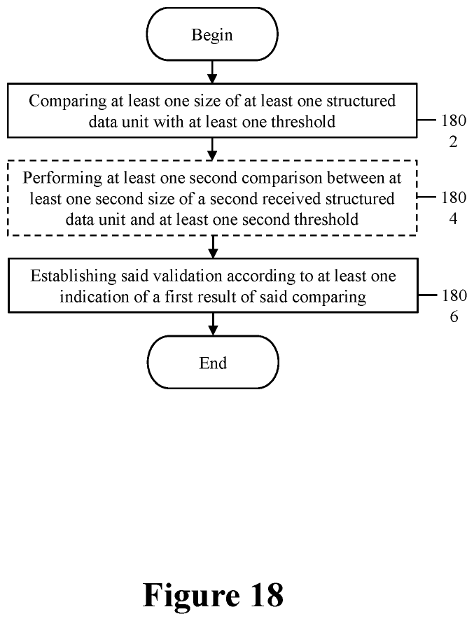

FIG. 18 is a flowchart illustrating an embodiment of a method for validating at least one size of at least one structured data unit, in accordance with at least one embodiment, such as at least one corresponding embodiment mentioned and presented above. The skilled addressee will appreciate that said method is performed by at least one first computing node.

According to processing step 1802, at least one first comparison between at least one first size of a first received structured data unit and at least one first threshold is performed. The skilled addressee will appreciate that the receiving can be provided in various forms, according to at least one embodiment, such as at least one embodiment of FIG. 1, FIG. 11 and/or FIG. 14. In at least one embodiment, the at least one first threshold comprises a lower bound threshold and an upper bound threshold. In at least one embodiment, the at least one first threshold is at least one of determined and redetermined according to at least one blockchain-related event and/or criterion such as a number of active nodes part of the blockchain, a right or restriction granted or imposed to a given entity, such as a node, by another entity part of the blockchain, a determined number of at least one block generated, a rule, at least one rate of at least one type of blockchain-related activity and/or the like. In at least one embodiment, the first received structured data unit is a block of a blockchain. In at least one embodiment, the first received structured data unit is a portion of a to be generated block, such as a set of data comprising at least one transaction, such as a transaction list, said set of data involving at least one given node, such as a generator, having participated in a generating of said set of data. In at least one embodiment, the at least one first comparison involves at plurality of first computing nodes. In at least one corresponding embodiment, the comparison involves at least one node of the plurality of first computing nodes to validate a given performed comparison by at least one other node and/or validate at least one portion of the first received structured data unit. The skilled addressee will appreciate that the first received structured data unit and the at least one first comparison typically are associated with at least one signature and/or co-signature of at least one concerned node, such as the at least one given node and at least one node involved in at least one comparing. The skilled addressee will appreciate that the at least one first size can be provided in various forms, according to at least one embodiment, such as at least one embodiment of FIG. 13.

According to optional processing step 1804, at least one second comparison between at least one second size of a second received structured data unit and at least one second threshold is performed. The skilled addressee will appreciate that the receiving can be provided in various forms, according to at least one embodiment, such as at least one embodiment of FIG. 1, FIG. 5 and/or FIG. 15. In at least one embodiment, the at least one second threshold comprises a lower bound threshold and an upper bound threshold. In at least one embodiment, the at least one second threshold is at least one of determined and redetermined according to at least one blockchain-related event and/or criterion such as a number of active nodes part of the blockchain, a right or restriction granted or imposed to a given entity, such as a node, by another entity part of the blockchain, a determined number of at least one block generated, a rule, at least one rate of at least one type of blockchain-related activity and/or the like. In at least one embodiment, the second received structured data unit is a block of a blockchain. In at least one embodiment, the second received structured data unit is the first received structured data unit. In at least one embodiment, the second received structured data unit is a portion of a to be generated block, such as a set of data comprising at least one transaction, such as a transaction(s) comparison list, said set of data involving at least one given node, such as an enforcer, having participated in a generating of said set of data. In at least one embodiment, the at least one second comparison involves at plurality of second computing nodes. In at least one corresponding embodiment, the comparison involves at least one node of the plurality of second computing nodes to validate a given performed comparison by at least one other node and/or validate at least one portion of the second received structured data unit. The skilled addressee will appreciate that the second received structured data unit and the at least one second comparison typically are associated with at least one signature and/or co-signature of at least one concerned node, such as the at least one given node and at least one node involved in at least one comparing. The skilled addressee will appreciate that the at least one second size can be provided in various forms, according to at least one embodiment, such as at least one embodiment of FIG. 13.

According to processing step 1806, a validation based on said performing of the at least one first comparison and said performing of the at least one second comparison is established. In at least one embodiment, the validation involves determining if at least one first virtual size threshold is respected thereof. In at least one embodiment, a determining of the validation involves at least one first criterion. In at least one embodiment, a processing of a first result of the first performed comparison and a second result of the second performed comparison determines said validation. In at least one embodiment, the at least one first criterion involves a parameter part of the blockchain.

In at least one embodiment, the validating of the at least one size of the at least one structured data unit further comprises determining that at least one of at least one first computing node and/or at least one other involved computing node is determined to be reliable. The skilled addressee will appreciate that, in at least one embodiment, at least one of the at least one first computing node and/or the other involved computing node is subject to slashes and/or penalizations, such as slashes and/or penalizations described in at least one embodiment of the FIG. 3, according to at least one criterion, such as an evaluating of at least one blockchain-related action and/or behavior involving the at least one first computing node and/or the at least one other involved computing node, wherein said evaluating and/or behavior is thereby often associated with said reliability of the at least one first computing node and/or the at least one other involved computing node. The skilled addressee will also appreciate that the reliability can be provided in various forms, according to at least one embodiment, such as the above-mentioned embodiments of FIG. 3.

In at least one embodiment, an enforcer is related to a generator and, based on a comparison of at least one portion of a mempool and/or transaction list associated with the generator and at least one portion of a mempool and/or transaction list associated with the enforcer, a trackable number associated with the enforcer is provided to the generator.

In at least one embodiment, an enforcer provides a single transaction comprised in at least one portion of the enforcer's mempool and/or transaction list to a generator.

In at least one embodiment, a given node is requested to obtain an enforcer and/or a generator and a trackable number associated with the given node may be included in a block involving the enforcer and/or generator in a generating process of said block.

In at least one embodiment, a given node is requested to obtain a partner and/or a requester and a trackable number associated with the given node may be included in a transaction involving the partner and/or requester in a generating process of said transaction.

The skilled addressee will appreciate that any trackable number associated with and/or comprised in any given element presented herein, such as a block, may be redetermined according to at least one criterion, such as at least one vote involving at least one voting computing node, such as a poll, a change of at least one reliability metric associated with a given node involved in a generation of said trackable number and/or the like.

In at least one embodiment, a given node obtaining a trackable number may do so by combining a trackable number associated with a block part of the blockchain and a trackable number associated with at least one other entity, such as a node, part of the blockchain.

In at least one embodiment, a node, or associated wallet thereof, must be approved by at least one other entity, such as a node, and/or must be compliant with at least one rule to be able to act as at least one given role.

In at least one embodiment, for a given subset of a given reliability metric(s) distribution, such as a reliability metric value distribution, wherein said subset is associated with a given role, a plurality of at least one subset is defined within said given subset. The skilled addressee will appreciate that each subset may be associated with at least one right, blockchain-related action, authority and/or role, such as an enforcer role, a storer role, acting as an enforcer in a determined scenario and/or the like, and a recursive relationship may be determined between a given plurality of subsets. In at least one embodiment, a number of the plurality of at least one subset is determined using a parameter part of the blockchain.

In at least one embodiment, a plurality of nodes is involved in a generating process of a given trackable number, said trackable number then being provided to at least one given node part of the blockchain.

In at least one embodiment, a rule is at least one of determined and redetermined in the blockchain according to at least one criterion and/or blockchain-related event, such as upon detection of at least one type of potentially suspicious activity(ies), an elapsing of a given period of time since a second blockchain-related event, or a plurality thereof, at least one vote involving at least one voting computing node, such as a poll, a result of an execution of at least one machine readable instruction and/or the like.

In at least one embodiment, a weight associated with a given rule varies according to at least one role and/or at least one reliability metric, such as a reliability metric value, associated with a concerned node, or associated wallet thereof.

In at least one embodiment, based on a generating of a given block, a concerned node thereby allocates and/or distributes at least one reward and/or compensation to at least one other node involved in a generating of the block.

In at least one embodiment, at least one asset of a given node involved in a transaction is frozen for a given amount of time according to at least one criterion, such as until said transaction is completed, until a block comprising said transaction is generated and/or the like. The skilled addressee will appreciate that the nature and/or scope of the freezing may be determined according to various conditions, such as a given type and/or nature of said transaction, a quantity of the at least one asset and/or the like. The skilled addressee will also appreciate that the at least one asset may be frozen for various conditions, such as during a determination of a role, during a generating of a block and/or the like.

The skilled addressee will appreciate that a number associated with a transaction and/or any relevant data structure according to a given context, such as a block generating process, thereof may be used to establish a given time-related metric of a completion and/or at least one step of a generation process of said transaction and/or any relevant process type according to a given context, such as a block generating process, thereof. The skilled addressee will thus appreciate that the present technology is capable of enabling a prevention of at least one entity, such as a node, and/or at least one entity, such as a node, associated with at least one given role part of the blockchain from repeatedly sending blockchain-related data to be processed and/or recorded in the blockchain, such as transactions in a given time period established using a time-related metric, such as said given time-related metric, for instance by determining at least one of a maximum and minimum of at least one type of blockchain-related data to send in a given time period for at least one first role, node, wallet and/or the like according to at least one criterion, such as a rule, a parameter part of the blockchain, at least one previous blockchain-related event, such as at least one previous transaction involving said first role, node, wallet and/or the like, and/or the like. The skilled addressee will appreciate that the number is preferably traceable, i.e., in at least one embodiment, that the number is associated with at least one of a node, or associated wallet thereof, part of the blockchain and a previous and/or current block. In at least one embodiment where the number is obtained from a smart contract, a system manager, a server, a computing node, a processing device and a software, traceability is established via at least one entity part of the blockchain obtaining a proof of an authenticity of the obtaining and, in at least one related embodiment, a proof of authority. In at least one embodiment where the number is a random number, at least one of a proof of said randomness and/or a proof of authority must be provided to at least one other entity part of the blockchain. The skilled addressee will appreciate that the number can be provided in various forms, according to at least one embodiment, such as at least one embodiment of FIG. 1, FIG. 2, FIG. 4, FIG. 7, FIG. 8, FIG. 12 and/or FIG. 16. In at least one embodiment, a plurality of numbers is used instead of a single number.

In at least one embodiment, at least one rule affects a nature, type, size and/or quantity of at least one given transaction permitted to be generated in the blockchain. The skilled addressee will appreciate that said nature, size and/or quantity may be affected by an updating of at least one given rule, such as described in at least one mentioned embodiment(s) of FIG. 3. The skilled addressee will appreciate that said nature, size and/or quantity can be provided in various forms, according to at least one embodiment, such as at least one embodiment of FIG. 3.

In at least one embodiment, at least one generator participating in a generating process of a block does not directly associate at least one enforcer's comparison's result with said block, and a first validation of said block and/or association of at least one enforcer's comparison's with said block is performed according to at least one criterion, such as a rule, a parameter part of the blockchain, an elapsed time period, such as a time period established using at least one previous blockchain-related event and/or the like. In at least one embodiment, a block that has not been first validated and/or first associated may be considered valid or invalid according to at least one criterion, such as a rule, a reliability metric associated with an entity, such as a node, involved in said generating process of said block, a blockchain parameter and/or the like.

In at least one embodiment, a first determining of at least one criterion and/or blockchain-related event is established based on a comparison of at least two time measures, such as timestamps, at least one first time measure being associated with at least one first set of data associated with at least one first computing node and at least one second time measure being associated with at least one second set of data associated with at least one second computing node, wherein the at least one second set of data is determined after the at least one first set of data. The skilled addressee will appreciate that a result of said first determining may be used in various situations and/or contexts and for various purposes, according to at least one embodiment, such as in a generation process of a transaction wherein said at least one first set of data is associated with at least one given requester and said at least one second set of data is associated with at least one given partner.

In at least one embodiment, at least one requester participating in a generating process of a transaction does not directly associate at least one partner's number(s) with said transaction, and a first association of at least one partner's number(s) with said transaction is performed according to at least one criterion, such as a rule, a parameter part of the blockchain, an elapsed time period, such as a time period established using at least one previous blockchain-related event and/or the like. In at least one embodiment, a transaction that has not been first associated may be considered valid or invalid according to at least one criterion, such as a rule, a reliability metric associated with an entity, such as a node, involved in said generating process of said transaction, a blockchain parameter and/or the like.

In at least one embodiment, at least one reliability metric associated with a given node, or associated wallet thereof, may be reduced and/or may need to meet at least one reliability metric threshold, according to at least one first criterion, for said given node to at least enable access to at least one given other role, blockchain-related action, right, authority, privilege and/or the like. In at least one embodiment, a given node may provide at least one asset to at least one of a smart contract, a system manager, a server, a computing node, a processing device and a software to at least enable access for said given node to at least one given other role, blockchain-related action, right, authority, privilege and/or the like.

In at least one embodiment, at least one given entity part of the blockchain, such as node, associated with at least one given role and/or right to perform at least one type of blockchain-related action may only be able to act and/or perform as such according to at least one criterion, for instance by only being able to act and/or perform as such for a determined time period, by meeting a need, such as a quantity threshold, of performing at least one related blockchain-related action over a determined time period, and/or the like.

In at least one embodiment, at least one type of blockchain-related action may be associated with at least one different type of punishment, reward, compensation, set of at least one rule and/or the like, wherein an enabling thereof may be determined by a determined time period and/or at least one other criterion thereof.

In at least one embodiment, at least one given role and/or blockchain-related action is available for at least one given entity, such as a node, part of the blockchain, and at least one of said at least one given entity is selected to at least enable an access to said at least one given role and/or blockchain-related action according to at least one criterion, such as at least one reliability metric, such as a reliability metric value, associated therewith, a quantity of at least one available asset, a number of at least one type of transaction in at least one portion of a corresponding mempool and/or transaction list and/or the like.

In at least one embodiment, at least one node having access to at least one given role and/or blockchain-related action may need to reach consensus for an allowance of at least one first node to said at least one given role and/or blockchain-related action.

In at least one embodiment, a given distributed ledger enabled system using the present technology comprises a main blockchain and a secondary blockchain-related storage and/or computational system, wherein a storage of and/or computation involving at least one portion of data which would be stored and/or computed in its entirety in the main blockchain is instead delegated to the secondary blockchain-related storage and/or computational system. In at least one embodiment, the delegation involves compressing, which may be lossless or lossy according to at least one corresponding embodiment, and/or altering and/or encrypting said at least one portion of data prior said delegation. The skilled addressee will appreciate that the secondary blockchain-related storage and/or computational system can be provided in various forms, such as a second layer architecture, such as Zero-knowledge rollups (ZK-rollups) or Optimistic rollups, comprising, in at least one embodiment, at least one proofing mechanism, such as a fraud proof mechanism, and/or an InterPlanetary File System (IPFS), and that at least one indication of the at least one portion of data is stored in the main blockchain, said at least one indication being associated with said delegated at least one portion of data. At least one embodiment, the encrypting is performed using a symmetric encryption algorithm selected from a group comprising Advanced Encryption Standard (AES), Data Encryption Standard (DES), International Data Encryption Algorithm (IDEA), Blowfish, Rivest Cipher 4 (RC4), Rivest Cipher 5 (RC5), Rivest Cipher 6 (RC6) and the like. In at least one embodiment, the encrypting is performed using an asymmetric encryption algorithm selected from a group comprising Rivest Shamir Adleman (RSA), Digital Signature Standard (DSS), Digital Signature Algorithm (DSA), Elliptical Curve Cryptography (ECC), Diffie-Hellman Exchange Method, TLS/SSL Protocol and the like.

The skilled addressee will appreciate that a cryptographic key is data enabling a decryption of a file or other form of processed data. In at least one embodiment, the cryptographic key is a public and/or private key. In at least one embodiment, the cryptographic key is related to a signature and/or co-signature. The skilled addressee will appreciate that, usually, at least one interaction, such as an obtaining and/or providing of data, between a plurality of entities, such as nodes, part of a blockchain usually involves at least one signature and/or co-signature. In at least one embodiment, said at least one interaction involves at least one other node acting as an intermediate between a plurality of computing nodes involved in said at least one interaction thereof. In at least one embodiment, according to at least one first criterion, said at least one other node may at least one of request at least one entity of the plurality of entity to process a challenge, request assistance of at least one other entity for a given interaction between a plurality of entities, such as nodes, limit a given interaction between a plurality of entities, such as nodes, stop or enable a given interaction between a plurality of entities, such as nodes and/or the like. In at least one embodiment, the at least one first criterion involves a processing and/or evaluation of received data provided by a given node, a reliability metric value associated thereof, or associated wallet thereof, and/or the like. In at least one embodiment, the limiting and/or stopping involves at least one penalization of at least one entity, such as a node, associated with said received data. In at least one embodiment, according to a processing and/or evaluation of received data provided by a given node, a node involved therewith may be granted a reward and/or compensation according to at least one given criterion, said at least one criterion varying greatly according to at least one given type of situation. The skilled addressee will appreciate that a given signature and/or co-signature technique can be used for various purposes and situations, and can be provided in various forms, according to at least one embodiment of the present technology. It will therefore be understood that at least one given entity which would have a need to provide data to at least one other blockchain-related entity and/or storage medium in a way that at least one origin, provenance and/or an authenticity of said data would be unaltered while also preserving, in at least one embodiment, an availability aspect to at least one portion of said data typically uses, alongside, in at least one embodiment, other mechanism(s) known by the skilled addressee, at least one signature and/or co-signature to meet said need. Finally, the skilled addressee will appreciate that at least one signature and/or co-signature mentioned in a context of the present technology typically involves an asymmetric encryption algorithm, such as elliptic curve cryptography. In at least one embodiment, a given interaction of a plurality of entities part of a blockchain involves an encrypting and/or decrypting of obtained and/or provided data during said given interaction. In at least one embodiment, a providing of data involves providing an indication of said data, such as an identifier and/or steps to reproduce said data, wherein said indication allows an obtaining, such as a recovering, of said data by at least one other entity part of the blockchain. The skilled addressee will appreciate that the obtaining often involves an encryption mechanism when said data is considered private. In at least one embodiment where a given computing node receives said indication of said data, said given computing node stores said indication of said data in at least one storage medium, such as a transaction, a structured data unit, such as a block, a hard drive, a solid-state drive and/or the like. In at least one embodiment, a given decrypting of given obtained and/or provided data is allowed to at least one entity part of the blockchain according to at least one criterion, such as an authority, a reliability metric, at least one vote involving at least one voting computing node, such as a poll, and/or the like. The skilled addressee will appreciate that said encrypting and/or decrypting can be provided in various forms, according to at least one embodiment of the present technology. In at least one embodiment, a given interacting between a plurality of entities, such as nodes, part of the blockchain involves a plurality of Transmission Control Protocol (TCP) channels. In at least one embodiment, a given interacting between a plurality of entities, such as nodes, involves using User Datagram Protocol (UDP). The skilled addressee will appreciate that, typically, at least one interaction type between a plurality of nodes part of a blockchain involves an implementation of a distributed hash table (DHT) system, such as an implementation of Kademlia. The skilled addressee will appreciate that said implementation of said distributed hash table system can be provided in various forms and may vary greatly. In at least one embodiment, a given interaction between a plurality of nodes involves at least one of the plurality of nodes to process a challenge, such a challenge aiming at establishing a reliability of a concerned node, or associated wallet thereof, and/or the like. In at least one embodiment, a given challenge may involve a mathematical challenge and/or a given proof resulting from a completion of a given data associated with a generator of said challenge. In at least one embodiment, the reliability enables a continuation of said given interaction and/or enables at least one portion of said given interaction. In at least one embodiment, according to a given blockchain-related event, such as an elapsing of a given period of time since a second blockchain-related event, or a plurality thereof, at least one given node thereby provides, such as in a given challenge process, at least one proof of non-participation in at least one type of potentially suspicious activity(ies) and/or at least one proof of maintaining a given behavior in the blockchain. For instance, in at least one embodiment, a given node provides to another entity part of the blockchain, such as a node, a proof that it is compliant with at least one rule, such as a need of using at least one different enforcer for at least one generated block.

In at least one embodiment, a parameter is defined as a value part of the blockchain which may or may not, according to at least one embodiment, be immutable. In at least one embodiment, a parameter part of the blockchain is immutable. In at least one embodiment, a parameter part of the blockchain can be updated according to at least one criterion, at least one event and/or rule, such as at least one vote involving at least one voting computing node, such as a poll, enabled, such as started, by at least one entity part of the blockchain having such authority, such as a system manager and/or a relevant role. The skilled addressee will appreciate that any value which does not have to be defined dynamically based on a given situation may be a parameter part of the blockchain.

In at least one embodiment, a given criterion involves at least one condition, a result of an execution of at least one machine readable instruction, at least one event, at least one performing of an evaluation of data relevant to a given situation involving said criterion, at least one condition and/or the like. The skilled addressee will appreciate that a given criterion may be provided in various forms and may vary greatly in nature and scope, according to at least one embodiment and at least one given situation.

In at least one embodiment, at least one evaluation of at least one reliability metric associated with a given computing node, or associated wallet thereof, is required to enable at least one type of blockchain-related action. In at least one embodiment, if said given computing node performs said at least one type of blockchain-related action regardless or prior hand, said given computing node may be subject to slashes and/or penalizations, such as slashes and/or penalizations described in at least one embodiment of the FIG. 3.

In at least one embodiment, an allowing and/or granting of at least one of an access to at least one first blockchain-related feature, a first authority, a first right, a first privilege and a first role may also involve, according to at least one embodiment and a given context and/or situation, at least one allowing and/or granting of at least one of an access to at least one second blockchain-related feature, a second authority, a second right, a second privilege, a second role and the like.

In at least one embodiment, a reliability of a given node, or associated wallet thereof, is determined by at least one computing node part of a distributed ledger enabled system and, once determined, provides at least one indication of a result of said determining of the reliability to at least one other entity part of the distributed ledger enabled system, such as at least one node, said at least one other entity thereby at least one of continuing, enable and/or disable an ongoing process involving said given node and initiate a process involving said given node according to said at least one indication of said result of said determining. The skilled addressee will appreciate that said determining may be processed and performed independently to said process involving said given node, such as by being performed as a background task. In at least one embodiment, at least one receiving entity, such as at least one node, of said result of said determining may provide at least one indication of a disagreement on a verdict associated with said result of said determining. In at least one embodiment, at least one entity involved in a given disagreement may be subject to slashes and/or penalizations, such as slashes and/or penalizations described in at least one embodiment of the FIG. 3, according to an evaluation of said disagreement by at least one evaluating entity, such as at least one node, part of the distributed ledger enabled system.

In at least one embodiment, instead of determining a reliability of an entirety of a plurality of entities, such as nodes and/or wallets, at least one portion of said plurality is determined instead, and at least one other portion of said plurality is one of considered to be reliable without determining thereof, must provide at least one result of at least one challenge provided thereof and be determined by at least one other node part of at least one second portion of said plurality.

The skilled addressee will appreciate that a given obtaining, such as a selecting, a given reliability metric distribution, a given determining of a reliability and/or various other actions which can involve at least one node may involve, in at least one embodiment, at least one wallet and/or other identifier and/or other representation associated thereof. In at least one embodiment, a given obtaining involves at least one machine readable instruction determining at least one portion of at least one aspect of said obtaining and/or acts as a criterion of at least one aspect of said obtaining, such as when a computing node obtains a request of a requesting node involved in a given selecting.

The skilled addressee will appreciate that a given reliability of at least one given entity, such as at least one node, or associated wallet thereof, may involve, according to at least one embodiment, at least one ability to perform at least one previously determined action in a distributed ledger enabled system, such as at least one type of transaction.

In at least one embodiment, at least one node delegating at least one of blockchain-related data, at least one role, at least one right, at least one privilege, at least one action, at least one task and at least one authority may be related to less reward(s) and/or compensation(s) and/or grant(s) and/or greater penalization(s) than at least one other node part of the blockchain according to at least one criterion, such as at least one associated role, at least one associated reliability metric value and/or at least one associated delegating aspect. In at least one embodiment, at least one node related to a delegating, or, in at least one embodiment, not related to a delegating, is identified as such in data part of the blockchain. In at least one embodiment, at least one type of blockchain-related action is at least one of enabled and/or disabled for at least one given node according to an identifying of said at least one given node. In at last one embodiment, an identifying of at least one given node is at least one of determined and redetermined according to at least one criterion, such as at least one connection and/or disconnection of said at least one given node to a blockchain-related network and/or the like. In at least one embodiment, at least one given node related to a delegating is at least one of allowed and disallowed, according to at least one criterion, such as a reliability metric value associated thereof, to performs and/or be involved in at least one type of blockchain-related action associated with at least one of a right, authority, privilege and/or the like.

In at least one embodiment, at least one computing node processing a structured data unit associate information to said structured data unit, such as at least one indication of at least one trackable number, at least one indication of at least one transaction and/or the like, prior providing it to at least one other computing node. In at least one embodiment, said information involves a plurality of computing node. For instance, said at least one portion of said plurality combine at least one co-signature with given information prior associating said information.

In at least one embodiment, a validation associated with at least one portion of structured data unit is performed before providing it to at least one other entity part of the blockchain and/or confirming it in the blockchain, such as determining a validity associated with at least one transaction in said structured data unit and/or a tracking of at least one indication of at least one trackable number associated with said structured data unit. In at least one embodiment, said validity involves at least one entity part of the blockchain to enable a penalizing and/or compensating and/or any other action resulting from a given tracking and/or at least one processing step of said validating. In at least one embodiment, at least one indication of at least one proof of performing at least one type of at least one blockchain-related action is required to be provided to at least one relevant entity, such as a system manager, part of the blockchain. In at least one embodiment, at least one of a shape, form, scope and nature associated with given penalizing and/or compensating related to said validation varies based on data being validated. For instance, a given node being considered to have committed multiple infractions to a set of at least one rule could receive a harsher punishment to another node given a similar data being validated. In at least one embodiment, a penalizing involves at least one of a preventing and losing of at least one associated asset and/or an altering of an associated score, and vice versa for a compensation, according to a shape, form, scope and/or nature of at least one validated portion thereof. In at least one embodiment, a duration of a compensating and/or penalizing varies according to at least one of at least one condition, event, action, function, criterion, smart contract, system manager, server, computing node, parameter, processing device, rule, machine readable instruction and vote of at least one entity related to a blockchain, such as a at least one reliability metric value associated with at least one concerned computing node.

In at least one embodiment, at least one blockchain-related action associated with at least one given node is enabled by at least one authorization, such as a challenge required to, at least once per given period of time, complete in order to perform said action. In at least one embodiment, at least one authorization is imposed based on at least one of at least one condition, event, action, function, criterion, smart contract, system manager, server, computing node, parameter, processing device, rule, machine readable instruction and vote of at least one entity related to the blockchain.

In at least one embodiment, a number of at least one trackable number and/or other relevant data to associate with a structured data unit varies based on at least one concerned computing node.

In at least one embodiment, a generating of a trackable number involves an obtaining of at least one portion thereof, such as at least one identifier associated with at least one given computing node aiming at generating such trackable number, said obtaining involving obtaining at least one portion of said at least one identifier from at least one of the at least one given computing node and/or at least one of at least one smart contract, system manager, server, computing node, processing device and machine readable instruction part of a blockchain. In at least one embodiment, at least one of a shape, form, nature and scope of an obtaining process and/or a combining process involved in a generating of at least one given trackable number and/or at least one determined portion of at least one block part of a blockchain associated with said combining process varies according to at least one of at least one condition, event, action, function, criterion, smart contract, system manager, server, computing node, parameter, processing device, rule, machine readable instruction and vote of at least one entity related to a blockchain. For instance, a at least one reliability metric value associated therewith could have an impact.

In at least one embodiment, a selecting of a given node involves at least one given portion of at least one of at least one smart contract, system manager, server, computing node, processing device and machine readable instruction acting as an intermediary. For instance, at least one given node having a need to associate with at least one other node would send information to perform said selection, such as at least one indication of at least one trackable number, to said at least one given portion before said at least one given portion performs said selecting according to at least one of at least one condition, event, action, function, criterion, smart contract, system manager, server, computing node, parameter, processing device, rule, machine readable instruction and vote of at least one entity related to the blockchain, such as a value associated with said at least one indication of at least one trackable number.

In at least one embodiment, an indication of a trackable number consists of instructions and/or data allowing a recovering of said trackable number. For instance, a set of component(s), portion(s) of relevant data and indication(s) of instruction(s) on how to combine at least one portion of at least one of said set of component(s) and portion(s) of relevant data.

The skilled addressee will appreciate that at least one embodiment of the method and the system disclosed herein are of great advantages.

More precisely, a first advantage of at least one embodiment of the methods and the systems disclosed herein is that the present technology enables to effectively process a transaction without needing to significantly rely on investing resources like PoS, PoW and PoSpace. Instead, the present technology uses a principle of probabilistic equality in which nodes have an equal opportunity to generate the next block given that the nodes respect at least one determined rule.

A second advantage of at least one embodiment of the methods and the systems disclosed herein is that the present technology enables a detection of potentially unwanted events and/or the countering of potentially unwanted events by determining a potentially suspicious pattern and thus to create a rule to punish a node related to the potentially suspicious pattern. For instance, a Sybil attack, which consists of attacking a blockchain by creating a large number of nodes to take over the decisional related power of a blockchain, could potentially be countered using a rule establishing that a given computing node is required to have a certain reliability metric value to act as an enforcer, a generator and/or any other relevant role. With the rule, even if a node makes a Sybil attack without enabling the detection of the potentially unwanted blockchain-related event and/or the countering of the potentially suspicious pattern, the suspicious pattern could still be determinable and penalizable. The skilled addressee will appreciate that the potentially suspicious patterns may be provided in various forms. In at least one embodiment, a blockchain using the present technology could detect a potentially suspicious pattern selected from a group comprising a rotating and/or an alternating of nodes for an enforcer, a generator and/or any other relevant role, ignoring and/or prioritizing the transactions from a similar computing node when generating a block, selecting an enforcer and/or a partner that was determined in a same timeframe as a generator, and/or a requester and/or any other relevant role, determining a transaction of a computing node determined in a same timeframe as a generator when generating a block, determining a transaction of a computing node determined in a same timeframe as the majority of other computing nodes when generating a block and/or the like. Therefore, the reliability metric value associated with a node performing the aforementioned activities could be impacted negatively when detected, and the node may be penalized and/or may become blacklisted.

A third advantage of at least one embodiment of the methods and systems disclosed herein is that since the present technology enables nodes to be evaluated and to detect and/or counter at least one potentially suspicious pattern, attacks such as a 51% attack, i.e., when a majority of nodes attempt to take over a decisional power in the network to perform malicious actions such as maliciously updating at least one block and/or generating at least one malicious block in a blockchain and/or generating and/or processing at least one malicious transaction in a blockchain, could be detectable and/or possible to counter. In one or more exemplary and non-limiting embodiments, a system using the present technology could counter a 51% attack by adding rules and/or strategies such as:
e) A rule aiming at preventing a given node to act as an enforcer, a generator and/or any other relevant role by reducing its reliability metric value when it performs a recognizable and potentially suspicious pattern, thereby reducing the reliability metric value related to said given node below a determined region in a reliability metric value distribution, such as an enforcer region or a blacklist region;
f) A strategy aiming at enabling sharding, where a given generator and/or requester and/or any other relevant role is only authorized to interact with a respective enforcer and/or a partner and/or any other relevant role if said respective enforcer and/or a partner and/or any other relevant role is comprised in a different shard than said given generator and/or requester and/or any other relevant role, the given generator and/or requester and/or any other relevant role being associated with said shard based on a given blockchain-related event, the given blockchain-related event being triggered when a given condition is met, such as a determined number of at least one block, a determined amount of time elapsed, and/or the like;
g) A strategy aiming at limiting a given node to repeatedly produce transactions of a given type to at least one of a given wallet and a given other computing node over a determined period of time, thereby limiting said computing node from repeatedly interacting with at least one specific computing node and/or producing transactions of a given type to at least one specific wallet. In at least one embodiment, the strategy further comprises requiring an amount of at least one asset comprised in a wallet associated with said given node to be comprised in a determined range to be able to act as an enforcer, a generator and/or any other relevant role, thereby limiting a mass creation of malicious wallets and/or nodes. In at least one embodiment, the strategy also comprises limiting said computing node to interact with at least one other node associated with at least one other wallet comprising an amount of at least one asset below a minimum threshold, said minimum threshold being either static or determined based on a plurality of wallets; and/or
h) A strategy aiming at updating, after a determined number of at least one block, the reliability metric value associated with a given node if said reliability metric value is over an upper limit in a reliability metric value distribution in relation to an average reliability metric value, said average reliability metric value being based on a plurality of nodes, thereby limiting said given node from repeatedly interacting with a specific enforcer, generator and/or any other relevant role. In at least one embodiment, the strategy further comprises temporarily requiring said given node to act as an enforcer, a generator and/or any other relevant role in relation to a reliability-related event, such as said reliability metric value updating after the determined number of at least one block, until at least one node can act as an enforcer, a generator and/or any other relevant role.

The skilled addressee will appreciate that because enforcers are, by default, chosen within a specific reliability metric value range varying in relation to the number of the generator, and because suspicious patterns are detectable and punishable, 51% attacks are possible but extremely hard to execute and the malicious nodes would be penalized by the determined rules rapidly. The skilled addressee will further appreciate that, similarly to PoW, PoS and PoSpace, the present technology is not infallible against 51% attacks, and the latter may succeed on processing fraudulent transactions.

The embodiments described above are intended to be exemplary only. The scope of the invention is therefore intended to be limited solely by the appended claims.

1. A computer-implemented method for processing a structured data unit related to a distributed ledger enabled system, the computer-implemented method being performed by at least one first computing node related to the distributed ledger enabled system, the computer-implemented method comprising:
determining a reliability associated with at least one of the at least one first computing node, at least one given computing node and at least one second computing node; and
providing at least one indication of at least one portion of the structured data unit to at least one subset of the at least one second computing node.

2. The computer-implemented method of claim 1, wherein the structured data unit is one of at least one portion of a block related to a blockchain and a structure of at least one indication of at least one portion of at least one transaction associated with at least one of the at least one second computing node and at least one other computing node, said at least one other computing node being considered to be reliable.

3. The computer-implemented method of any one of claims 1 to 2, wherein the method is associated with the at least one given computing node.

4. The computer-implemented method of any one of claims 1 to 3, wherein at least one subset of the at least one given computing node is at least one subset of at least one of the at least one first computing node and the at least one second computing node.

5. The computer-implemented method of any one of claims 1 to 4, wherein said processing comprises associating at least one first indication of at least one obtained first trackable number associated with at least one of the at least one first computing node, the at least one given computing node and the at least one second computing node with the structured data unit.

6. The computer-implemented method of any one of claims 1 to 5, further comprising associating at least one indication of at least one transaction with the structured data unit, and wherein at least one portion of said at least one indication of the at least one transaction is organized according to at least one associated second trackable number.

7. The computer-implemented method of any one of claims 5 to 6, wherein associating data with at least one given portion of the structured data unit comprises one of:
adding said data to said at least one given portion; and
storing said data on at least one storage medium, obtaining at least one given indication of said data on the at least one storage medium and adding said at least one given indication to said at least one given portion.

8. The computer-implemented method of any one of claims 1 to 7, wherein determining the reliability comprises comparing at least one reliability metric value associated with at least one of the at least one first computing node, the at least one given computing node and the at least one second computing node with at least one reliability metric value threshold, and further wherein the at least one reliability metric value threshold is determined according to at least one of at least one condition, event, action, function, criterion, smart contract, system manager, server, computing node, parameter, processing device, rule, machine readable instruction and vote of at least one entity related to the distributed ledger enabled system.

9. The computer-implemented method of claim 8, wherein the at least one reliability metric value threshold comprises at least one first minimum reliability metric value threshold and at least one first maximum reliability metric value threshold.

10. The computer-implemented method of any one of claims 1 to 9, wherein said determining of reliability comprises obtaining at least one authorization associated with at least one of the at least one first computing node and the at least one given computing node, and further wherein the at least one authorization is determined according to at least one of at least one condition, event, action, function, criterion, smart contract, system manager, server, computing node, parameter, processing device, rule, machine readable instruction and vote of at least one entity related to the distributed ledger enabled system.

11. The computer-implemented method of any one of claims 1 to 10, wherein the structured data unit is obtained from at least one subset of at least one of: the at least one first computing node; the at least one given computing node; and the at least one second computing node.

12. The computer-implemented method of any one of claims 1 to 11, wherein at least one subset of the at least one first computing node, the at least one given computing node and the at least one second computing node enables at least one portion of said processing.

13. The computer-implemented method of any one of claims 1 to 12, wherein at least one subset of the at least one first computing node enables at least one portion of a generating process of the structured data unit.

14. The computer-implemented method of any one of claims 1 to 13, further comprising confirming the structured data unit in the distributed ledger enabled system, wherein said confirming involves at least one subset of at least one of: the at least one first computing node; the at least one given computing node; and the at least one second computing node.

15. The computer-implemented method of any one of claims 1 to 14, further comprising performing a validating associated with the structured data unit.

16. The computer-implemented method of any one of claims 1 to 15, wherein at least one of said validating and said providing comprises combining at least one part of at least one cryptographic key associated with at least one of the at least one first computing node, the at least one given computing node and the at least one second computing node with at least one portion of at least one of the structured data unit and information involved in at least one interaction between at least one subset of at least one of the at least one first computing node, the at least one given computing node and at least one second computing node.

17. The computer-implemented method of any one of claims 15 to 16, wherein said validating comprises associating at least one portion of at least one result of at least one comparison associated with at least one subset of the at least one first computing node and at least one third computing node with the structured data unit.

18. The computer-implemented method of any one of claims 1 to 17, wherein said processing comprises performing a selecting associated with at least one subset of at least one of the at least one first computing node, the at least one given computing node, the at least one second computing node and the at least one third computing node using at least one given trackable number, and further wherein said selecting involves at least one other subset of at least one of the at least one first computing node, the at least one given computing node, the at least one second computing node and the at least one third computing node.

19. The computer-implemented method of claim 18, wherein said selecting comprises determining at least one portion of at least one reliability metric value distribution and performing said selecting using said at least one portion of the at least one reliability metric value distribution.

20. The computer-implemented method of claim 18, wherein said selecting comprises at least one of:
determining at least one portion of at least one reliability metric value distribution;
providing, to at least one of at least one first intermediary smart contract, system manager, server, computing node and processing device, information required to perform at least one processing step of said selection; and
obtaining, from at least one of at least one first providing smart contract, system manager, server, computing node and processing device, information associated with the selection.

21. The computer-implemented method of any one of claims 15 to 20, wherein said validating comprises determining at least one of a reliability and a uniqueness associated with the structured data unit.

22. The computer-implemented method of any one of claims 15 to 21, wherein said validating comprises at least one of tracking and invalidating at least one relevant trackable number associated with the structured data unit, and further wherein a performing of at least one of said tracking and invalidating involves at least one subset of at least one of the at least one first computing node, the at least one given computing node, and at least one of at least one smart contract, system manager, server, computing node, processing device and machine readable instruction related to the distributed ledger enabled system.

23. The computer-implemented method of any one of claims 15 to 22, wherein said validating comprises redetermining a previously determined reliability associated with at least one of the at least one first computing node, the at least one given computing node, the at least one second computing node and the at least one other computing node according to at least one of at least one condition, event, action, function, criterion, smart contract, system manager, server, computing node, parameter, processing device, rule, machine readable instruction, and vote of at least one entity related to the distributed ledger enabled system.

24. The computer-implemented method of any one of claims 15 to 23, wherein a performing of said validating involves at least one first subset of at least one of:
the at least one first computing node;
the at least one second computing node;
the at least one given computing node;
the at least one third computing node; and
at least one of at least one smart contract, system manager, server, computing node, processing device and machine readable instruction related to the distributed ledger enabled system.

25. The computer-implemented method of claim 24, wherein said validating comprises enabling at least one of a penalizing and a compensating associated with the at least one first subset, and further wherein at least one of a shape, form, scope and nature of at least one of said penalizing and said compensating is determined according to at least one of at least one condition, event, action, function, criterion, smart contract, system manager, server, computing node, parameter, processing device, rule, machine readable instruction and vote of at least one entity related to the distributed ledger enabled system.

26. The computer-implemented method of any one of claims 6 to 25, wherein at least one second portion of at least one of the at least one obtained first trackable number, the at least one associated second trackable number, the at least one given trackable number and the at least one relevant trackable number is one of pseudo-random and random, and further wherein an obtaining process associated with said at least one second portion involves at least one subset of at least one of the at least one first computing node, the at least one given computing node, the at least one second computing node and the structured data unit.

27. The computer-implemented method of any one of claims 1 to 26, wherein a reliability associated with at least one computing node related to said processing comprises at least one of at least one rule, role, ability to perform at least one previously determined action in the distributed ledger enabled system, reliability metric value, demonstration of trustworthiness and determining of trustworthiness determined by at least one first rightful computing node.

28. The computer-implemented method of any one of claims 25 to 27, wherein said penalizing comprises at least one of:
preventing at least one action to be performed on at least one first asset accessible by at least one subset of at least one of the at least one first subset;
losing at least one second asset accessible by at least one subset of at least one of the at least one first subset; and
altering at least one reliability metric value associated with at least one of the at least one first subset,
and wherein at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

29. The computer-implemented method of any one of claims 1 to 28, wherein at least a portion of the method is enabled according to at least one of at least one condition, event, action, function, criterion, smart contract, system manager, server, computing node, parameter, processing device, rule, machine readable instruction and vote of at least one entity related to the distributed ledger enabled system.

30. The computer-implemented method of any one of claims 27 to 29, wherein said role comprises at least one of at least one right, responsibility and authority, said at least one of at least one right, responsibility and authority comprising at least one of:
delegating a storing of at least one portion of data related to at least one subset of at least one of the at least one first computing node, the at least one second computing node, the at least one given computing node, and the at least one third computing node according to at least one of at least one condition, event, action, function, criterion, smart contract, system manager, server, computing node, parameter, processing device, rule, machine readable instruction and vote of at least one entity related to the distributed ledger enabled system;
storing at least one additional portion of delegated data related to at least one subset of at least one of the at least one first computing node, the at least one second computing node, the at least one given computing node, and the at least one third computing node according to at least one of at least one condition, event, action, function, criterion, smart contract, system manager, server, computing node, parameter, processing device, rule, machine readable instruction and vote of at least one entity related to the distributed ledger enabled system;
altering at least one transaction threshold of at least one structured data unit related to the distributed ledger enabled system for at least one subset of at least one of the at least one first computing node, the at least one second computing node, the at least one given computing node, and the at least one third computing node according to at least one of at least one condition, event, action, function, criterion, smart contract, system manager, server, computing node, parameter, processing device, rule, machine readable instruction and vote of at least one entity related to the distributed ledger enabled system; and
performing at least one task, said at least one task comprising at least one of monitoring, modifying, adding, terminating and determining a behavior of at least one machine readable instruction related to the distributed ledger enabled system for at least one subset of at least one of the at least one first computing node, the at least one second computing node, the at least one given computing node, and the at least one third computing node according to at least one of at least one condition, event, action, function, criterion, smart contract, system manager, server, computing node, parameter, processing device, rule, machine readable instruction and vote of at least one entity related to the distributed ledger enabled system.

31. A system comprising at least one processor, and at least one storage medium storing instructions, which when executed by the at least one processor, causes the system to carry out the computer-implemented method of any one of claims 1 to 30.

32. A machine-readable medium carrying machine readable instructions, which when executed by a processor of a machine, causes the machine to perform the computer-implemented method of any one of claims 1 to 30.

33. A computer-implemented method for validating a structured data unit related to a distributed ledger enabled system, the computer-implemented method being performed by at least one first computing node related to the distributed ledger enabled system, the computer-implemented method comprising:
determining a reliability associated with at least one of the at least one first computing node, at least one given computing node and at least one second computing node;
obtaining at least one indication of at least one first transaction associated with the structured data unit;
determining a similarity between at least one indication of at least one second transaction associated with the at least one first computing node and the at least one indication of the at least one first transaction; and
providing at least one of at least one given indication of a first result of said determining of similarity and at least one portion of the structured data unit to at least one subset of the at least one second computing node.

34. The computer-implemented method of claim 33, wherein the structured data unit is one of at least one portion of a block related to a blockchain and a structure of at least one indication of at least one portion of at least one transaction associated with at least one of the at least one second computing node and at least one other computing node, said at least one other computing node being considered to be reliable.

35. The computer-implemented method of any one of claims 33 to 34, wherein a performing of at least one processing step of said validating is associated with the at least one given computing node, and further wherein at least one of said providing and at least one other processing step comprises said at least one processing step.

36. The computer-implemented method of any one of claims 33 to 35, wherein at least one subset of the at least one given computing node is at least one subset of at least one of the at least one first computing node and the at least one second computing node.

37. The computer-implemented method of any one of claims 33 to 36, further comprising:
providing at least one portion of at least one of the at least one given indication, the at least one indication of the at least one first transaction and the at least one indication of the at least one second transaction to at least one relevant subset of at least one given computing node; and
obtaining at least one indication of a second result, the at least one indication of the second result being obtained by first determining a similarity between at least one of the at least one given indication, the at least one indication of the at least one first transaction, the at least one indication of the at least one second transaction and at least one indication of at least one third transaction associated with the at least one relevant subset.

38. The computer-implemented method of any one of claims 33 to 37, further comprising associating at least one first indication of at least one obtained first trackable number associated with at least one of the at least one first computing node, the at least one given computing node and the at least one second computing node with at least one of the at least one given indication, the at least one indication of the second result and the structured data unit.

39. The computer-implemented method of any one of claims 33 to 38, wherein associating data with at least one given portion of at least one of the at least one given indication, the at least one indication of the second result and the structured data unit comprises one of:
adding said data to said at least one given portion; and
storing said data on at least one storage medium, obtaining at least one given indication of said data on the at least one storage medium and adding said at least one given indication to said at least one given portion.

40. The computer-implemented method of any one of claims 33 to 39, further comprising determining a validity associated with at least one of the at least one given indication, the at least one indication of the second result, the at least one indication of at least one first transaction, the at least one indication of at least one third transaction and at least one other given portion of the structured data unit.

41. The computer-implemented method of any one of claims 33 to 40, wherein determining the reliability comprises comparing at least one reliability metric value associated with at least one of the at least one first computing node, the at least one given computing node and the at least one second computing node with at least one reliability metric value threshold, and further wherein the at least one reliability metric value threshold is determined according to at least one of at least one condition, event, action, function, criterion, smart contract, system manager, server, computing node, parameter, processing device, rule, machine readable instruction and vote of at least one entity related to the distributed ledger enabled system.

42. The computer-implemented method of claim 41, wherein the at least one reliability metric value threshold comprises at least one first minimum reliability metric value threshold and at least one first maximum reliability metric value threshold.

43. The computer-implemented method of any one of claims 33 to 42, wherein said determining of reliability comprises obtaining at least one authorization associated with at least one of the at least one first computing node and the at least one given computing node, and further wherein the at least one authorization is determined according to at least one of at least one condition, event, action, function, criterion, smart contract, system manager, server, computing node, parameter, processing device, rule, machine readable instruction and vote of at least one entity related to the distributed ledger enabled system.

44. The computer-implemented method of any one of claims 33 to 43, wherein the structured data unit is obtained from at least one subset of at least one of the at least one first computing node, the at least one given computing node and the at least one second computing node.

45. The computer-implemented method of any one of claims 33 to 44, wherein at least one subset of the at least one first computing node, the at least one given computing node and the at least one second computing node enables at least one portion of said validating.

46. The computer-implemented method of any one of claims 33 to 45, wherein at least one subset of the at least one first computing node enables at least one portion of a generating process of the structured data unit.

47. The computer-implemented method of any one of claims 33 to 46, wherein at least one of:
determining a similarity between at least one indication of at least one second transaction associated with the at least one first computing node and the at least one indication of the at least one first transaction; and
determining a similarity between at least one of the at least one given indication, the at least one indication of the at least one first transaction, the at least one indication of the at least one second transaction and at least one indication of at least one third transaction associated with the at least one relevant subset involves at least one portion of at least one of:
the at least one indication of the at least one second transaction;
the at least one indication of the at least one first transaction; and
the at least one indication of the at least one third transaction to be organized according to at least one associated second trackable number.

48. The computer-implemented method of any one of claims 33 to 47, wherein at least one of said validating and said providing comprises combining at least one part of at least one cryptographic key associated with at least one of the at least one first computing node, the at least one given computing node and the at least one second computing node with at least one portion of at least one of the structured data unit, the at least one given indication, the at least one indication of the second result and information involved in at least one interaction between at least one subset of at least one of the at least one first computing node, the at least one given computing node and at least one second computing node.

49. The computer-implemented method of any one of claims 33 to 48, further comprising associating at least one portion of at least one of the at least one given indication, the at least one indication of the at least one third transaction, at least one indication of the at least one second transaction, the at least one indication of the at least one first transaction and the structured data unit with at least one of the at least one given indication, the at least one indication of the at least one third transaction, at least one indication of the at least one second transaction, the at least one indication of the at least one first transaction and the structured data unit.

50. The computer-implemented method of any one of claims 33 to 49, further comprising performing a selecting associated with at least one subset of at least one of the at least one first computing node, the at least one given computing node and the at least one second computing node using at least one given trackable number, and further wherein said selecting involves at least one other subset of at least one of the at least one first computing node, the at least one given computing node and the at least one second computing node.

51. The computer-implemented method of claim 50, wherein said selecting comprises determining at least one portion of at least one reliability metric value distribution and performing said selecting using said at least one portion of the at least one reliability metric value distribution.

52. The computer-implemented method of claim 50, wherein said selecting comprises at least one of:
determining at least one portion of at least one reliability metric value distribution;
providing, to at least one of at least one first intermediary smart contract, system manager, server, computing node and processing device information required to perform at least one processing step of said selection; and
obtaining, from at least one of at least one first providing smart contract, system manager, server, computing node and processing device information associated with the selection.

53. The computer-implemented method of any one of claims 33 to 52, further comprising determining at least one of a reliability and a uniqueness associated with at least one of the at least one given indication, the at least one indication of the at least one third transaction, at least one indication of the at least one second transaction, the at least one indication of the at least one first transaction and the structured data unit.

54. The computer-implemented method of any one of claims 33 to 53, further comprising at least one of tracking and invalidating at least one relevant trackable number associated with at least one of the at least one given indication, the at least one indication of the at least one third transaction, at least one indication of the at least one second transaction, the at least one indication of the at least one first transaction and the structured data unit, and further wherein a performing of at least one of said tracking and invalidating involves at least one subset of at least one of the at least one first computing node, the at least one given computing node, at least one smart contract, system manager, server, computing node, processing device and machine readable instruction related to the distributed ledger enabled system.

55. The computer-implemented method of any one of claims 33 to 54, further comprising redetermining a previously determined reliability associated with at least one of the at least one first computing node, the at least one given computing node, the at least one second computing node and the at least one other computing node according to at least one of at least one condition, event, action, function, criterion, smart contract, system manager, server, computing node, parameter, processing device, rule, machine readable instruction and vote of at least one entity related to the distributed ledger enabled system.

56. The computer-implemented method of any one of claims 33 to 55, further comprising enabling at least one of a penalizing and a compensating associated with at least one of the at least one first computing node, the at least one given computing node, the at least one second computing node and at least one concerned computing node, and wherein at least one of a shape, form, scope and nature of at least one of said penalizing and said compensating is determined according to at least one of at least one condition, event, action, function, criterion, smart contract, system manager, server, computing node, parameter, processing device, rule, machine readable instruction and vote of at least one entity related to the distributed ledger enabled system.

57. The computer-implemented method of any one of claims 38 to 56, wherein at least one first portion of at least one of the at least one obtained first trackable number, the at least one associated second trackable number, the at least one given trackable number and the at least one relevant trackable number is one of pseudo-random and random, and wherein an obtaining process associated with said at least one first portion involves at least one subset of at least one of the at least one first computing node, the at least one given computing node, the at least one second computing node and the structured data unit.

58. The computer-implemented method of any one of claims 33 to 57, wherein a reliability associated with at least one computing node related to said validating comprises at least one of at least one rule, role, ability to perform at least one previously determined action in the distributed ledger enabled system, reliability metric value, demonstration of trustworthiness and determining of trustworthiness determined by at least one first rightful computing node.

59. The computer-implemented method of any one of claims 56 to 57, wherein said penalizing comprises at least one of:
preventing at least one action to be performed on at least one first asset accessible by at least one subset of at least one of the at least one first computing node, the at least one given computing node, the at least one second computing node and the at least one concerned computing node;
losing at least one second asset accessible by at least one subset of at least one of the at least one first computing node, the at least one given computing node, the at least one second computing node and the at least one concerned computing node; and
altering at least one reliability metric value associated with at least one of the at least one first computing node, the at least one given computing node, the at least one second computing node and the at least one concerned computing node,
and wherein at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

60. The computer-implemented method of anyone of claims 33 to 59, wherein at least a portion of the method is enabled according to at least one of at least one condition, event, action, function, criterion, smart contract, system manager, server, computing node, parameter, processing device, rule, machine readable instruction and vote of at least one entity related to the distributed ledger enabled system.

61. The computer-implemented method of any one of claims 33 to 60, further comprising, according to at least one criterion, performing at least one blockchain-related action of removing, adding, or updating, on at least one portion of the data associated with the structured data unit.

62. The computer-implemented method of claim 61, wherein the at least one criterion comprises a transaction type of at least one transaction associated with the structured data unit.

63. The computer-implemented method of claim 61, wherein the at least one blockchain-related action comprises at least one of: removing potentially malicious data; removing at least one transaction; adding at least one transaction; updating at least one transaction; adding a signature; updating a signature; adding a co-signature; and updating a co-signature.

64. The computer-implemented method of any one of claims 58 to 63, wherein said role comprises at least one of at least one right, responsibility and authority, said at least one of at least one right, responsibility and authority comprising at least one of:
delegating a storing of at least one portion of data related to at least one subset of at least one of the at least one first computing node, the at least one second computing node, the at least one given computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system;
storing at least one additional portion of delegated data related to at least one subset of at least one of the at least one first computing node, the at least one second computing node, the at least one given computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system;
altering at least one transaction threshold associated with at least one structured data unit related to the distributed ledger enabled system for at least one subset of at least one of the at least one first computing node, the at least one second computing node, the at least one given computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; and
performing at least one task, said at least one task comprising at least one of monitoring, modifying, adding, terminating and determining a behavior associated with at least one machine readable instruction related to the distributed ledger enabled system for at least one subset of at least one of the at least one first computing node, the at least one second computing node, the at least one given computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system.

65. A system comprising at least one processor, and at least one storage medium storing instructions, which when executed by the at least one processor, causes the system to carry out the computer-implemented method of any one of claims 33 to 64.

66. A machine-readable medium carrying machine readable instructions, which when executed by a processor of a machine, causes the machine to perform the computer-implemented method of any one of claims 33 to 64.

67. A computer-implemented method for generating at least one indication of a trackable number, the computer-implemented method being performed by at least one first computing node part of a distributed ledger enabled system, the computer-implemented method comprising:
combining at least one first identifier associated with the at least one first computing node with at least one first trackable number associated with at least one determined portion of at least one structured data unit part of the distributed ledger enabled system; and
obtaining the at least one indication of the trackable number according to a first result of said combining.

68. The computer-implemented method of claim 67, wherein the structured data unit is a block related to a blockchain.

69. The computer-implemented method of any one of claims 67 to 68, wherein said combining comprises at least one of at least one concatenation process, number reduction process, hashing process, and normalization process.

70. The computer-implemented method of any one of claims 67 to 69, wherein said combining comprises at least one of at least one length normalization process, exclusive or (XOR) operation, compression process, and number reduction process.

71. The computer-implemented method of any one of claims 67 to 70, wherein the trackable number is compared to at least one trackable number threshold, and further wherein the at least one trackable number threshold is determined according to at least one of at least one condition, event, action, function, criterion, smart contract, system manager, server, computing node, parameter, processing device, rule, machine readable instruction and vote of at least one entity related to the distributed ledger enabled system.

72. The computer-implemented method of any one of claims 67 to 71, wherein at least one first portion of at least one of said combining and said obtaining is processed by at least one second computing node and according to at least one of the first result and a second result of said at least one first portion, providing at least one of the first result and the second result to at least one subset of the at least one first computing node, and further wherein the at least one second computing node is considered to be reliable.

73. The computer-implemented method of any one of claims 67 to 72, wherein said at least one determined portion of the structured data unit is determined according to at least one of at least one given computing node, at least one condition, event, action, function, criterion, smart contract, system manager, server, computing node, parameter, processing device, rule, machine readable instruction and vote of at least one entity related to the distributed ledger enabled system.

74. The computer-implemented method of claim 73, wherein at least one subset of the at least one given computing node is at least one subset of at least one of the at least one first computing node and the at least one second computing node.

75. The computer-implemented method of any one of claims 67 to 74, wherein at least one of a shape, form, scope and nature of said combining is determined according to at least one of at least one condition, event, action, function, criterion, smart contract, system manager, server, computing node, parameter, processing device, rule, machine readable instruction and vote of at least one entity related to the distributed ledger enabled system.

76. The computer-implemented method of any one of claims 67 to 75, wherein said generating comprises a first determining process determining at least one of:
a reliability associated with the at least one first computing node, the at least one given computing node and the at least one second computing node,
a validity associated with at least one first position associated with the at least one structured data unit and
a validity associated with the at least one indication of the trackable number.

77. The computer-implemented method of any one of claims 67 to 76, wherein said combining comprises a first obtaining process of the at least one first identifier.

78. The computer-implemented method of any one of claims 76 to 77, wherein said first determining process comprises enabling a penalizing associated with at least one of the at least one first computing node, the at least one given computing node and the at least one second computing node, and further wherein at least one of a shape, form, scope and nature of said penalizing is determined according to at least one of at least one condition, event, action, function, criterion, smart contract, system manager, server, computing node, parameter, processing device, rule, machine readable instruction and vote of at least one entity related to the distributed ledger enabled system.

79. The computer-implemented method of any one of claims 67 to 78, further comprising combining at least one part of at least one cryptographic key associated with at least one of the at least one first computing node, the at least one given computing node and the at least one second computing node with at least one portion of at least one of the first result, the second result and the at least one indication of the trackable number and information involved in at least one interaction between at least one subset of at least one of the at least one first computing node, the at least one given computing node and at least one second computing node.

80. The computer-implemented method of any one of claims 67 to 79, further comprising performing a selecting associated with at least one subset of at least one of the at least one first computing node, the at least one given computing node and the at least one second computing node using at least one given trackable number, and further wherein said selecting involves at least one other subset of at least one of the at least one first computing node, the at least one given computing node and the at least one second computing node.

81. The computer-implemented method of claim 80, wherein said selecting comprises determining at least one portion of at least one reliability metric value distribution and performing said selecting using said at least one portion of the at least one reliability metric value distribution.

82. The computer-implemented method of claim 80, wherein said selecting comprises at least one of:
determining at least one portion of at least one reliability metric value distribution;
providing, to at least one of at least one first intermediary smart contract, system manager, server, computing node and processing device, information required to perform at least one processing step of said selection; and
obtaining, from at least one of at least one first providing smart contract, system manager, server, computing node and processing device, information associated with the selection.

83. The computer-implemented method of any one of claims 80 to 82, wherein the at least one given trackable number is one of pseudo-random and random, and wherein an obtaining process associated with said at least one given trackable number involves at least one subset of at least one of: the at least one first computing node; the at least one given computing node; the at least one second computing node; and the at least one structured data unit.

84. The computer-implemented method of claim 83, wherein the at least one given trackable number is obtained using the computer-implemented method of any one of claims 67 to 77.

85. The computer-implemented method of any one of claims 78 to 84, wherein said penalizing comprises at least one of:
preventing at least one action to be performed on at least one first asset accessible by at least one subset of at least one of the at least one first computing node, the at least one given computing node and the at least one second computing node;
losing at least one second asset accessible by at least one subset of at least one of the at least one first computing node, the at least one given computing node and the at least one second computing node; and
altering at least one reliability metric value associated with at least one of the at least one first computing node, the at least one given computing node and the at least one second computing node,
and wherein at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

86. The computer-implemented method of any one of claims 67 to 85, wherein at least a portion of the method is enabled according to at least one of: at least one condition, event, action, function, criterion, smart contract, system manager, server, computing node, parameter, processing device, rule, machine readable instruction and vote of at least one entity related to the distributed ledger enabled system.

87. A system comprising at least one processor, and at least one storage medium storing instructions, which when executed by the at least one processor, causes the system to carry out the computer-implemented method of any one of claims 67 to 86.

88. A machine-readable medium carrying machine readable instructions, which when executed by a processor of a machine, causes the machine to perform the computer-implemented method of any one of claims 67 to 86.

89. A computer-implemented method for generating a transaction to be added to a distributed ledger enabled system's structured data unit, the computer-implemented method being performed by at least one first computing node, the computer-implemented method comprising:
determining a reliability associated with at least one second computing node;
obtaining at least one indication of at least one trackable number from the at least one second computing node;
associating the at least one indication of the at least one trackable number with the transaction; and
providing at least one indication of the transaction to at least one third computing node.

90. The computer-implemented method of claim 89, further comprising determining a reliability associated with at least one of the at least one first computing node, the at least one third computing node and at least one given computing node.

91. The computer-implemented method of any one of claims 89 to 90, wherein the method is associated with the at least one given computing node.

92. The computer-implemented method of claim 91, wherein at least one subset of the at least one given computing node is at least one subset of at least one of the at least one first computing node, the at least one second computing node and the at least one third computing node.

93. The computer-implemented method of any one of claims 89 to 92, wherein at least a portion of the method is enabled according to at least one of at least one condition, event, action, function, criterion, smart contract, system manager, server, computing node, parameter, processing device, rule, machine readable instruction and vote of at least one entity related to the distributed ledger enabled system.

94. The computer-implemented method of claim 93, wherein said enabling is associated with at least one of at least one of a shape, form, scope and nature of at least one portion of the transaction, transaction-related data, obtained pre-transaction information, said first determining process and said determining of reliability.

95. The computer-implemented method of any one of claims 89 to 94, further comprising associating at least one first indication of at least one obtained first trackable number associated with at least one of the at least one first computing node, the at least one given computing node and the at least one third computing node with the transaction.

96. The computer-implemented method of claim 95, wherein associating data with the transaction comprises one of adding said data to said transaction and storing said data on at least one storage medium, obtaining at least one given indication of said data on the at least one storage medium, and adding said at least one given indication to said transaction.

97. The computer-implemented method of any one of claims 89 to 96, wherein at least one first portion of at least one of the at least one trackable number and the at least one obtained first trackable number is one of pseudo-random and random, and wherein an obtaining process associated with said at least one first portion involves at least one subset of at least one of the at least one first computing node, the at least one given computing node, the at least one second computing node and the at least one third computing node.

98. The computer-implemented method of any one of claims 89 to 97, further comprising at least one of tracking and invalidating at least one of the at least one trackable number and the at least one obtained first trackable number, and wherein a performing of at least one of said tracking and invalidating involves at least one subset of at least one of the at least one first computing node, the at least one second computing node, the at least one third computing node, the at least one given computing node, at least one smart contract, system manager, server, computing node, processing device and machine readable instruction related to the distributed ledger enabled system.

99. The computer-implemented method of any one of claims 89 to 98, further comprising redetermining a previously determined reliability associated with at least one of the at least one first computing node, the at least one given computing node, the at least one second computing node and the at least one third computing node according to at least one of at least one condition, event, action, function, criterion, smart contract, system manager, server, computing node, parameter, processing device, rule, machine readable instruction and vote of at least one entity related to the distributed ledger enabled system.

100. The computer-implemented method of any one of claims 89 to 99, further comprising enabling a penalizing associated with at least one of the at least one first computing node, the at least one given computing node, the at least one second computing node, the at least one third computing node and at least one concerned computing node, and further wherein at least one of a shape, form, scope and nature of said penalizing is determined according to at least one of at least one condition, event, action, function, criterion, smart contract, system manager, server, computing node, parameter, processing device, rule, machine readable instruction and vote of at least one entity related to the distributed ledger enabled system.

101. The computer-implemented method of any one of claims 89 to 100, further comprising determining at least one of a reliability and a uniqueness associated with at least one of the at least one obtained first trackable number, the at least one trackable number, said transaction-related data, said obtained pre-transaction information and the transaction.

102. The computer-implemented method of any one of claims 89 to 101, wherein a reliability associated with at least one computing node related to said generating comprises at least one of at least one rule, role, ability to perform at least one previously determined action in the distributed ledger enabled system, reliability metric value, demonstration of trustworthiness and determining of trustworthiness determined by at least one first rightful computing node.

103. The computer-implemented method of any one of claims 100 to 102, wherein said penalizing comprises at least one of:
preventing at least one action to be performed on at least one first asset accessible by at least one subset of at least one of the at least one first computing node, the at least one given computing node, the at least one second computing node, the at least one third computing node and the at least one concerned computing node;
losing at least one second asset accessible by at least one subset of at least one of the at least one first computing node, the at least one given computing node, the at least one second computing node, the at least one third computing node and the at least one concerned computing node; and
altering at least one reliability metric value associated with at least one of the at least one first computing node, the at least one given computing node, the at least one second computing node, the at least one third computing node and the at least one concerned computing node,
and wherein at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

104. The computer-implemented method of any one of claims 102 to 103, wherein said role comprises at least one of at least one right, responsibility and authority, said at least one of at least one right, responsibility and authority comprising at least one of:
delegating a storing of at least one portion of data related to at least one subset of at least one of the at least one first computing node, the at least one second computing node, the at least one given computing node, the at least one third computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system;
storing at least one additional portion of delegated data related to at least one subset of at least one of the at least one first computing node, the at least one second computing node, the at least one given computing node, the at least one third computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system;
altering at least one transaction threshold associated with at least one structured data unit related to the distributed ledger enabled system for at least one subset of at least one of the at least one first computing node, the at least one second computing node, the at least one given computing node, the at least one third computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; and
performing at least one task, said at least one task comprising at least one of monitoring, modifying, adding, terminating and determining a behavior associated with at least one machine readable instruction related to the distributed ledger enabled system for at least one subset of at least one of the at least one first computing node, the at least one second computing node, the at least one given computing node, the at least one third computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system.

105. A system comprising at least one processor, and at least one storage medium storing instructions, which when executed by the at least one processor, causes the system to carry out the computer-implemented method of any one of claims 89 to 104.

106. A machine-readable medium carrying machine readable instructions, which when executed by a processor of a machine, causes the machine to perform the computer-implemented method of any one of claims 89 to 104.

107. A computer-implemented method for validating at least one size of at least one structured data unit, the computer-implemented method being performed by at least one first computing node part of a distributed ledger enabled system, the computer-implemented method comprising:
comparing at least one size of at least one structured data unit with at least one threshold; and
establishing said validation according to at least one indication of a first result of said comparing,
wherein the at least one size is obtained according to at least one combination of at least one trackable number associated with the at least one structured data unit.

108. The computer-implemented method of claim 107, wherein the at least one threshold is determined according to at least one of a reliability associated with at least one of:
the at least one first computing node;
at least one second computing node at least one of associated with the at least one structured data unit and involved in at least one of a processing and a generating of the at least one structured data unit; and
a nature associated with the at least one structured data unit, at least one condition, event, action, function, criterion, smart contract, system manager, server, computing node, parameter, processing device, rule, machine readable instruction and vote of at least one entity related to the distributed ledger enabled system.

109. The computer-implemented method of any one of claims 107 to 108, wherein the at least one structured data unit is at least one of at least one block related to a blockchain and at least one structure of at least one indication of at least one portion of at least one transaction associated with at least one of the at least one second computing node and at least one other computing node, said at least one other computing node being considered to be reliable.

110. The computer-implemented method of any one of claims 107 to 109, wherein the at least one threshold is determined according to at least one of: at least one rate of at least one type of at least one activity related to the distributed ledger enabled system; and a centralization related to the distributed ledger enabled system.

111. The computer-implemented method of any one of claims 107 to 110, further comprising determining a reliability associated with at least one of the at least one first computing node, the at least one other computing node and the at least one second computing node.

112. The computer-implemented method of any one of claims 107 to 111, wherein at least one first portion of the at least one trackable number is one of pseudo-random and random, and wherein an obtaining process associated with said at least one first portion involves at least one subset of at least one of the at least one first computing node, the at least one second computing node and the at least one structured data unit.

113. The computer-implemented method of any one of claims 107 to 112, further comprising determining at least one of a reliability and a uniqueness associated with the at least one structured data unit.

114. The computer-implemented method of any one of claims 107 to 113, wherein said validating comprises at least one of tracking and invalidating at least one relevant trackable number associated with the at least one structured data unit, and further wherein a performing of at least one of said tracking and invalidating involves at least one subset of the at least one first computing node, at least one smart contract, system manager, server, computing node, processing device and machine readable instruction related to the distributed ledger enabled system.

115. The computer-implemented method of any one of claims 107 to 114, further comprising redetermining a previously determined reliability associated with at least one of the at least one first computing node, the at least one second computing node and the at least one other computing node according to at least one of at least one condition, event, action, function, criterion, smart contract, system manager, server, computing node, parameter, processing device, rule, machine readable instruction and vote of at least one entity related to the distributed ledger enabled system.

116. The computer-implemented method of any one of claims 107 to 115, further comprising enabling a penalizing associated with at least one of the at least one first computing node, the at least one second computing node and at least one concerned computing node, and further wherein at least one of a shape, form, scope and nature of said penalizing is determined according to at least one of at least one condition, event, action, function, criterion, smart contract, system manager, server, computing node, parameter, processing device, rule, machine readable instruction and vote of at least one entity related to the distributed ledger enabled system.

117. The computer-implemented method of claim 116, wherein said penalizing comprises at least one of:
preventing at least one action to be performed on at least one first asset accessible by at least one of the at least one first computing node, the at least one second computing node and the at least one concerned computing node;
losing at least one second asset accessible by at least one of the at least one first computing node, the at least one second computing node and the at least one concerned computing node; and
altering at least one reliability metric value associated with at least one of the at least one first computing node, the at least one second computing node and the at least one concerned computing node,
and wherein at least one of a duration, scope and enabling of at least one of said preventing, said losing and said altering is determined according to at least one of at least one condition, event, action, function, criterion, smart contract, system manager, server, computing node, parameter, processing device, rule, machine readable instruction and vote of at least one entity related to the distributed ledger enabled system.

118. The computer-implemented method of any one of claims 107 to 117, wherein a reliability associated with at least one computing node related to said validating comprises at least one of: at least one rule, role, ability to perform at least one previously determined action in the distributed ledger enabled system, reliability metric value, demonstration of trustworthiness and determining of trustworthiness determined by at least one first rightful computing node.

119. The computer-implemented method of any one of claims 107 to 118, wherein at least a portion of the method is enabled according to at least one of at least one condition, event, action, function, criterion, smart contract, system manager, server, computing node, parameter, processing device, rule, machine readable instruction and vote of at least one entity related to the distributed ledger enabled system.

120. The computer-implemented method of any one of claims 118 to 119, wherein said role comprises at least one of at least one right, responsibility and authority, said at least one of at least one right, responsibility and authority comprising at least one of:
delegating a storing of at least one portion of data related to at least one subset of at least one of the at least one first computing node, the at least one second computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system;
storing at least one additional portion of delegated data related to at least one subset of at least one of the at least one first computing node, the at least one second computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system;
altering at least one transaction threshold associated with at least one structured data unit related to the distributed ledger enabled system for at least one subset of at least one of the at least one first computing node, the at least one second computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system; and
performing at least one task, said at least one task comprising at least one of monitoring, modifying, adding, terminating and determining a behavior associated with at least one machine readable instruction related to the distributed ledger enabled system for at least one subset of at least one of the at least one first computing node, the at least one second computing node and the at least one concerned computing node according to at least one of at least one condition, event, action, function, criterion, smart contract, system manager, server, computing node, parameter, processing device, rule, machine readable instruction and vote of at least one entity related to the distributed ledger enabled system.

121. A system comprising at least one processor, and at least one storage medium storing instructions, which when executed by the at least one processor, causes the system to carry out the computer-implemented method of any one of claims 107 to 120.

122. A machine-readable medium carrying machine readable instructions, which when executed by a processor of a machine, causes the machine to perform the computer-implemented method of any one of claims 107 to 120.
